(19) United States
(12) Patent Application Publication
(10) Pub. No.: US 2014/0143126 A1
(43) Pub. Date: May 22, 2014

(54) Loan Analysis And Management System

(71) Applicant: Shaheen Malik, Jersey City, NJ (US)

(72) Inventor: Shaheen Malik, Jersey City, NJ (US)

(21) Appl. No.: 13/950,309

(22) Filed: Jul. 25, 2013

Related U.S. Application Data
(60) Provisional application No. 61/729,325, filed on Nov. 21, 2012.

(51) Int. Cl. G06Q 40/02

(52) U.S. Cl. CPC G06Q 40/025
USPC 705/38

(57) ABSTRACT

A computer implemented method and a system for analyzing and managing multiple syndicated loan transaction elements, for example, legal loan transaction documents, bank books, compliance reports, etc., are provided. An information analysis platform (IAP) receives the syndicated loan transaction elements from multiple data sources. The IAP extracts data items from the syndicated loan transaction elements and converts the data items into multiple data fields for enhanced review, interpretation, comparison, and statistical analysis of the syndicated loan transaction elements. The IAP analyzes the syndicated loan transaction elements using the data fields via analytical tools and expert inputs received via a graphical user interface, and estimates one or more factors, for example, impact of structural elements on loss given default, probability of default and pricing, impact of each data field for short and long term changes in default and loss given default assumptions, etc., based on the analysis.

### CROSS REFERENCE TO RELATED APPLICATIONS

This application claims the benefit of provisional patent application No. 61/729,325 titled “Loan Analysis And Management System”, filed in the United States Patent and Trademark Office on Nov. 21, 2012.

The specification of the above referenced patent application is incorporated herein by reference in its entirety.

### BACKGROUND

Financing of a commercial transaction, for example, an acquisition, an investment, or working capital typically requires leveraging a large amount of financial resources to support creation of one or more new tranches of debt or equity. A planned commercial transaction may involve debt based financing, for example, in the form of loans. Middle market and large companies typically need multimillion dollar loans and require significant resources to properly complete a funding transaction. For example, if a company approaches a bank for a loan, the bank generally requires proper assurance from the company regarding the company's ability to pay interest, fees, and principal before money can be loaned. Such assurances comprise, for example, collateral, loan insurance, etc. Moreover, the bank needs to organize resources sufficient to meet the needs of the company and structure the loan such that the loan meets the needs of the borrowing company.

Lending institutions such as investment banks and commercial banks have limits on the amounts of funds they commit to any one company or for any one transaction. These loan limits are often less than the total amount of financing a company requires for initiating a commercial transaction. By organizing a group of banks or lenders to finance an undertaking, the required funds can be obtained while limiting the exposure of individual lending institutions. One of the methods for organizing a group of banks or lenders is to form a loan syndicate which has, as members, a number of investment banks, commercial banks, investment vehicles such as mutual funds, hedge funds, and collateralized loan obligations (CLOs). The loan syndicate can underwrite large commercial loans, while spreading risk and liability among the various members to lessen the impact of any risk associated with a large syndicated loan.

A syndicated loan is typically a loan issued jointly by a group of lenders, for example, banks, financial institutions, etc., to a borrower. Mandated by the borrower, lead arrangers, generally lead banks promote the syndicated loan to potential lending institutions. The lead arrangers or the lead banks provide a memorandum comprising borrower specific information to potential participants. Each participating lending institution funds the syndicated loan at identical conditions and each participating lending institution is responsible for its particular share of the syndicated loan at the close of a syndicated loan transaction. Therefore, each participating lending institution has no legal responsibility for the shares of the other participating lending institutions. Currently, syndicated loans are used by banks and firms mainly for financing, for example, projects and investments involved in modernization of the company, research and development, mergers and acquisitions, trade financing, technical re-equipment of enterprises, and implementation of new production technology.

Financial analysis of a conventional loan transaction, for example, a consumer loan transaction does not involve complex legal documents and voluminous customized loan documents and is simpler when compared to financial analysis of syndicated loans of a commercial entity held by banks and accredited investors. A few issues associated with registration of a syndicated loan comprise, for example, managing actual credit relationships between the borrower and the banks or the lending institutions, an intercreditor agreement which aims at creation of a mechanism to coordinate the commitment of the participating lending institutions of different lien tranches of loans to the same borrowing entity, a credit agreement which defines a mechanism for interaction between the parties involved in the syndicated loan transaction, commitment and fee letters or engagement letters which define the terms of the underwriting or distribution among origination banks, etc. Managing a syndicated loan that engages a number of lending institutions involves handling of a large amount of data related to various aspects of the syndicated loan. For example, loan resources to be used for the syndicated loan, facilities, etc., typically need to be tracked and evaluated for availability, amounts available, future demands on the facility, etc. Information related to members of a syndicate group or investors also needs to be tracked and updated as a syndicated loan evolves. There is also a need for tracking activity related to the borrowers such as payment amounts, expected dates of payments, etc. Moreover, there is a need to track and report details related to regulatory requirements, for example, tax payments to appropriate authorities, etc. As a syndicated loan is completed, an opportunity for loan trading is presented among the various lenders holding loan assets during the lifetime of the syndicated loan. Loan trading requires a continuous track of the changes in ownership of the syndicated loan. In addition to the above aspects of a syndicated loan which track logistics of managing the syndicated loan, loan participants also need to track changes in the credit of a company and the impact of changes in the credit on the loan structure. The value of a loan and its recovery at default are impacted by credit and structural information. Evaluation of the risks implied by the structure of the loan as time progresses is the loan participant's responsibility.

Lending institutions in the financial services industry often evaluate a few factors while extending credit or lending money to a corporate entity. These factors comprise, for example, the risk of loss on default, whether a syndicated loan transaction should be approved, terms of the syndicated loan transaction approval, etc. Such syndicated loan transaction analysis methods are often found to be non-uniform across various business units.

Hence, there is a long felt but unresolved need for a computer implemented method and a computer implemented system that manage and organize complex loan documents and incoming financial compliance information to facilitate monitoring of syndicated loans by lenders and borrowers. Moreover, there is a need for a computer implemented method and a computer implemented system that analyze and manage multiple syndicated loan transaction documents, assess and manipulate information related to syndicated loans, and determine the impact of various factors associated with syndicated loan transactions, for example, impact of structural elements on loss given default, probability of default, pricing, etc. Furthermore, there is a need for a computer implemented method and a computer implemented system configured to technologically translate or convert complex customized legal terms from the syndicated loan documents into data fields, provide advanced statistical analysis on the data in the data fields, and generate reports for a detailed analysis.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

The computer implemented method and the computer implemented system disclosed herein address the above stated needs for managing and organizing complex loan documents and incoming financial compliance information to facilitate monitoring of syndicated loans by lenders and borrowers. The computer implemented method and the computer implemented system disclosed herein analyze and manage multiple syndicated loan transaction documents, assess and manipulate information related to syndicated loans, and determine the impact of various factors associated with syndicated loan transactions. The computer implemented method and the computer implemented system disclosed herein technologically translate or convert complex customized legal terms from the syndicated loan documents into data fields, provide advanced statistical analysis on the data in the data fields, and generate reports for a detailed analysis. As used herein, the term “data field” refers to an output field in a computer system, which displays a unit of information.

The computer implemented method and the computer implemented system disclosed herein provide an information analysis platform comprising at least one processor configured to analyze and manage syndicated loan transaction elements. As used herein, the term “syndicated loan transaction elements” refers to information, documents, etc., associated with a syndicated loan transaction. Also, as used herein, the term “syndicated loan transaction” refers to a transaction involving syndicated loans provided by a group of lenders comprising, for example, commercial or investment banks, financial institutions, investors, etc., that share or participate in providing a specific loan to a borrowing entity. In an embodiment, the information analysis platform is accessible by one or more user devices via a network, for example, the internet. The information analysis platform receives the syndicated loan transaction elements from multiple data sources. The syndicated loan transaction elements comprise, for example, syndicated loan transaction documents and loan information comprising, for example, legal loan transaction documents such as a commitment letter, a fee letter, an engagement letter, a credit agreement, a security and guarantee agreement, and an intercreditor agreement, bank books, compliance reports, etc., and any combination thereof. As used herein, the term “data sources” refers to sources of data created, generated, and aggregated by multiple entities and accessible by the information analysis platform. The data sources comprise, for example, one or more business entities that provide private filings or public filings associated with a loan transaction, for example, banks, law firms, bank databases, public databases, virtual data rooms, etc., and any combination thereof. The information analysis platform dynamically generates a data management database for storing the received syndicated loan transaction elements and information associated with the syndicated loans.

The information analysis platform extracts data items from the received syndicated loan transaction elements. As used herein, the term “data items” refers to pieces of information, for example, key legal terms and financial terms disclosed in the syndicated loan transaction elements such as the syndicated loan transaction documents and the loan information. In an embodiment, the information analysis platform configures each of the received syndicated loan transaction elements as a template for the extraction of the data items. The information analysis platform converts the extracted data items into multiple data fields. The data fields are configured for enhanced review, interpretation, comparison, and statistical analysis of the received syndicated loan transaction elements. In an embodiment, the information analysis platform converts the extracted data items into multiple data fields using expert inputs received via a graphical user interface (GUI) provided by the information analysis platform. As used herein, the term “expert inputs” refers to inputs received from legal and financial advisers, for example, investment bankers, statisticians, lawyers, etc., who are experts in loan markets. The data entered in the data fields comprises the data items extracted from the syndicated loan transaction elements, for example, based on the judgment of a user who provides manual data input or expert inputs.

In another embodiment, the information analysis platform categorizes each of the extracted data items into one of the data fields in the data management database. The information analysis platform stores one or more of the data fields in predefined formats in the data management database for enhanced accessibility. The data management database also stores the extracted data items categorized into data fields. In an embodiment, the information analysis platform provides a search engine configured to facilitate scanning of the received syndicated loan transaction elements, the extracted data items, and the data fields associated with the syndicated loans. The search engine enables a user to scan through the received syndicated loan transaction elements, the extracted data items, and the data fields associated with the syndicated loans.

The information analysis platform analyzes the received syndicated loan transaction elements using the data fields via analytical tools and expert inputs received via the GUI of the information analysis platform. In an embodiment, the information analysis platform generates one or more reports based on the analysis of the received syndicated loan transaction elements. In another embodiment, the information analysis platform compares the data fields associated with financial instruments for valuing credit of each of the data fields in each of the financial instruments. As used herein, the term “financial instruments” refers to fixed income or fixed payment instruments, for example, cash instruments such as securities, loans, bonds, interest rate swaps, currency swaps, convertible securities, total return swaps, etc. The information analysis platform estimates one or more of multiple factors associated with syndicated loans based on the analysis of the received syndicated loan transaction elements. The factors associated with the syndicated loans comprise, for example, impact of structural elements on loss given default, probability of default and pricing, impact of each of the data fields for short term and long term changes in default and loss given default assumptions, credit impact on each of the extracted data items, impact on valuations of the syndicated loans, statistical relationships between the data fields in the received syndicated loan transaction elements and metrics that measure overall credit, etc.

The information analysis platform enables sharing of the estimated factors associated with the syndicated loans and the generated reports between multiple user devices via the network based on predetermined sharing criteria. The predetermined sharing criteria comprises, for example, periods of time under confidentiality agreements, status of the user being one or more of a private side investor, a public side investor, a public non-investor, a potential investor, a law firm with access to credit agreements but not certain marketing materials, etc. In an embodiment, the information analysis platform assigns a user identifier to each of the estimated factors and each of the generated reports shared between the user devices, for identifying each of the user devices. As used herein, the term “user identifier” refers to a unique identifier, for example, a username, a company name, etc., that can be used to identify the user or the user's device that shares the estimated factors, the generated reports, etc. In an embodiment, the information analysis platform retrieves and displays detailed information for each of the received syndicated loan transaction elements, the extracted data items, and the data fields on the GUI, on receiving an input from a user device via the GUI.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and components disclosed herein.

FIG. 1 illustrates a computer implemented method for analyzing and managing multiple syndicated loan transaction elements.

FIG. 2 exemplarily illustrates a flow diagram showing functions performed by an information analysis platform for analyzing and managing multiple syndicated loan transaction elements.

FIG. 3 exemplarily illustrates a flow diagram showing components implemented by the information analysis platform for analyzing and managing multiple syndicated loan transaction elements.

FIG. 4 exemplarily illustrates a flow diagram showing data flow through a data management database of the information analysis platform for generation of a user output.

FIG. 5 exemplarily illustrates a computer implemented system for analyzing and managing multiple syndicated loan transaction elements.

FIG. 6 exemplarily illustrates the architecture of a computer system employed by the information analysis platform for analyzing and managing multiple syndicated loan transaction elements.

FIGS. 7A-7E exemplarily illustrate screenshots of a homepage interface provided on a graphical user interface of the information analysis platform.

FIG. 8 exemplarily illustrates a screenshot of an advanced search interface provided on the graphical user interface of the information analysis platform.

FIGS. 9A-9B exemplarily illustrate screenshots of a company interface provided on the graphical user interface of the information analysis platform.

FIGS. 10A-10L exemplarily illustrate screenshots of a company-credit agreement interface provided on the graphical user interface of the information analysis platform.

FIGS. 11A-11B exemplarily illustrate screenshots of an organization structure interface provided on the graphical user interface of the information analysis platform.

FIG. 12 exemplarily illustrates a screenshot of an intercreditor agreement interface provided on the graphical user interface of the information analysis platform.

FIG. 13 exemplarily illustrates a screenshot of a security agreement interface provided on the graphical user interface of the information analysis platform.

FIG. 14 exemplarily illustrates a screenshot of a competitors interface provided on the graphical user interface of the information analysis platform.

FIGS. 15A-15B exemplarily illustrate screenshots of a research interface provided on the graphical user interface of the information analysis platform.

FIG. 16 exemplarily illustrates a screenshot of a documents interface provided on the graphical user interface of the information analysis platform.

FIG. 17 exemplarily illustrates a screenshot of a compliance interface provided on the graphical user interface of the information analysis platform.

FIG. 18 exemplarily illustrates a screenshot of an amendments interface provided on the graphical user interface of the information analysis platform.

FIG. 19 exemplarily illustrates a screenshot of a comparison interface provided on the graphical user interface of the information analysis platform.

FIGS. 20A-20D exemplarily illustrate screenshots of a confidential information memorandum-lenders presentation interface provided on the graphical user interface of the information analysis platform.

FIG. 21 exemplarily illustrates a screenshot of a search interface provided on the graphical user interface of the information analysis platform.

FIGS. 22A-22L exemplarily illustrate screenshots of a search results interface provided on the graphical user interface of the information analysis platform.

FIG. 23 exemplarily illustrates a screenshot of an analytical interface provided on the graphical user interface of the information analysis platform.

### DETAILED DESCRIPTION OF THE INVENTION

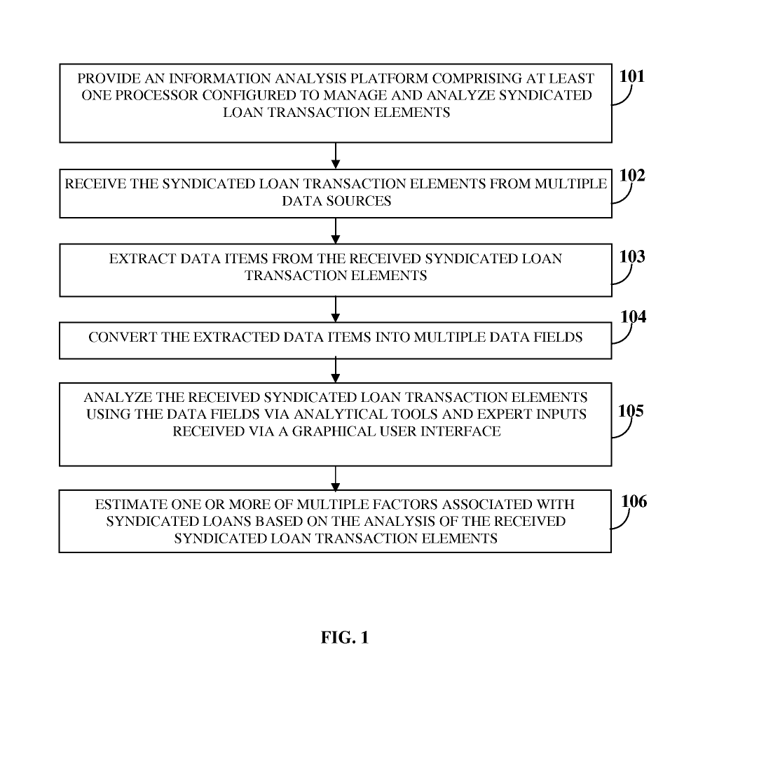

FIG. 1 illustrates a computer implemented method for analyzing and managing multiple syndicated loan transaction elements. As used herein, the term “syndicated loan transaction elements” refers to information, documents, etc., associated with a syndicated loan transaction. Also, as used herein, the term “syndicated loan transaction” refers to a transaction involving syndicated loans provided by a group of lenders comprising, for example, commercial or investment banks, financial institutions, investors, etc., that share or participate in providing a specific loan to a borrowing entity. Although the detailed description refers to syndicated loans, the scope of the computer implemented method and system disclosed herein is not limited to analysis and management of transactions involving syndicated loans, but may be extended to include analysis and management of transactions in different markets involving, for example, bonds, interest rate derivatives, currency derivatives, total return swaps, convertible securities, etc., since these financial items relate to tradable products that are technical and difficult to easily interpret and that use legal terms that need to be analyzed.

The syndicated loan transaction elements comprise, for example, syndicated loan transaction documents such as legal loan transaction documents and loan information associated with a syndicated loan. The legal loan transaction documents comprise, for example, legal documents, bank books, lenders presentations, monthly and quarterly compliance reports, corporate credit documents, one or more agreements associated with a loan deal such as credit agreements, security or collateral agreements, guarantees, intellectual property (IP) agreements, intercreditor agreements, etc., complex customized loan documents, other documents that form a part of a credit agreement package, etc. The syndicated loan transaction elements also comprise confidential commitment and fee letters, engagement letters, etc., where available. The loan information comprises information related to syndicated loans, for example, deal information, compliance information, transaction information associated with a loan deal, legal information, financial information, marketing information, confidential information memorandums, etc.

The computer implemented method disclosed herein provides 101 an information analysis platform comprising at least one processor configured to analyze and manage the syndicated loan transaction elements. In an embodiment, the information analysis platform is implemented as a website or a web based platform hosted on a server or a network of servers. In another embodiment, the information analysis platform is implemented in a cloud computing environment. As used herein, the term” cloud computing environment” refers to a processing environment comprising configurable computing physical and logical resources, for example, networks, servers, storage, applications, services, etc., and data distributed over a network, for example, the internet. The cloud computing environment provides on-demand network access to a shared pool of the configurable computing physical and logical resources. The information analysis platform is a cloud computing based platform implemented as a service for analyzing and managing the syndicated loan transaction elements. The information analysis platform is developed, for example, using cloud infrastructure of Amazon® Cloud Drive by Amazon Technologies, Inc.

The information analysis platform is accessible by one or more user devices via a network. The user devices are electronic devices, for example, personal computers, tablet computing devices, mobile computers, mobile phones, smart phones, portable computing devices, laptops, personal digital assistants, touch centric devices, workstations, servers, client devices, portable electronic devices, network enabled computing devices, interactive network enabled communication devices, web browsers, any other suitable computing equipment, and combinations of multiple pieces of computing equipment, etc. Computing equipment may be used to implement applications such as media playback applications, a web browser, a mapping application, an electronic mail (email) application, a calendar application, etc. Computing equipment, for example, one or more servers may be associated with one or more online services.

The information analysis platform is accessible to users, for example, through a broad spectrum of technologies and devices such as personal computers with access to the internet, internet enabled cellular phones, tablet computing devices, etc. The network for accessing the information analysis platform is, for example, the internet, an intranet, a wired network, a wireless network, a network that implements WiFi® of the Wireless Ethernet Compatibility Alliance, Inc., an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area communication network, a wide area network, an internet connection network, an infrared communication network, etc., or a network formed from a combination of these networks. In an embodiment, the information analysis platform is configured as a software application downloadable and executable on a user device.

The information analysis platform allows syndicated loan market users on the buy side and the sell side to review detailed items on structures of a syndicated loan that are disclosed in legal documents, compliance information, marketing material, etc. Syndicated loan market users comprise lenders and borrowers of syndicated loans, for example, banks, financial capital providers, institutional investors, corporations, etc. The information analysis platform enables syndicated loan market users, herein referred to as “users”, to compare the structures of syndicated loans, analyze the structures using mathematical tools, and generate estimates of factors influencing pricing. The information analysis platform allows users to compile their portfolio and conduct several analyses comprising, for example, an analysis to determine impact of a consolidated fixed charge coverage ratio (FCCR) on loss given default, probability of default, pricing, etc.

The information analysis platform receives 102 syndicated loan transaction elements from multiple data sources. As used herein, the term “data sources” refers to sources of data created, generated, and aggregated by multiple entities and accessible by the information analysis platform. The data sources comprise individuals, for example, lenders, underwriters, or other entities, institutions, business entities that provide private filings or public filings associated with a loan transaction, for example, banks, law firms, bank databases, public databases, virtual data rooms, etc., and any combination thereof that store and provide syndicated loan transaction elements to the information analysis platform. In an embodiment, the syndicated loan transaction documents are available through external data sources. For example, the information analysis platform receives syndicated loan transaction documents from companies that provide private or public filings in an 8K filing or another Securities and Exchange Commission (SEC) filing. For companies that do not perform an 8K filing or an SEC filing, the information analysis platform receives the syndicated loan transaction documents, for example, from the Intralinks® corporate repositories of IntraLinks, Inc., Syndtrak™ public databases of Fidelity Information Services, Inc., the Merrill DataSite® virtual data rooms of Merrill Communications LLC, the Debtdomain data rooms of Debtdomain Limited, the DebtX virtual data rooms of The Debt Exchange, Inc., etc.

Information available through external data sources is also available, for example, at each lender and underwriting institution. Deal information provided to investors while marketing a loan deal is also a part of the data feed provided to the information analysis platform. The deal information comprises company information provided by a company, for example, information on the company's business operations, capital structure, organizational structure, projections, etc. The deal information provides a snapshot of the company when the loan deal was in the market and is a source of comparison at later times throughout the life of the loan deal. The deal information further comprises information on the bank book, confidential information memorandums, and compliance packages, for example, financial covenants, financial statements, etc. The information analysis platform also receives data reported by the company through the life of the loan deal as part of its compliance requirements. In addition to compliance information, the information analysis platform also records amendments during reception of the loan information.

The information analysis platform creates or dynamically generates a relational data management database for storing the information from the syndicated loan transaction elements. The data management database is any storage area or medium that can be used for storing data and files. The data management database is, for example, a structured query language (SQL) data store or a not only SQL (NoSQL) data store such as the Microsoft® SQL Server®, the Oracle® servers, the MySQL® database of MySQL AB Company, the mongoDB® of 10gen, Inc., the Neo4j graph database, the Cassandra database of the Apache Software Foundation, the HBase™ database of the Apache Software Foundation, etc. In an embodiment, the data management database can also be a location on a file system. In another embodiment, the data management database can be remotely accessed by the information analysis platform via the network. In another embodiment, the data management database is configured as a cloud based database implemented in a cloud computing environment, where computing resources are delivered as a service over a network, for example, the internet.

The information analysis platform extracts 103 data items from the received syndicated loan transaction elements. As used herein, the term “data items” refers to pieces of information, for example, key legal terms and financial terms disclosed in the syndicated loan transaction elements such as the syndicated loan transaction documents and the loan information. The legal terms comprise, for example, definitions of excess cash flow, asset sale, eligible receivables and inventory, negative covenants such as liens, indebtedness, investments, events of default such as payment defaults, change of control, etc. The financial terms comprise, for example, revenue, operating costs and profit, earnings before interest, taxes, depreciation and amortization (EBITDA) actuals, projections, etc. In an embodiment, the information analysis platform configures each of the received syndicated loan transaction elements as a template for extraction of the data items, where each data item in each of the syndicated loan transaction elements received from the data sources is provided as part of a transaction. For example, in order to extract the data items, the information analysis platform lays out the entire credit agreement as a template comprising, for example, definitions, loan mechanics such as amortization schedules, prepayments, etc., affirmative covenants, negative covenants, events of default, security agreement sections, intercreditor sections, intellectual property (IP) agreements, etc. Under each section of the template, the information analysis platform anticipates each data item and subsections under each data item, and creates standardization in the interpretation of the syndicated loan credit agreements, thereby facilitating comparison of loan structures contained in the syndicated loan transaction elements. The information analysis platform standardizes the syndicated loan transaction elements into a data field format based on the data items in each of the syndicated loan transaction elements. The information analysis platform also standardizes commitment and fee letters or engagement letters which have a subset of the components of a credit agreement package and some additional information into a data field format based on the data items in each of the letters.

The information analysis platform converts 104 the extracted data items into multiple standardized data fields. As used herein, the term “data field” refers to an output field in a computer system, which displays a unit of information. The data entered in the data fields comprises the data items extracted from the syndicated loan transaction elements, for example, credit agreements, commitment and fee letters, engagement letters, confidential information memorandums, compliance packages, etc., based on the judgment of a user who provides manual data input or expert inputs. For example, asset sale information is converted into three data fields or categories, for example, minimum amount, type of asset, reinvestment period, etc., used to describe the asset sale information. The data fields are configured for enhanced review, interpretation, comparison, and statistical analysis of the received syndicated loan transaction elements. The data fields comprise data on definitions of key terms, for example, excess cash flow, earnings before interest, taxes, depreciation and amortization (EBITDA), etc. The data fields further comprise, for example, sections on prepayments, affirmative and negative covenants, events of default, etc. The structure of each of the data fields is configured to display data in a uniform pattern. Consider an example where each excess cash flow definition has similar subcomponents. The information analysis platform enables users to click through the subcomponents via a graphical user interface (GUI) provided by the information analysis platform to view the actual definition in a credit agreement or a commitment letter as well as review the entire credit agreement or the commitment letter. Furthermore, the information analysis platform also provides the users with a drop down list on the GUI with changes made to the data fields since the close of a loan deal by means of amendments.

In an embodiment, the information analysis platform converts the extracted data items into multiple data fields using expert inputs received via the GUI of the information analysis platform. As used herein, the term “expert inputs” refers to inputs received from legal and financial advisers, for example, investment bankers, statisticians, lawyers, etc., who are experts in loan markets. In an example, legal and finance experts input data via the GUI to enable the information analysis platform to convert the extracted data items into multiple data fields. In an embodiment, the information analysis platform allows legal experts and finance experts to manually input data items into the data fields via the GUI. In another embodiment, the information analysis platform manually defines data fields for the extracted data items via the GUI. In an embodiment, the information analysis platform categorizes each of the extracted data items into one of the data fields in the data management database. For example, the information analysis platform categorizes each data field in the syndicated loan transaction documents as a separate field in the data management database.

In an embodiment, the information analysis platform records amendments, analyzes each amendment, and overlays each amendment onto an original credit agreement to allow a syndicated loan market user to compare the credit agreement with the amendment and review changes, and also records each changed data field. The information analysis platform converts each amendment from a legal document into data fields that are entered, for example, into the data management database of the information analysis platform. For example, an amendment may include a change in pricing based on a change in the definition of an applicable margin. The information analysis platform enters the changed pricing information, for example, from L+300 basis points (bps) to L+275 bps into a data field on the information analysis platform, where “L” refers to the London interbank offered rate (LIBOR).

The data management database stores the received syndicated loan transaction elements, the extracted data items categorized into the data fields, and information associated with the syndicated loans. The information analysis platform analyzes syndicated loan transaction elements to determine appropriate data fields to be entered into one or more data management databases for further analysis through professional judgment. The information analysis platform analyzes the syndicated loan transaction elements, for example, credit agreements, security agreements, intellectual property (IP) agreements, intercreditor agreements and any other agreements relevant to a particular transaction in order to categorize each data item in the syndicated loan transaction elements as a separate data field on the data management database. The information analysis platform uses pricing and valuation data fields from external data sources for advanced analyses.

The information analysis platform converts the key legal terms and financial terms of each syndicated loan transaction into data fields. In an embodiment, the information analysis platform analyzes legal data offline and converts the legal data into data fields. The information analysis platform performs statistical analysis on the legal data. For example, the information analysis platform generates a metric to express risk such as credit loss. The information analysis platform defines data fields as an expression of credit improvement or degradation. The information analysis platform analyzes these data fields, for example, using algorithms that run hazard analysis and multiple regressions to determine their impact on credit loss. In another embodiment, the information analysis platform analyzes and records financial data separately as data fields. The information analysis platform provides the data fields to users in a format that enables a quick review and analysis of transactions. The information analysis platform converts information, for example, from legal, marketing, and compliance documents related to bank loan transactions into data fields that can be easily reviewed, compared, and analyzed. The information analysis platform also converts data items provided while marketing the loan deal into data fields. The information analysis platform analyzes marketing material and documents comprising, for example, bank books, confidential information memorandums, etc., and converts the marketing information comprising, for example, organizational structure, capital structure, projections, confidential information memorandum, lender presentation, etc., from these documents into data fields. The information analysis platform also converts compliance information into data fields and retains the converted compliance information in one or more data management databases for future analysis. Experts, for example, corporate lawyers can manually manipulate the data fields via the GUI.

The information analysis platform stores one or more of the data fields in predefined formats in the data management database for enhanced accessibility. For example, mandatory prepayments have four data fields to input the data items for debt sweeps, equity sweeps, asset sale sweeps, and extraordinary receipt sweeps. The information analysis platform stores certain data fields in the data management database for further analysis, and also provides access to the received syndicated loan transaction elements at future times. The information analysis platform also maintains the transaction information in one or more data management databases as data fields and links to the complete syndicated loan transaction documents. In an embodiment, the information analysis platform stores marketing information comprising, for example, confidential information memorandum, lender presentation, and ongoing compliance information in the data management database to effectively track comparisons of the compliance information with projections and ongoing budgets.

In an embodiment, the information analysis platform retrieves and displays detailed information for each of the received syndicated loan transaction elements, the extracted data items, and the data fields on the GUI, on receiving an input from a user device, for example, via the GUI. For example, the information analysis platform provides detailed legal language or definitions for any data field or term or data item on the GUI. When a user points to the data field using an input device, for example, a computer mouse pointer or clicks on the data field via the GUI of the user device, the information analysis platform displays a popup with the detailed definition, links to the defined terms, and amendments that have been made to the data items in the data fields. The information analysis platform retrieves the detailed information for each of the received syndicated loan transaction elements, the extracted data items, and the data fields from external data sources via the network. The external data sources comprise, for example, internal databases of banks and investors, data providers authorized to provide the loan information, etc.

In an embodiment, the information analysis platform compares the data fields associated with financial instruments for valuing credit of each of the data fields in each of the financial instruments. As used herein, the term “financial instruments” refers to fixed income or fixed payment instruments, for example, cash instruments such as securities, loans, bonds, interest rate swaps, currency swaps, convertible securities, total return swaps, etc. The information analysis platform evaluates the credit risk of any data field in any fixed income product that represents corporate debt on a balance sheet or a derivative product that produces fixed cash inflows or cash outflows. Credit risk is the ability of the fixed income product to pay interest and principal payments on schedule.

The information analysis platform analyzes 105 the received syndicated loan transaction elements using the data fields via analytical tools and expert inputs received via the GUI. The analytical tools implement and perform multiple regressions, operational research and statistical techniques, etc., to analyze the received syndicated loan transaction elements using the data fields. For example, the information analysis platform performs hazard analysis to determine a posterior probability of violation of other covenants once a single covenant has been violated. The information analysis platform extracts syndicated loan information, for example, from credit agreements and converts the extracted information into easily searchable and analyzable data fields. The information analysis platform analyzes these data fields to determine patterns that display the credit impact of the data items in the data fields. For example, the information analysis platform determines that deals that have strong management and ratings of under B will not increase credit loss beyond 20 bps, if a financial covenant with over 30% cushion is violated. This would represent a pattern. In an embodiment, the information analysis platform analyzes each data item in each data field to assess the impact of a subsection under each data field for short and long term changes in default and loss given default assumptions, with subsequent impact on valuation. In the above example, the information analysis platform determines that the credit loss due to financial covenant violations is less than 20 bps and shows that 50% credit loss represents 25 bps of reduction in value from par. Therefore, the resulting price of the loan is 99.875 bps after adjusting for financial covenants. The information analysis platform analyzes the data fields to establish statistical relationships between the loan information in the loan documents and metrics that measure overall credit, for example, the probability of default and loss given default in order to assist the users in determining the impact of the terms on the credit and the impact on valuation. The information analysis platform analyzes the loan documents comprising, for example, commitment and fee letters, engagement letters, credit agreements, security agreements, intellectual property (IP) agreements, intercreditor agreements, and any other agreements relevant to the particular transaction.

The information analysis platform estimates 106 one or more of multiple factors associated with syndicated loans based on the analysis of the received syndicated loan transaction elements. The factors associated with the syndicated loans comprise, for example, impact of structural elements on loss given default, probability of default and pricing, impact of each of the data fields for short term and long term changes in default and loss given default assumptions, credit impact on each of the extracted data items, impact on valuations of the syndicated loans, and statistical relationships between the data fields in the received syndicated loan transaction elements and metrics that measure overall credit. Consider an example where the information analysis platform runs a regression to determine impact of restricted payments to unrestricted subsidiaries on risk of default. If a credit loss rating of restricted payments to unrestricted subsidiaries is assigned as 20 bps, then the information analysis platform runs a regression on all prior deals to check whether a relationship between this credit loss and the default rate of the deal can be proven, for example, using a formula E(Y|X)=f(X,β), where X is the credit loss amount and β is the default rate. Based on the regression results, the information analysis platform shows the risk of default increases by 10 basis points for every 5% of earnings before interest, taxes, depreciation and amortization (EBITDA) contributed towards restricted payments to unrestricted subsidiaries, assuming all other factors associated with the syndicated loan are maintained constant.

In an embodiment, the information analysis platform further analyzes customized syndicated loan transaction documents. The information analysis platform also runs analytical tools to perform a structural and statistical analysis on the received syndicated loan transaction elements using the data fields to determine the impact of specific features, for example, the size of restricted payments on loss given default, probability of default, pricing, etc., for use as a reference guide. The structural analysis refers to converting, for example, each loan term into an expression of credit. For example, the information analysis platform converts the restricted payments to unrestricted subsidiaries as credit loss of 1 bp for every 1% of restricted payment or earnings before interest, taxes, depreciation and amortization (EBITDA). Once the credit loss is determined, the information analysis platform performs a statistical analysis, for example, using multiple regressions, a hazard analysis, or any other statistical or operational research technique. In an embodiment, the information analysis platform provides analytical tools to the users to enable the users to design terms and estimate the parameters of the data fields based on the credit impact the users want to influence. In an embodiment, the information analysis platform uses the data from transactions and performs analyses to create models that predict the impact of each feature on the short and long term credit of the company. Consider an example where the information analysis platform runs a regression on the size of an investment basket as a percentage of EBITDA and runs regressions to check how the size of the investment basket is impacted by the quality of management and rating. The resultant analysis generated by the information analysis platform enables predictions on how the investment basket will impact the default of the company and the loss given default. In an embodiment, the information analysis platform runs regressions to predict the impact on valuations of a loan. The information analysis platform uses a valuation technique to value the credit of any term in any fixed income product that represents corporate debt on a balance sheet. Consider another example where the information analysis platform determines the dollar size of restricted payments as well as restricted payments as a percentage of revenue and EBITDA, and runs regressions of these terms against the probability of default and loss given default. The information analysis platform controls these regressions for industry and rating to determine the impact of the size of restricted payments on the loss given default, probability of default, and eventually on valuations. In the above example, the information analysis platform determines that the credit loss as a result of the restricted payments is 50 bps and therefore the value of the loan after adjusting for the credit loss is 99.5.

The information analysis platform provides a detailed menu on the GUI to allow users to enter selections of loan deals, for example, based on company names, industry, deals within a particular timeframe, deals with specific features, etc., and to create comparison charts of the selected loan deals. The information analysis platform also captures raw data that is provided, for example, to bank loan users as compliance information, and displays the raw data in a manner that can be reviewed and analyzed. The information analysis platform displays information on the loan deals from the syndicated loan transaction documents, marketing information, compliance information, etc., in a uniform and readable format on the GUI for enhanced viewing by users and enables the users to compare features to any other company or transaction. In an embodiment, the information analysis platform generates one or more reports based on the analysis of the received syndicated loan transaction elements. The information analysis platform allows users to view reports generated based on an available analysis performed, or to request for a specific analysis run for them using the received and stored data fields.

In an embodiment, the information analysis platform enables sharing of the estimated factors associated with the syndicated loans and/or one or more of the generated reports between multiple user devices via the network based on predetermined sharing criteria. The predetermined sharing criteria comprises, for example, periods of time under confidentiality agreements, status of a user being one or more of a private side investor, a public side investor, a public non-investor, a potential investor, a law firm with access to credit agreements but not certain marketing materials, etc. The information analysis platform allows users to share the generated analytical reports with other users for short or long periods under confidentiality agreements. The information analysis platform enables sharing of the estimated factors and/or the generated reports, for example, via the GUI, electronic mail, a social networking platform, etc.

In an embodiment, the information analysis platform assigns a user identifier to each of the estimated factors and each of the generated reports shared between the user devices for identifying each of the user devices. As used herein, the term “user identifier” refers to a unique identifier, for example, a username, a company name, etc., that can be used to identify the user or the user's device that shares the estimated factors, the generated reports, etc. For example, the information analysis platform stamps each document or report shared by the user with the name of the user, the name of the company, and a date stamp. The information analysis platform provides access to the remaining data fields to the users who can apply other analyses to the data. The information analysis platform controls the access to the generated reports based on user preferences and a privacy status configured by the user, for example, via the GUI. In an embodiment, the information analysis platform provides a search engine configured to facilitate scanning of the received syndicated loan transaction elements, the extracted data items, and/or the data fields associated with the syndicated loans. The search engine enables users to scan through multiple transactions via the GUI using descriptions of definitions comprising, for example, a definition of a disqualified lender or features of transactions comprising, for example, tenor of a transaction or rating of a company. The information analysis platform provides a technological tool as a web based platform or an internet based platform on which a user reviews information on any transaction and assesses the credit impact on the detailed data items.

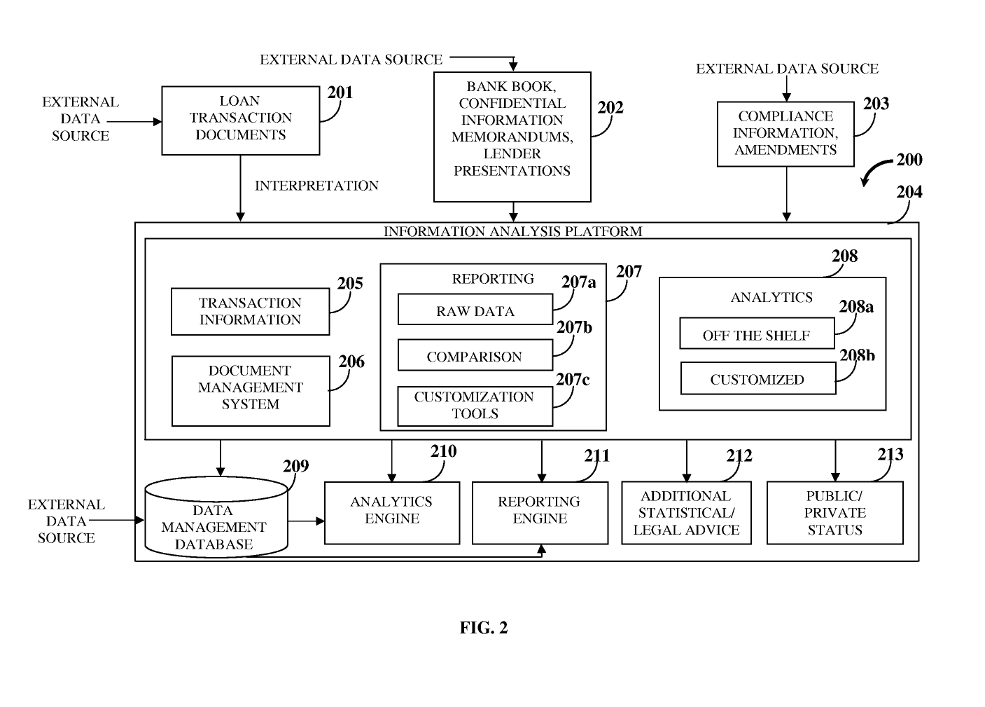

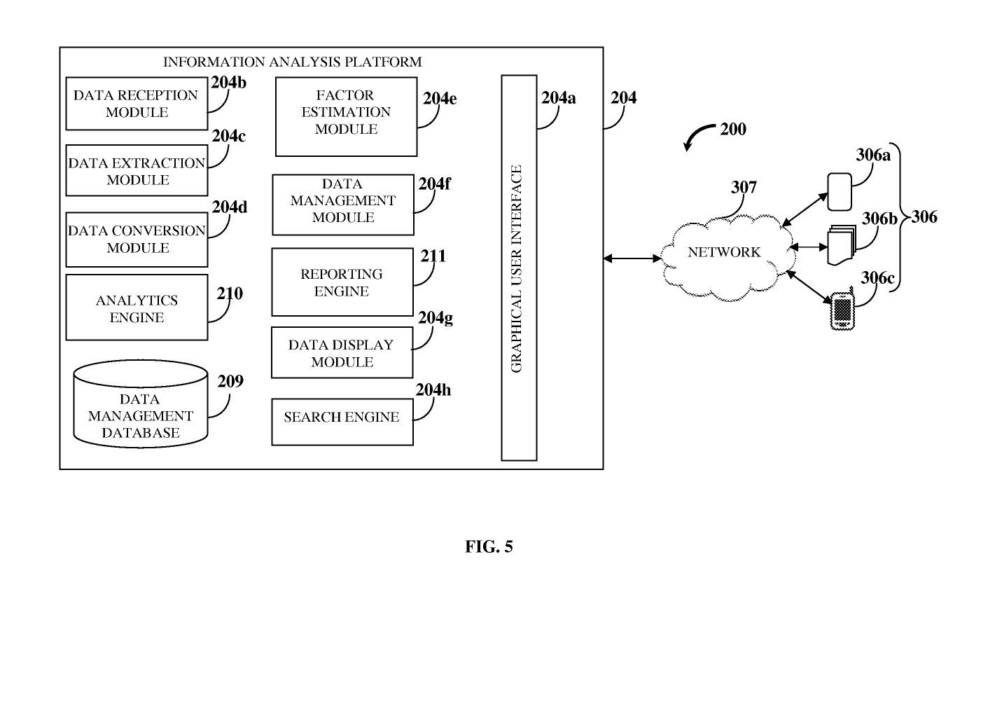

FIG. 2 exemplarily illustrates a flow diagram showing functions performed by the information analysis platform 204 for analyzing and managing multiple syndicated loan transaction elements. A high level architecture of a computer implemented system 200 comprising the information analysis platform 204 is exemplarily illustrated in FIG. 2. The information analysis platform 204 is configured to operate in a cloud computing environment as disclosed in the detailed description of FIG. 1. The information analysis platform 204 comprises a data reception module 204b exemplarily illustrated in FIG. 5, a document management system 206, an analytics engine 210, a reporting engine 211, and the data management database 209. The data reception module 204b receives syndicated loan transaction elements comprising, for example, loan transaction documents 201, bank book information, confidential information memorandums, and lender presentations 202, compliance information and amendments 203, etc., from multiple external data sources and stores the received syndicated loan transaction elements in the data management database 209.

The information analysis platform 204 maintains transaction information 205 associated with processing of the received syndicated loan transaction elements in the data management database 209 as data fields in predefined formats for enhanced accessibility and provides links to the received syndicated loan transaction elements. The data management database 209 is implemented as one or more cloud databases in a cloud computing environment. The transaction information 205 comprises, for example, transaction information associated with a loan deal, sections of the syndicated loan transaction elements related to the transaction including commitment and fee letters, an engagement letter, the credit agreement with exhibits and schedules, intercreditor agreements, security or collateral agreements, guarantees, and any other agreements filed as the loan documents package. In an embodiment, the information analysis platform 204 does not permit access to the transaction information 205. The information analysis platform 204 extracts data from the transaction information 205 using a combination of legal expertise and technology and runs advanced statistical analyses on the data. The document management system 206 organizes each of the syndicated loan transaction elements received as inputs from the external data sources in the form of a template as disclosed in detailed description of FIG. 1. The information analysis platform 204 allows users to access deal documents of past and present loan deals based on a privacy status configured by the users. The information analysis platform 204 maintains the privacy status external to the document management system 206, for example, through an administrator.

The reporting engine 211 performs reporting functions 207 and generates reports as disclosed in the detailed description of FIG. 1. The reports provide the users with raw data 207a in a usable format and the data fields on loan deals, and allows the users to select loan deals and data fields associated with financial instruments for comparison 207b. The reporting engine 211 generates reports that allow the users to review an organized version of the raw data 207a and data fields or comparative data. The information analysis platform 204 provides customization tools 207c accessible via the graphical user interface (GUI) of the information analysis platform 204 to allow users to customize the generated reports on the entire data fields based on their needs. The analytics engine 210 performs analytic functions 208, that is, analysis of the received syndicated loan transaction elements using the data fields. The analytics engine 210 performs statistical analyses and provides results of the statistical analyses, for example, on each deal, industry, group of recent deals or similarly sized deals, etc., to the users via the GUI. The analytics engine 210 provides access to the results of the statistical analyses based on the privacy status of an investor. The analytics engine 210 provides and displays off-the-shelf analytics 208a on the GUI to users who subscribe to the off-the-shelf analytics 208a. Off-the-shelf analytics 208a refers to reports that users do not need to design themselves. These reports are readily prepared and listed for the user to select and download. The analytics engine 210 runs the off-the-shelf analytics 208a as standard tests on the data and displays the results on the GUI to subscribing users. Standard tests refer to the impact of changes of, for example, applicable margins on trading levels, financial covenants on trading levels, etc. In an embodiment, the analytics engine 210 also performs a customized statistical analysis 208b on the entire data based on the user's needs on a chargeable basis.

The information analysis platform 204 maintains the transaction information 205, documentation, reports, and analyses in the data management database 209. The analytics engine 210 performs multiple statistical analyses such as a regression of the features of the loans with pricing information and valuation metrics received from external pricing sources, using the data stored in the data management database 209. The reporting engine 211 receives the data from the data management database 209 and converts the data to a searchable, analyzable, accessible and standardized format to determine patterns to show the credit impact on the syndicated loan transaction elements. The converted data in the accessible and standardized format shows entire loan deal information, comparison 207b of multiple loan deals based on any deal descriptor, for example, industry, size range, date of closing, etc. Users may request for additional statistical or legal advice 212 via the GUI of the information analysis platform 204 to interpret any of the data fields or analyses on any of the reports or the analytics. Financial experts may provide the statistical or legal advice 212 offline or online via the GUI. User may set the privacy status of the loan transaction documents 201, the loan information, the reports, etc., to a public status or a private status 213 via the GUI.

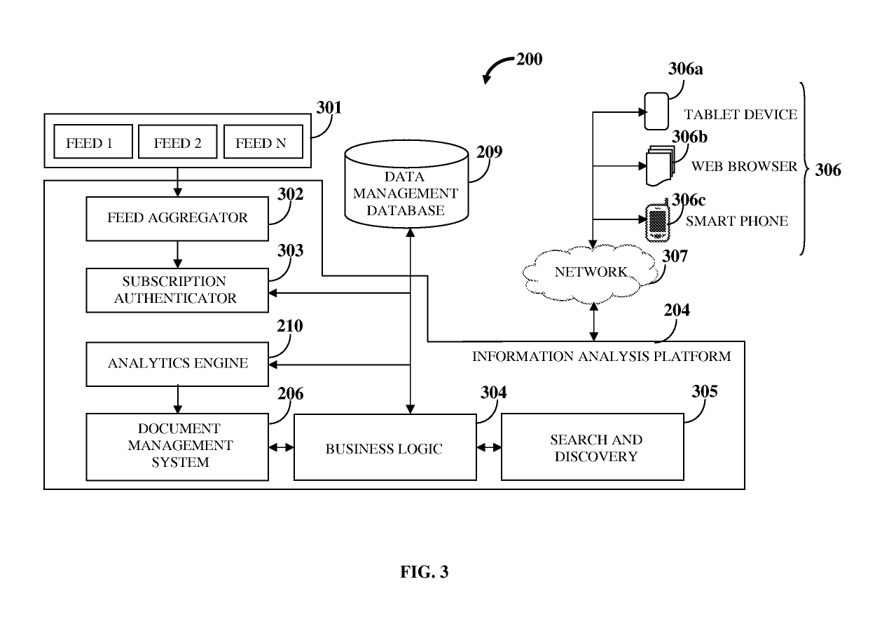

FIG. 3 exemplarily illustrates a flow diagram showing components implemented by the information analysis platform 204 for analyzing and managing multiple syndicated loan transaction elements. The users access the information analysis platform 204 using user devices 306 comprising, for example, tablet devices 306a, web browsers 306b, smart phones 306c, etc. The user devices 306 access and communicate with the information analysis platform 204 via a network 307, for example, the internet. In addition to the data reception module 204b exemplarily illustrated in FIG. 5, the document management system 206, the analytics engine 210, and the reporting engine 211 disclosed in the detailed description of FIG. 2, the components of the information analysis platform 204 further comprise a feed aggregator 302 and a subscription authenticator 303. The feed aggregator 302 receives the syndicated loan transaction elements as multiple input feeds 301, for example, feed 1, feed 2, . . . feed N, etc., to the information analysis platform 204. The input feeds 301 comprise manual or external data source feeds. The feed aggregator 302 aggregates the input feeds 301 into data fields. The subscription authenticator 303 authenticates a user by validating the user's subscription status to each input feed 301. The analytics engine 210 runs analytics 208 exemplarily illustrated in FIG. 2, on the data fields based on business logic 304 configured in the information analysis platform 204, and stores the results in the data management database 209. The business logic 304 refers to relationships between variables. For example, the analytics engine 210 determines that degradation of financial covenants in a company with less than a B-rating will result in credit loss of over 10 bps. Accordingly, the analytics engine 210 sets up a regression analysis between financial covenants and ratings to render the amount of credit loss. The data management database 209 is implemented as a single cloud based database or as multiple interconnected cloud based databases. As disclosed in the detailed description of FIG. 1, the information analysis platform 204 allows users to perform search and discovery functions 305, via the graphical user interface (GUI) of the information analysis platform 204 to receive a combination of the data fields and analyzed information. The information analysis platform 204 provides reports generated by the search engine 204h exemplarily illustrated in FIG. 5, the reporting engine 211, and the analytics engine 210 to users, for example, via the GUI.

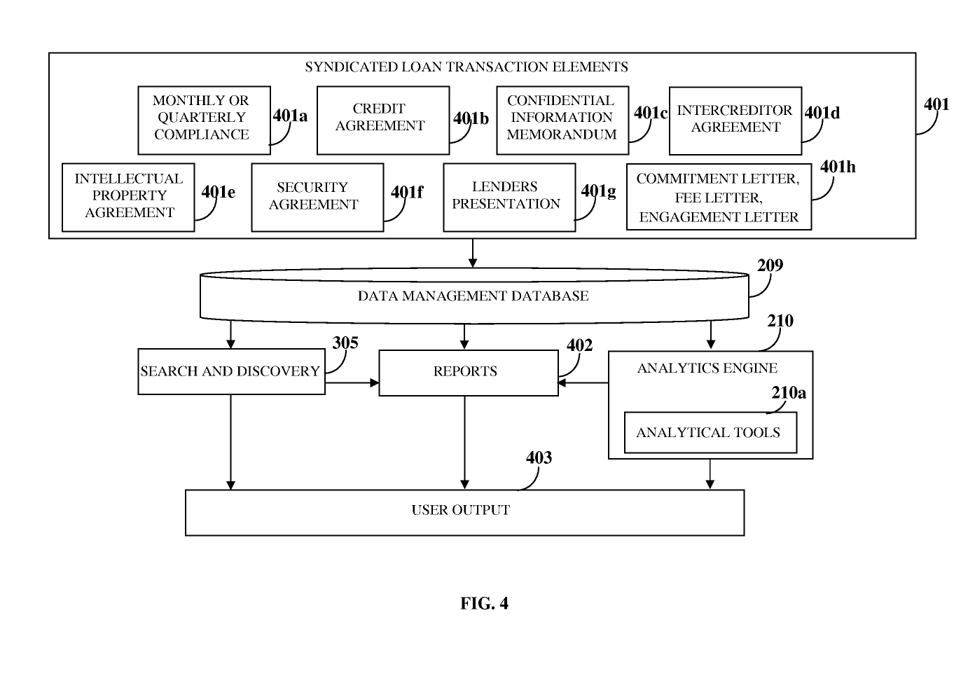

FIG. 4 exemplarily illustrates a flow diagram showing data flow through the data management database 209 for generation of a user output 403. The information analysis platform 204 exemplarily illustrated in FIGS. 2-3 and FIG. 5, receives raw data, that is, the syndicated loan transaction elements 401, for example, monthly or quarterly compliance reports 401a, credit agreements 401b, confidential information memorandums 401c, intercreditor agreements 401d, intellectual property agreements 401e, security agreements 401f, lenders presentations 401g, a commitment letter, a fee letter, an engagement letter 401h, etc., from multiple data sources. The information analysis platform 204 stores the received syndicated loan transaction elements 401 in the data management database 209 used for internal storage. The information analysis platform 204 enables search and discovery functions 305 via the data management database 209. As disclosed in the detailed description of FIG. 3, the search engine 204h exemplarily illustrated in FIG. 5 enables users to search and receive a combination of the raw data and analyzed data from the data management database 209 and facilitates scanning of multiple transactions based on the description of definitions or features of the transaction, via the graphical user interface (GUI) of the information analysis platform 204. The reporting engine 211 of the information analysis platform 204 exemplarily illustrated in FIG. 2, generates reports 402 and customizes the reports 402 as per requirements of the users to allow the users to review an organized version of the raw data or comparative data in standard reports 402. The analytics engine 210 comprising the analytical tools 210a enables users to run specific customized analysis on the received and analyzed syndicated loan transaction elements 401 based on the users' requirements to a generate a user output 403. The user output 403 comprises the results of the analyses, results of the search and discovery 305, the generated reports 402, etc.

FIG. 5 exemplarily illustrates a computer implemented system 200 for analyzing and managing multiple syndicated loan transaction elements 401 exemplarily illustrated in FIG. 4. The computer implemented system 200 disclosed herein comprises the information analysis platform 204 accessible via one or more user devices 306, for example, a tablet device 306a, a web browser 306b, a smart phone 306c, etc., over a network 307. The network 307 is, for example, the internet, an intranet, a wired network, a wireless network, a communication network that implements, a network that implements Wi-Fi® of the Wireless Ethernet Compatibility Alliance, Inc., etc., as disclosed in the detailed description of FIG. 1. The information analysis platform 204 comprises at least one processor configured to execute modules, for example, 204b, 204c, 204d, 204e, 204f, 204g, 204h, 210, 211, etc., of the information analysis platform 204. The information analysis platform 204 further comprises a non-transitory computer readable storage medium communicatively coupled to the processor. The non-transitory computer readable storage medium stores the modules, for example, 204b, 204c, 204d, 204e, 204f, 204g, 204h, 210, 211, etc., of the information analysis platform 204. The information analysis platform 204 further comprises a graphical user interface (GUI) 204a, a data reception module 204b, a data extraction module 204c, a data conversion module 204d, an analytics engine 210, a factor estimation module 204e, a data management module 204f, a reporting engine 211, a data display module 204g, a search engine 204h, and the data management database 209. In an embodiment, the data management database 209 is remotely connected to the information analysis platform 204 via the network 307.

The GUI 204a is configured to receive expert inputs for converting data items extracted from the syndicated loan transaction elements 401 into data fields and for analyzing the syndicated loan transaction elements 401 using the data fields. The GUI 204a is, for example, a webpage of a website hosted by the information analysis platform 204, an online web interface, a web based downloadable application interface, a mobile based downloadable application interface, etc. The data reception module 204b receives the syndicated loan transaction elements 401 from multiple data sources, for example, business entities that provide private filings or public filings associated with a loan transaction, bank databases, public databases, virtual data rooms, etc. In an embodiment, the data reception module 204b receives the syndicated loan transaction elements 401 from multiple data sources via the GUI 204a. The data extraction module 204c extracts data items from the received syndicated loan transaction elements 401. In an embodiment, the data extraction module 204c configures each of the received syndicated loan transaction elements 401 as a template for the extraction of the data items. The data conversion module 204d converts the extracted data items into multiple data fields configured for enhanced review, interpretation, comparison, and statistical analysis of the received syndicated loan transaction elements 401. In an embodiment, the data conversion module 204d converts the extracted data items into the data fields using the expert inputs received via the GUI 204a. The data conversion module 204d categorizes each of the extracted data items into one of the data fields in the data management database 209. The data display module 204g retrieves and displays detailed information for each of the received syndicated loan transaction elements 401, the extracted data items, and the data fields on the GUI 204a, on receiving an input from one or more of the user devices 306 via the GUI 204a. The data display module 204g retrieves the detailed information from the data management database 209.

The analytics engine 210 analyzes the received syndicated loan transaction elements 401 using the data fields via analytical tools 210a exemplarily illustrated in FIG. 4, and the expert inputs received via the GUI 204a. The analytics engine 210 compares the data fields associated with financial instruments for valuing credit of each of the data fields in each of the financial instruments. The factor estimation module 204e estimates one or more of multiple factors associated with syndicated loans, for example, impact of structural elements on loss given default, probability of default and pricing, impact of each of the data fields for short term and long term changes in default and loss given default assumptions, credit impact on each of the extracted data items, impact on valuations of the syndicated loans, statistical relationships between the data fields in the received syndicated loan transaction elements 401 and metrics that measure overall credit, etc., based on the analysis of the received syndicated loan transaction elements 401.

The data management database 209 stores one or more data fields in predefined formats for enhanced accessibility, the received syndicated loan transaction elements 401, the extracted data items categorized into the data fields, and information associated with the syndicated loans. The reporting engine 211 generates one or more reports based on the analysis of the received syndicated loan transaction elements 401. The data management module 204f shares the estimated factors associated with the syndicated loans and/or the generated reports between multiple user devices 306 via the network 307 based on predetermined sharing criteria. The data management module 204f assigns a user identifier to each of the estimated factors and/or the generated reports shared between the user devices 306 for identifying each of the user devices 306. The search engine 204h facilitates scanning of the received syndicated loan transaction elements 401, the extracted data items, and the data fields associated with the syndicated loans.

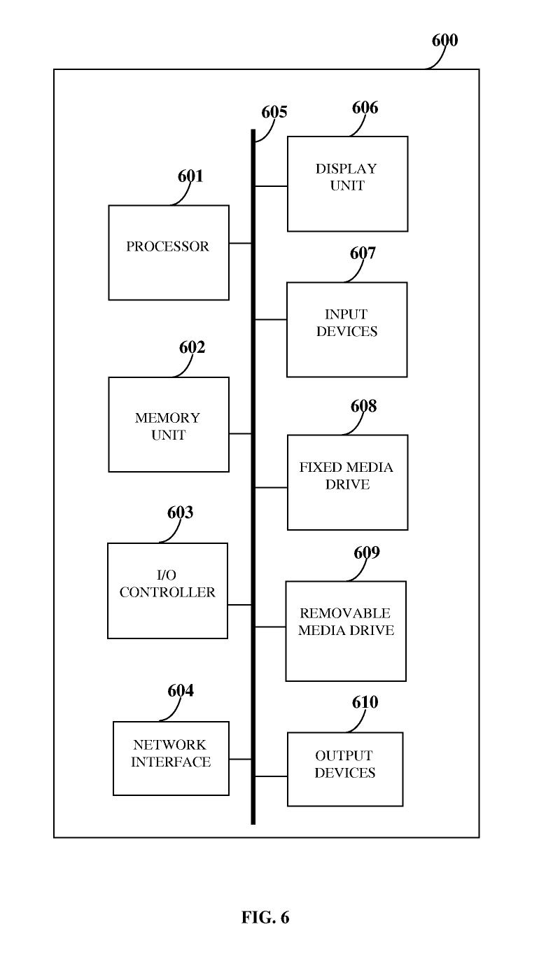

FIG. 6 exemplarily illustrates the architecture of a computer system 600 employed by the information analysis platform 204 for analyzing and managing multiple syndicated loan transaction elements 401 exemplarily illustrated in FIG. 4. The information analysis platform 204 of the computer implemented system 200 exemplarily illustrated in FIG. 5 employs the architecture of the computer system 600 exemplarily illustrated in FIG. 6. The computer system 600 is programmable using a high level computer programming language. The computer system 600 may be implemented using programmed and purposeful hardware.

The information analysis platform 204 communicates with the user devices 306 of each of the users, for example, borrowers, lenders, banks, financial institutions, etc., registered with the information analysis platform 204 via a network 307, for example, a short range network or a long range network. The network 307 is, for example, the internet, a local area network, a wide area network, a wired network, a wireless network, a mobile communication network, etc. The computer system 600 comprises, for example, a processor 601, a memory unit 602 for storing programs and data, an input/output (I/O) controller 603, a network interface 604, a data bus 605, a display unit 606, input devices 607, a fixed media drive 608, a removable media drive 609 for receiving removable media, output devices 610, etc.

The term “processor” refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 601 may also be implemented as a processor set comprising, for example, a general purpose microprocessor and a math or graphics co-processor. The processor 601 is selected, for example, from the Intel® processors such as the Itanium® microprocessor or the Pentium® processors, Advanced Micro Devices (AMD®) processors such as the Athlon® processor, UltraSPARC® processors, microSPARC™ processors, hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, etc. The information analysis platform 204 disclosed herein is not limited to a computer system 600 employing a processor 601. The computer system 600 may also employ a controller or a microcontroller. The processor 601 executes the modules, for example, 204b, 204c, 204d, 204e, 204f, 204g, 204h, 210, 211, etc., of the information analysis platform 204.

The memory unit 602 is used for storing programs, applications, and data. For example, the data reception module 204b, the data extraction module 204c, the data conversion module 204d, the analytics engine 210, the factor estimation module 204e, the data management module 204f, the reporting engine 211, the data display module 204g, the search engine 204h, etc., of the information analysis platform 204 are stored in the memory unit 602 of the computer system 600. The memory unit 602 is, for example, a random access memory (RAM) or another type of dynamic storage device that stores information and instructions for execution by the processor 601. The memory unit 602 also stores temporary variables and other intermediate information used during execution of the instructions by the processor 601. The computer system 600 further comprises a read only memory (ROM) or another type of static storage device that stores static information and instructions for the processor 601.

The network interface 604 enables connection of the computer system 600 to the network 307. For example, the information analysis platform 204 connects to the network 307 via the network interface 604. In an embodiment, the network interface 604 is provided as an interface card also referred to as a line card. The network interface 604 comprises, for example, one or more of an infrared (IR) interface, an interface implementing Wi-Fi® of the Wireless Ethernet Compatibility Alliance, Inc., a universal serial bus (USB) interface, a FireWire® interface of Apple, Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on transmission control protocol (TCP)/internet protocol (IP), interfaces based on wireless communications technology such as satellite technology, radio frequency (RF) technology, near field communication, etc. The I/O controller 603 controls input actions and output actions performed by the information analysis platform 204. The data bus 605 permits communications between the modules, for example, 204a, 204b, 204c, 204d, 204e, 204f, 204g, 204h, 210, 211, etc., of the information analysis platform 204.

The display unit 606, via the graphical user interface (GUI) 204a, displays information, display interfaces, user interface elements such as text fields, checkboxes, text boxes, windows, etc., for allowing a borrower, a lender, a bank, or a financial institution to enter the syndicated loan transaction information comprising, for example, deal information, compliance information, transaction information associated with the loan deal, legal information, marketing information, and financial information, etc., for allowing viewing of analysis reports that help in comparing and reviewing the structure and factors impacting financial instruments, etc. The display unit 606 comprises, for example, a liquid crystal display, a plasma display, an organic light emitting diode (OLED) based display, etc. The input devices 607 are used for inputting data into the computer system 600. The borrowers, the lenders, the banks, the financial institutions, etc., use input devices 607 to provide inputs to the information analysis platform 204. For example, a user may enter loan information, enter name of a lending financial institution, upload analysis reports, upload customized analysis reports in response to the analysis requests received from a borrower, etc., using the input devices 607. The input devices 607 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

Computer applications and programs are used for operating the computer system 600. The programs are loaded onto the fixed media drive 608 and into the memory unit 602 of the computer system 600 via the removable media drive 609. In an embodiment, the computer applications and programs may be loaded directly via the network 307. Computer applications and programs are executed by double clicking a related icon displayed on the display unit 606 using one of the input devices 607. The output devices 610 output the results of operations performed by the information analysis platform 204. For example, the information analysis platform 204 provides customized reports to users using the output devices 610. The information analysis platform 204 displays the generated reports using the output devices 610.

The processor 601 executes an operating system, for example, the Linux® operating system, the Unix® operating system, any version of the Microsoft® Windows® operating system, the Mac OS of Apple Inc., the IBM® OS/2, VxWorks® of Wind River Systems, inc., QNX Neutrino® developed by QNX Software Systems Ltd., Palm OS®, the Solaris operating system developed by Sun Microsystems, Inc., the Android operating system, Windows Phone™ operating system of Microsoft Corporation, BlackBerry® operating system of Research in Motion Limited, the iOS operating system of Apple Inc., the Symbian® operating system of Symbian Foundation Limited, etc. The computer system 600 employs the operating system for performing multiple tasks. The operating system is responsible for management and coordination of activities and sharing of resources of the computer system 600. The operating system further manages security of the computer system 600, peripheral devices connected to the computer system 600, and network connections. The operating system employed on the computer system 600 recognizes, for example, inputs provided by the users using one of the input devices 607, the output display, files, and directories stored locally on the fixed media drive 608, for example, a hard drive. The operating system on the computer system 600 executes different programs using the processor 601. The processor 601 and the operating system together define a computer platform for which application programs in high level programming languages are written.

The processor 601 retrieves instructions for executing the modules, for example, 204b, 204c, 204d, 204e, 204f, 204g, 204h, 210, 211, etc., of the information analysis platform 204 from the memory unit 602. A program counter determines the location of the instructions in the memory unit 602. The program counter stores a number that identifies the current position in the program of each of the modules, for example, 204b, 204c, 204d, 204e, 204f, 204g, 204h, 210, 211, etc., of the information analysis platform 204. The instructions fetched by the processor 601 from the memory unit 602 after being processed are decoded. The instructions are stored in an instruction register in the processor 601. After processing and decoding, the processor 601 executes the instructions. For example, the data reception module 204b defines instructions for receiving the syndicated loan transaction elements 401 exemplarily illustrated in FIG. 4, from multiple data sources. The data extraction module 204c defines instructions for extracting data items from the received syndicated loan transaction elements 401. Furthermore, the data extraction module 204c defines instructions for configuring each of the received syndicated loan transaction elements 401 as a template for the extraction of the data items. The data conversion module 204d defines instructions for converting the extracted data items into multiple data fields. In an embodiment, the data conversion module 204d defines instructions for converting the extracted data items into data fields using expert inputs received via the GUI 204a. Furthermore, the data conversion module 204d defines instructions for categorizing each of the extracted data items into one of the data fields in the data management database 209.

The analytics engine 210 defines instructions for analyzing the received syndicated loan transaction elements 401 using the data fields via analytical tools 210a exemplarily illustrated in FIG. 4, and the expert inputs received via the GUI 204a. The analytics engine 210 defines instructions for comparing the data fields associated with financial instruments for valuing credit of each of the data fields in each of the financial instruments. The factor estimation module 204e defines instructions for estimating one or more factors associated with syndicated loans comprising, for example, impact of structural elements on loss given default, probability of default and pricing, etc., based on the analysis of the received syndicated loan transaction elements 401. The reporting engine 211 defines instructions for generating one or more reports based on the analysis of the received syndicated loan transaction elements 401. The data display module 204g defines instructions for retrieving and displaying detailed information for each of the received syndicated loan transaction elements 401, the extracted data items, and the data fields on the GUI 204a, on receiving an input from a user device 306 via the GUI 204a. The data management module 204f defines instructions for sharing the estimated factors associated with the syndicated loans and/or one or more of the generated reports between multiple user devices 306 via the network 307 based on predetermined sharing criteria. Furthermore, the data management module 204f defines instructions for assigning a user identifier to each of the estimated factors and/or the generated reports shared between the user devices 306 for identifying each of the user devices 306. The search engine 204h defines instructions for facilitating scanning of the received syndicated loan transaction elements 401, the extracted data items, and the data fields associated with the syndicated loans.

The processor 601 of the computer system 600 employed by the information analysis platform 204 retrieves the instructions defined by the data reception module 204b, the data extraction module 204c, the data conversion module 204d, the analytics engine 210, the factor estimation module 204e, the data management module 204f, the reporting engine 211, the data display module 204g, the search engine 204h, etc., of the information analysis platform 204, and executes the instructions, thereby performing one or more processes defined by those instructions.

At the time of execution, the instructions stored in the instruction register are examined to determine the operations to be performed. The processor 601 then performs the specified operations. The operations comprise arithmetic operations and logic operations. The operating system performs multiple routines for performing a number of tasks required to assign the input devices 607, the output devices 610, and memory for execution of the modules, for example, 204b, 204c, 204d, 204e, 204f, 204g, 204h, 210, 211, etc., of the information analysis platform 204. The tasks performed by the operating system comprise, for example, assigning memory to the modules, for example, 204b, 204c, 204d, 204e, 204f, 204g, 204h, 210, 211, etc., of the information analysis platform 204, and to data used by the information analysis platform 204, moving data between the memory unit 602 and disk units, and handling input/output operations. The operating system performs the tasks on request by the operations and after performing the tasks, the operating system transfers the execution control back to the processor 601. The processor 601 continues the execution to obtain one or more outputs. The outputs of the execution of the modules, for example, 204b, 204c, 204d, 204e, 204f, 204g, 204h, 210, 211, etc., of the information analysis platform 204 are displayed to the user on the display unit 606.

For purposes of illustration, the detailed description refers to the information analysis platform 204 being run locally on the computer system 600; however the scope of the computer implemented method and system 200 disclosed herein is not limited to the information analysis platform 204 being run locally on the computer system 600 via the operating system and the processor 601, but may be extended to run remotely over the network 307 by employing a web browser and a remote server, a mobile phone, or other electronic devices. One or more portions of the computer system 600 may be distributed across one or more computer systems (not shown) coupled to the network 307.

Disclosed herein is also a computer program product comprising a non-transitory computer readable storage medium that stores computer program codes comprising instructions executable by at least one processor 601 for analyzing and managing multiple syndicated loan transaction elements 401. As used herein, the term “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor 601, except for a transitory, propagating signal.

The computer program product comprises a first computer program code for receiving syndicated loan transaction elements 401 from multiple data sources; a second computer program code for extracting data items from the received syndicated loan transaction elements 401; a third computer program code for converting the extracted data items into multiple data fields; a fourth computer program code for analyzing the received syndicated loan transaction elements 401 using the data fields and expert inputs received via the GUI 204a; and a fifth computer program code for estimating one or more factors associated with syndicated loans based on the analysis of the received syndicated loan transaction elements 401. The computer program product disclosed herein further comprises one or more additional computer program codes for performing additional steps that may be required and contemplated for analyzing and managing syndicated loan transaction elements 401. In an embodiment, a single piece of computer program code comprising computer executable instructions performs one or more steps of the computer implemented method disclosed herein for analyzing and managing syndicated loan transaction elements 401.

The computer program codes comprising computer executable instructions are embodied on the non-transitory computer readable storage medium. The processor 601 of the computer system 600 retrieves these computer executable instructions and executes them. When the computer executable instructions are executed by the processor 601, the computer executable instructions cause the processor 601 to perform the steps of the computer implemented method for analyzing and managing syndicated loan transaction elements 401.

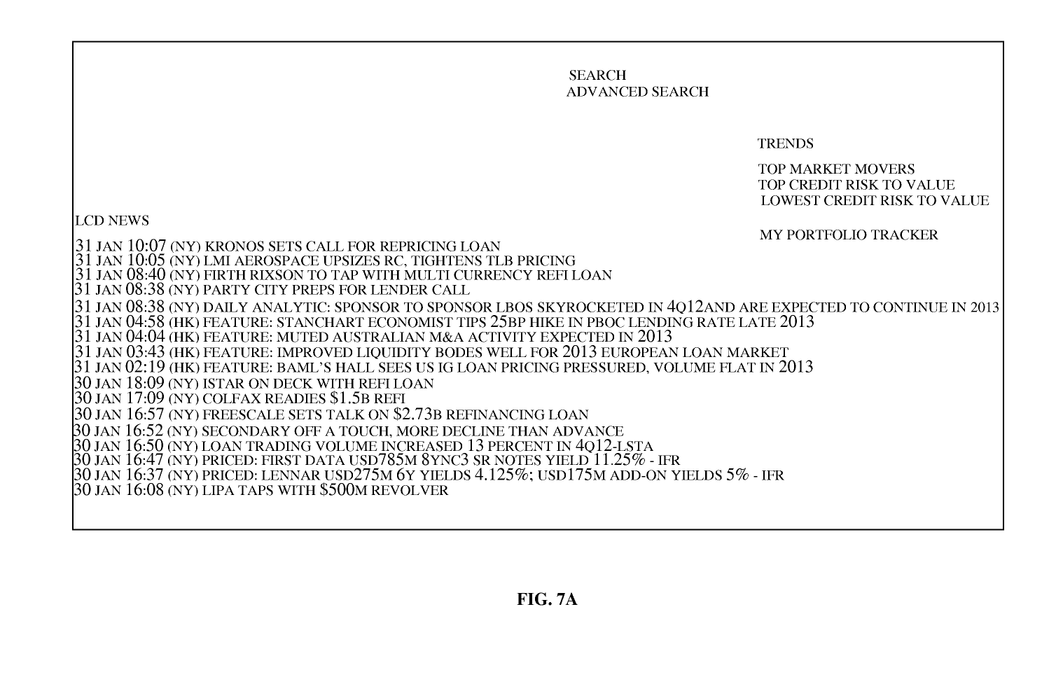

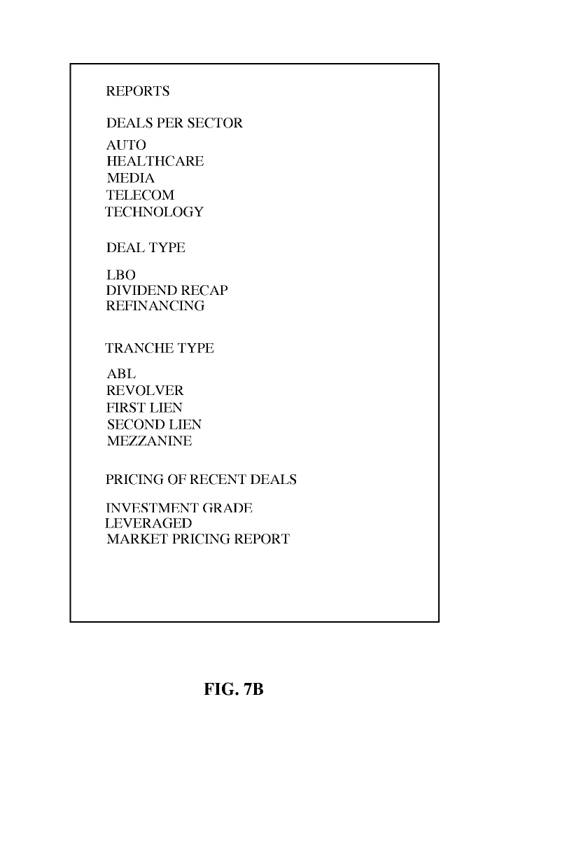

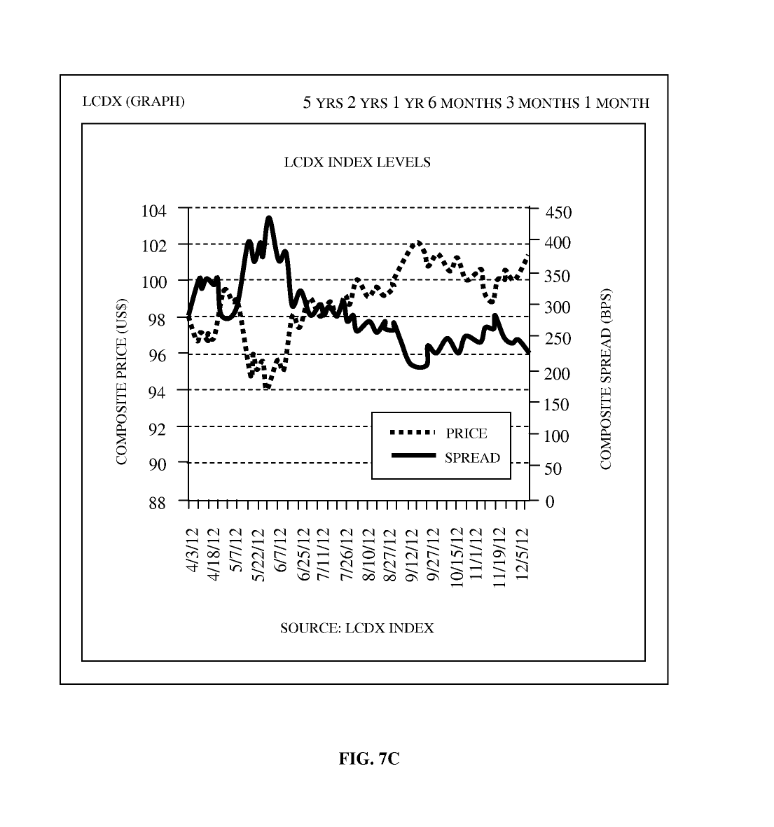

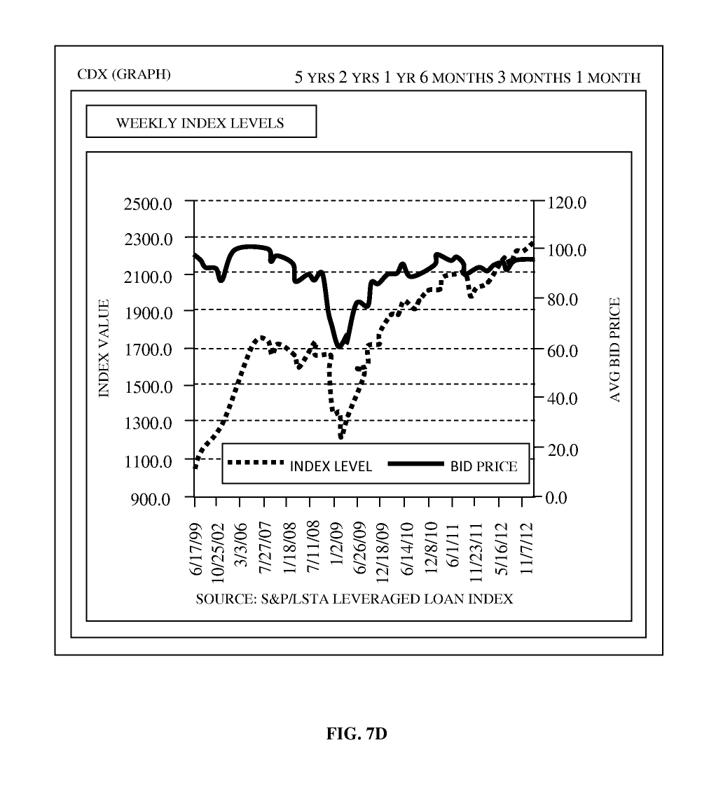

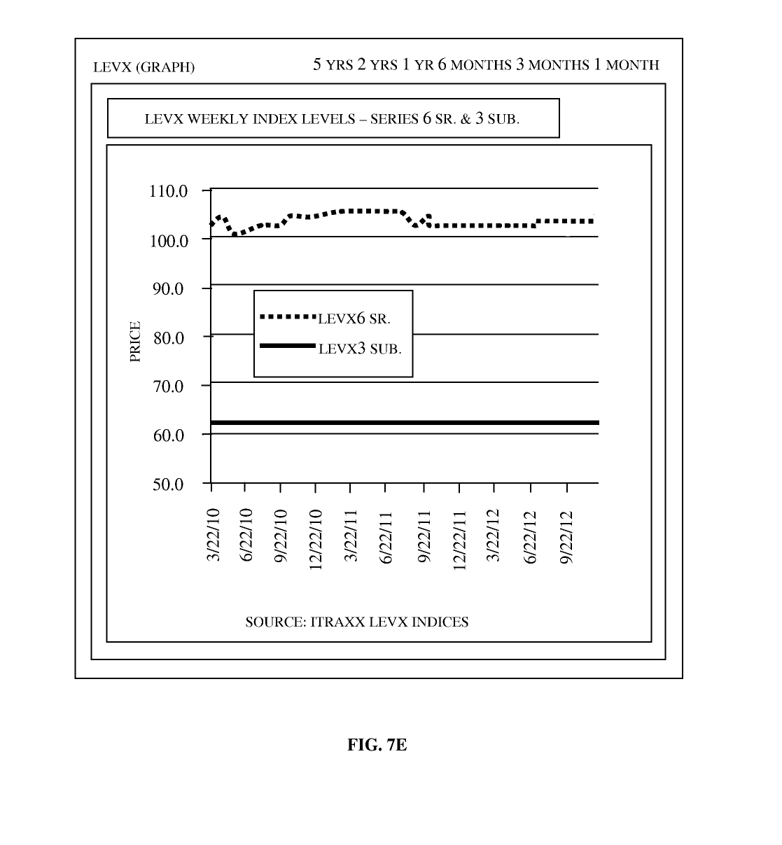

FIGS. 7A-7E exemplarily illustrate screenshots of a homepage interface provided on the graphical user interface (GUI) 204a of the information analysis platform 204 exemplarily illustrated in FIGS. 2-3 and FIG. 5. The homepage interface provides links for viewing leveraged commentary and data (LCD) news items, latest market trends, for example, top market movers, top credit risk to value, lowest credit risk to value, etc., links for accessing a portfolio tracker of a user, links for searching for various items associated with syndicated loans, etc., as exemplarily illustrated in FIG. 7A. The information analysis platform 204 allows a user to generate reports based on loan deals per sector, for example, automotive, healthcare, media, telecommunication, technology, etc. The information analysis platform 204 also allows a user to generate reports per deal type, per tranche type, based on pricing of recent deals, etc., as exemplarily illustrated in FIG. 7B. FIGS. 7C-7E exemplarily illustrate graphical representations of various market indexes, for example, loan credit default swap index (LCDX) levels, weekly index levels, leveraged loan (LEVX) weekly index levels, etc.

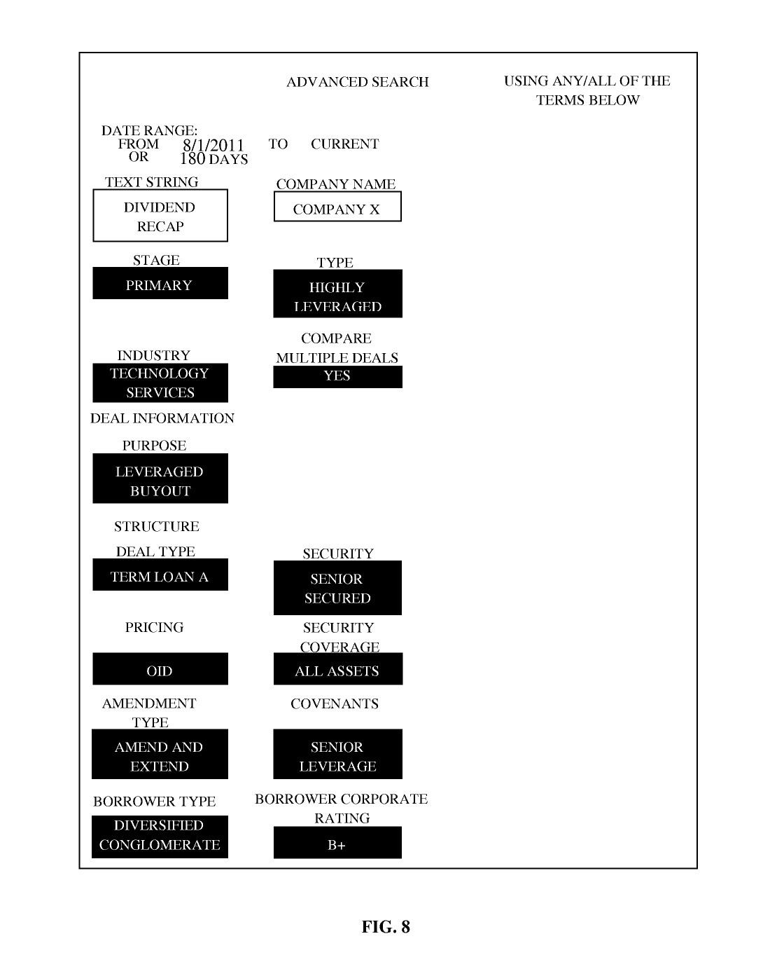

FIG. 8 exemplarily illustrates a screenshot of an advanced search interface provided on the GUI 204a of the information analysis platform 204 exemplarily illustrated in FIGS. 2-3 and FIG. 5. The advanced search interface allows users to perform an advanced search by entering search criteria in various fields comprising, for example, a date range, a company name, a type of text string, a type of lending, a stage of lending such as primary stage or secondary stage, an industry type, etc., and deal information fields comprising, for example, a purpose, a structure, a deal type, security, pricing, security coverage, a borrower type, a borrower, an amendment type, covenants, etc. The advanced search interface allows a user to select a date range, for example, from 1 day, 7 days, 30 days, 60 days, 180 days, 1 year, a range >1 year, etc. The type of lending comprises, for example, asset based, leveraged, highly leveraged, investment grade, middle market, near investment grade, etc. The industry type comprises, for example, technology services, retail, consumer services, oil and gas, utilities, telecommunication, technology hardware, financial institutions, etc. The advanced search interface allows a user to select a purpose from options, for example, leveraged buyout, debtor in possession, dividend recap, general corp purposes, leveraged recap, etc. The advanced search interface allows a user to select a deal type from options, for example, bilateral, borrowing base, bridge loan, covenant lite, delayed draw, etc.

The advanced search interface also allows a user to select a security coverage from options, for example, all assets, borrowing base, equity of subsidiaries, etc. The advanced search interface allows a user to select an amendment type from options, for example, amend and extend, covenant waiver, structural change, etc. The advanced search interface also allows a user to select a borrower type from options, for example, diversified conglomerate, semi sovereign, sovereign, etc. The advanced search interface allows a user to select covenants from options, for example, senior secured leverage, total leverage, assets, springing leverage, etc. The advanced search interface allows users to select any or all of the terms, for example, by industry, select all recent deals, by deal type, and also select the terms to compare.

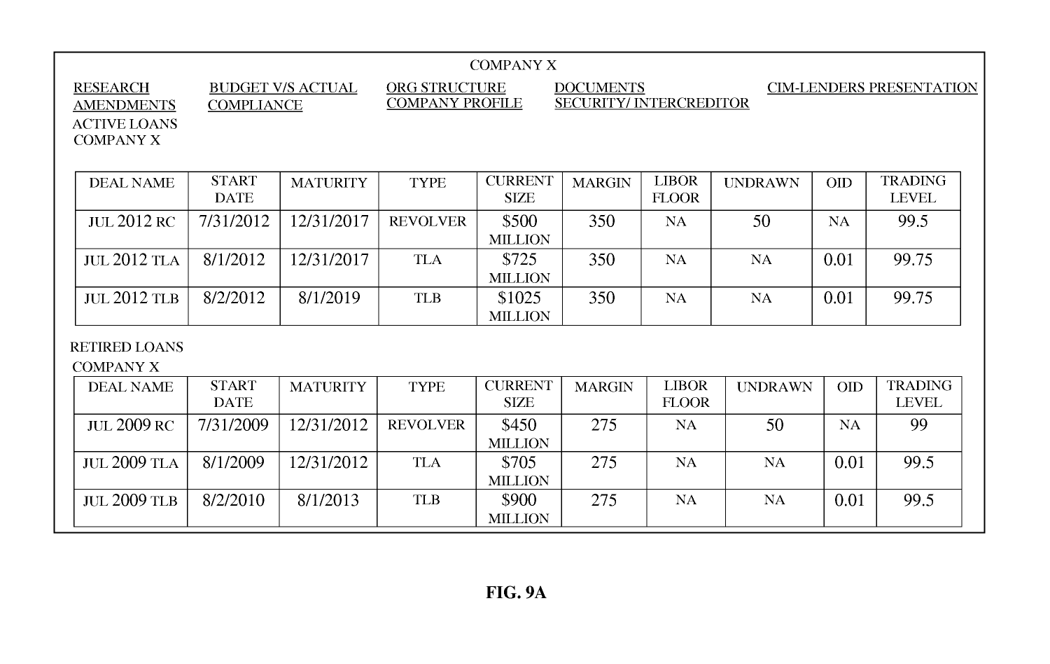

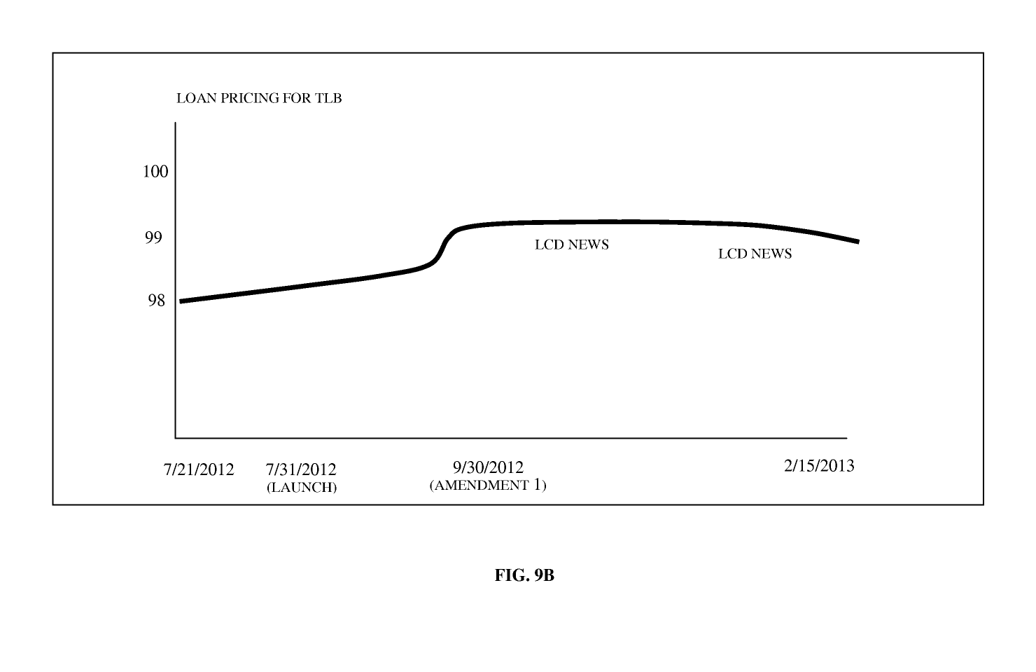

FIGS. 9A-9B exemplarily illustrate screenshots of a company interface provided on the GUI 204a of the information analysis platform 204 exemplarily illustrated in FIGS. 2-3 and FIG. 5. The company interface of the information analysis platform 204 provides company information comprising, for example, organization structure, a company profile, research, amendments, compliance information, etc., as exemplarily illustrated in FIG. 9A. The company interface also displays deal information comprising, for example, the start date and maturity date, current size, trading level, margin, etc., of the loan deals provided by the company. The company interface provides graphical representations of loan pricing for an institutional term loan, for example, term loan B (TLB) as exemplarily illustrated in FIG. 9B.

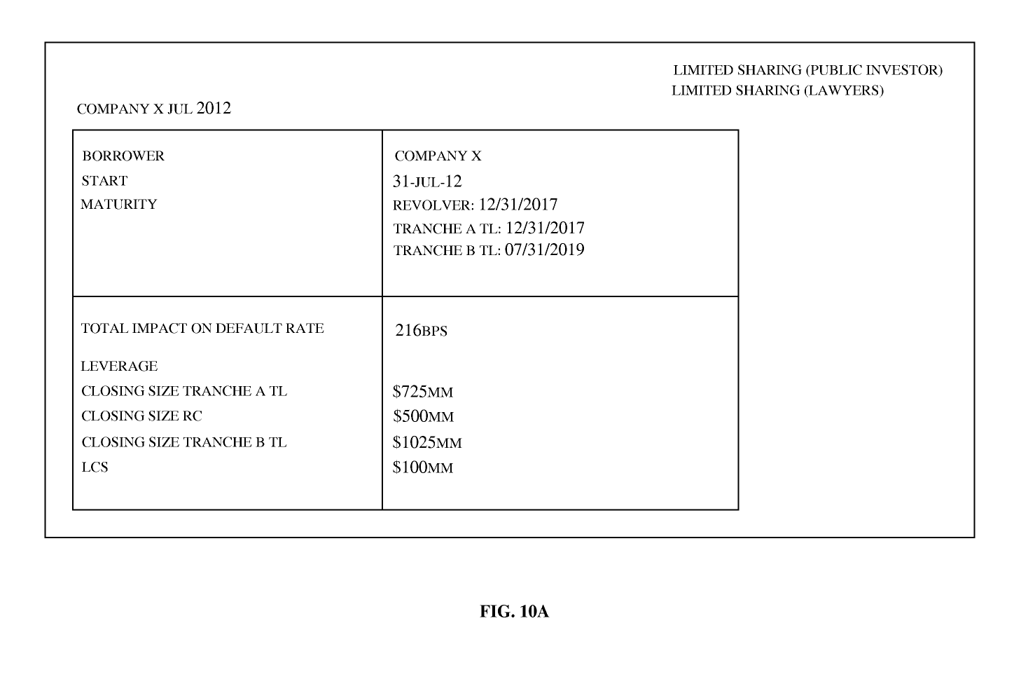

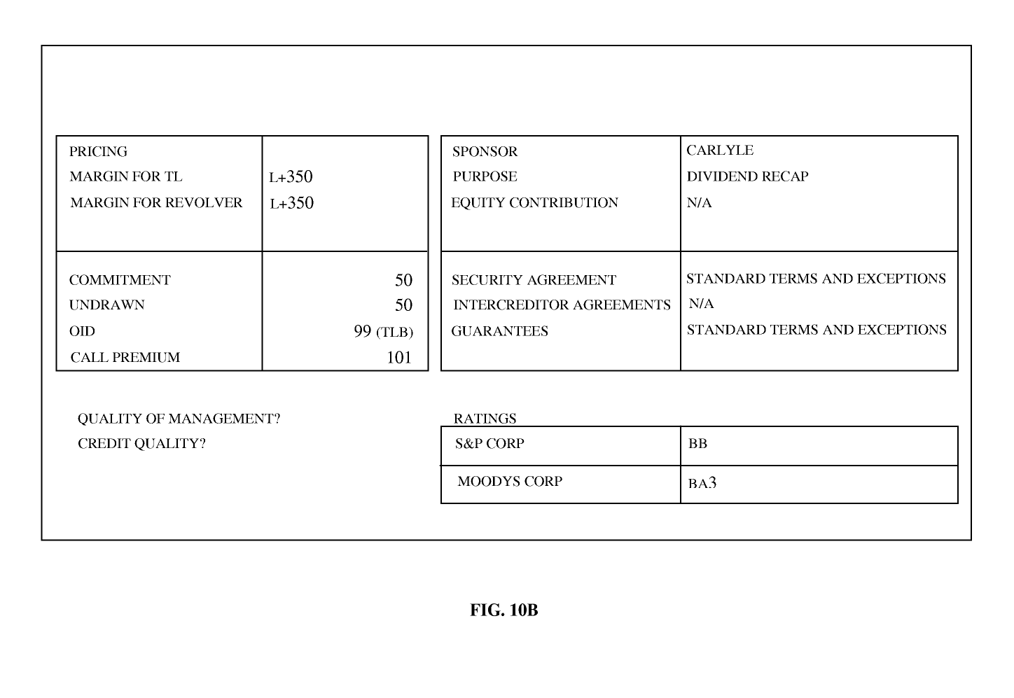

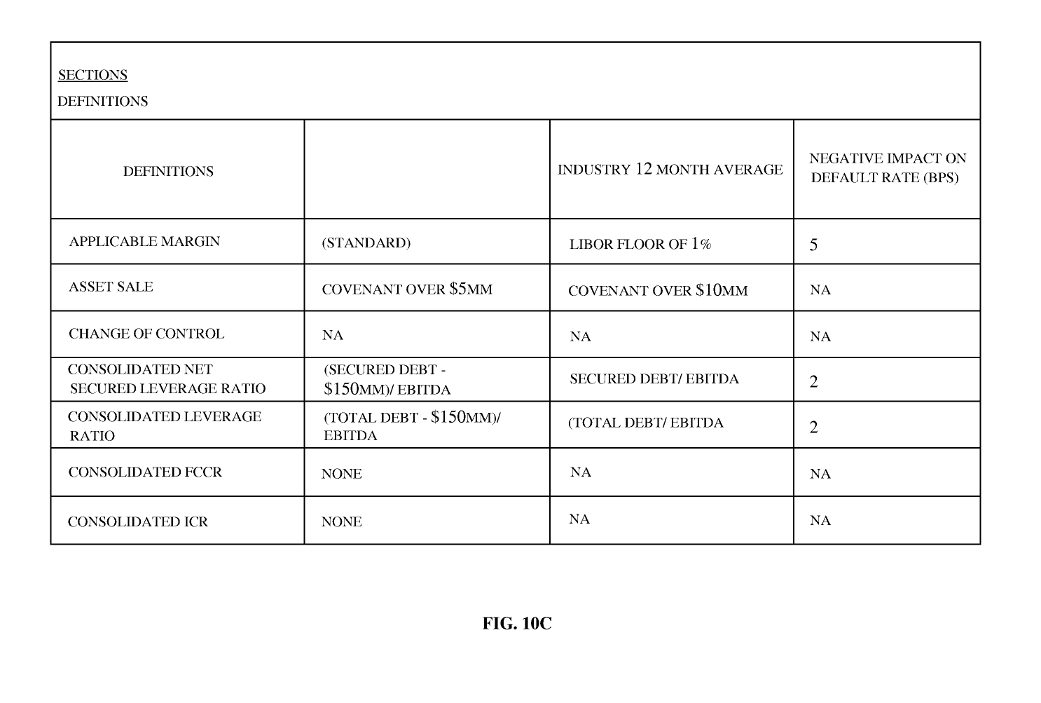

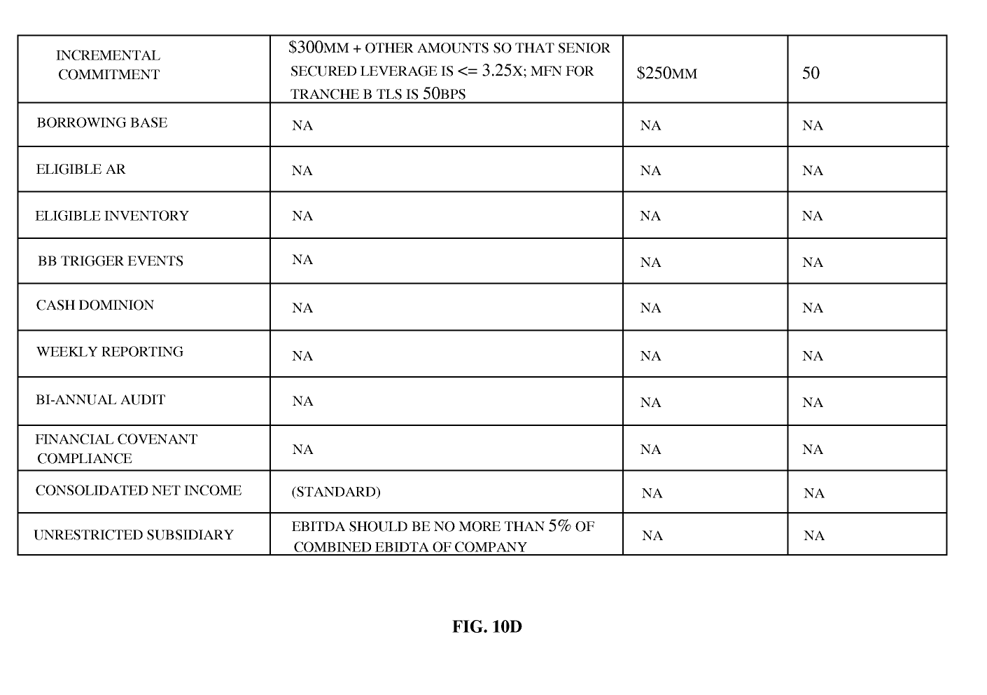

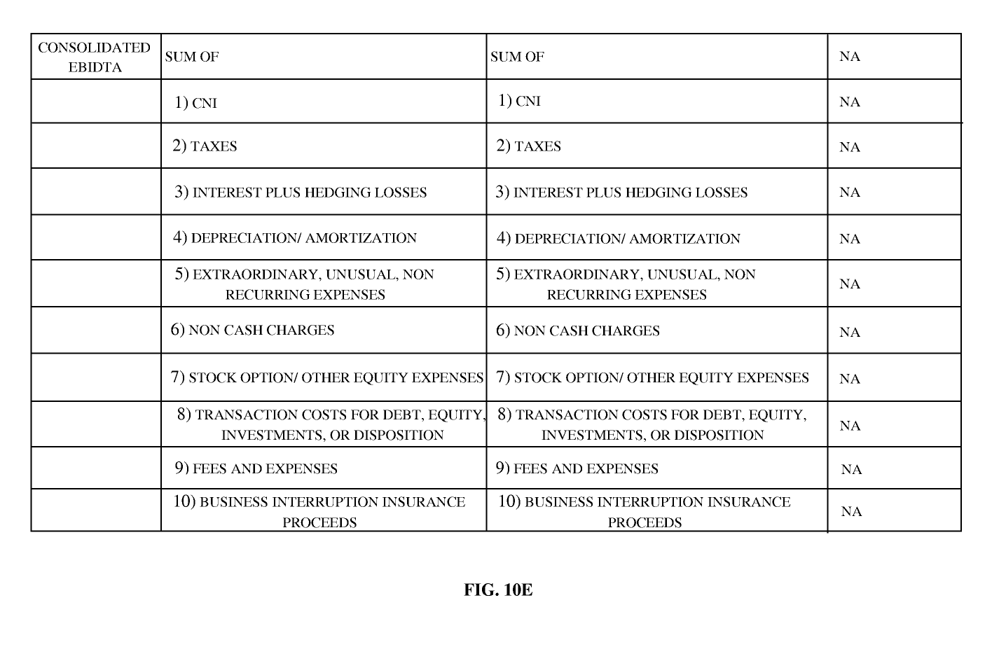

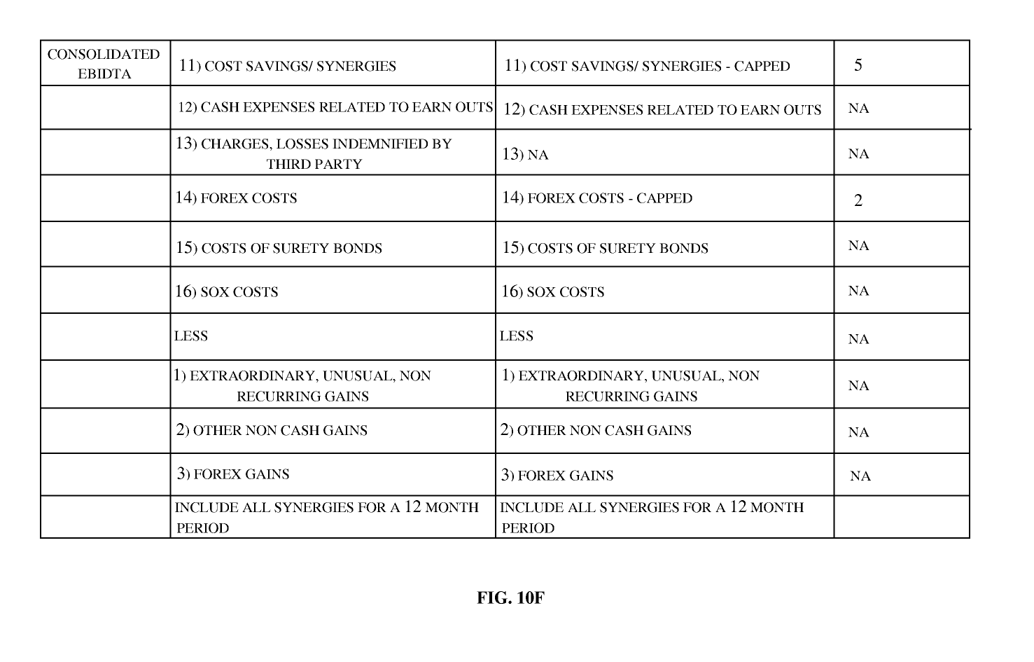

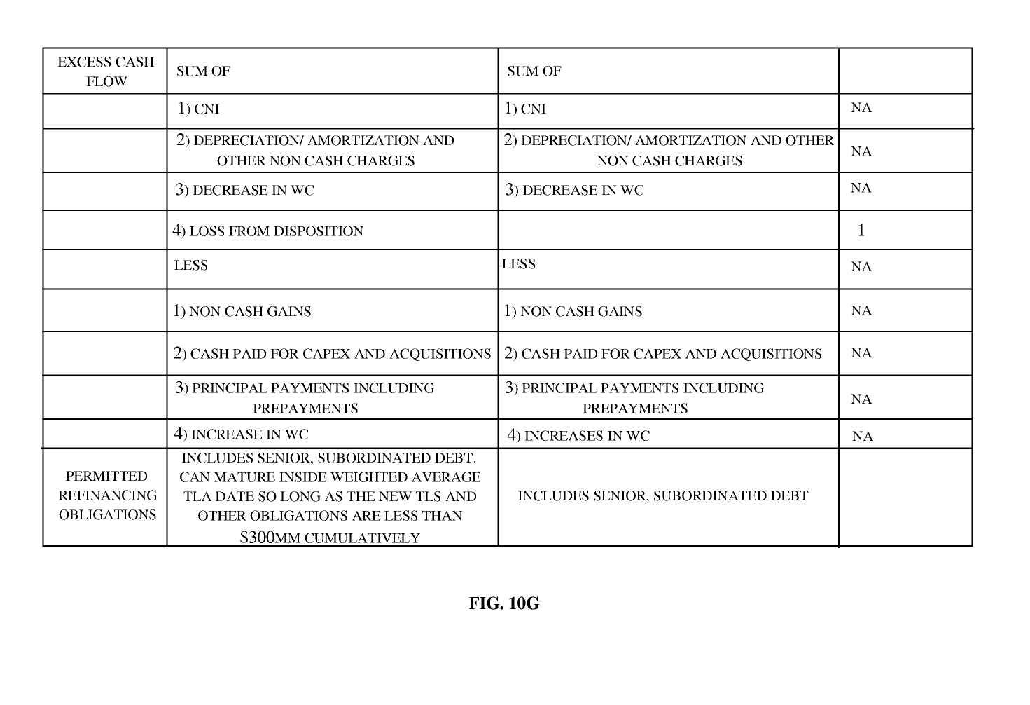

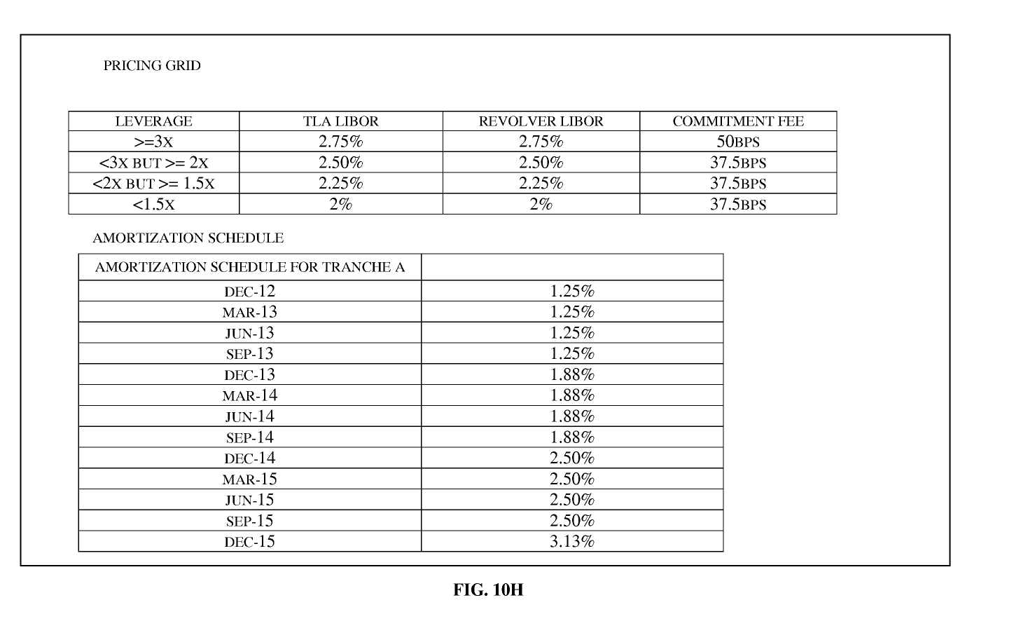

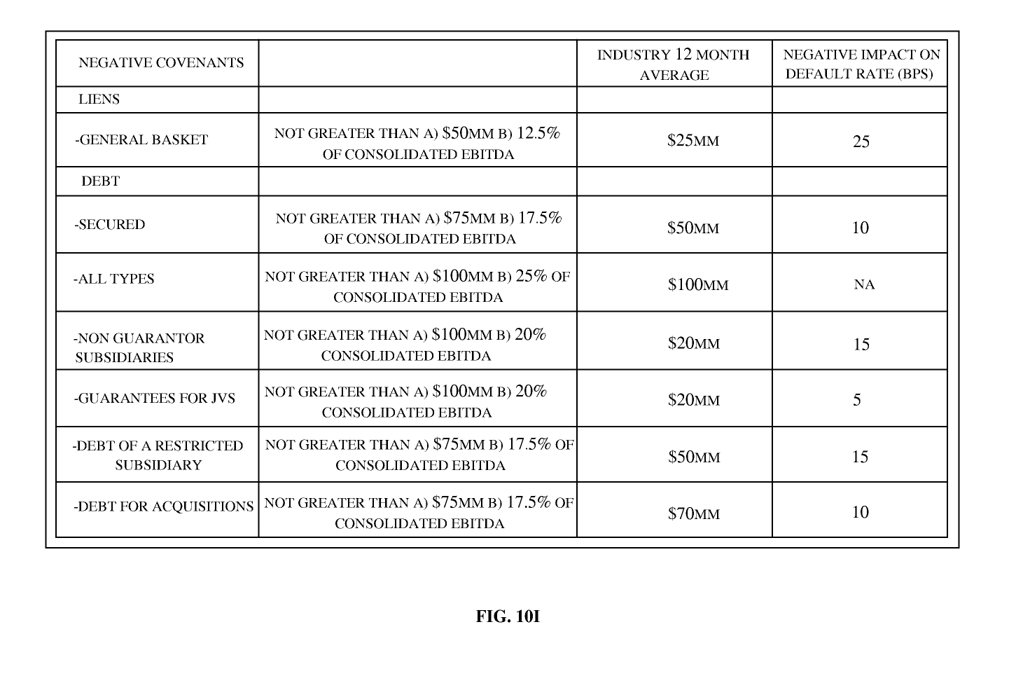

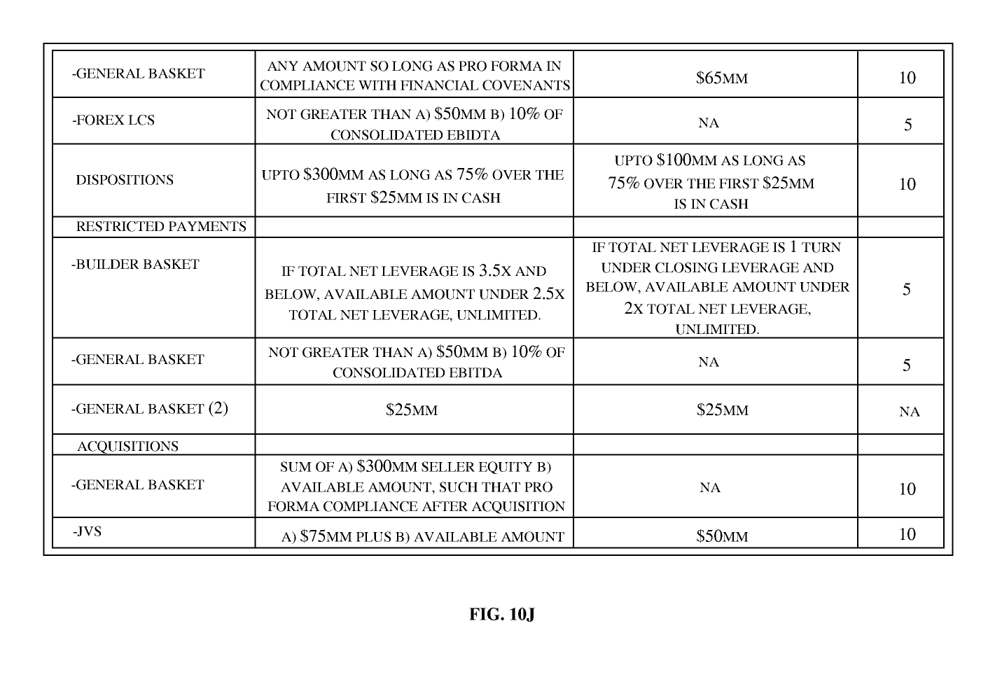

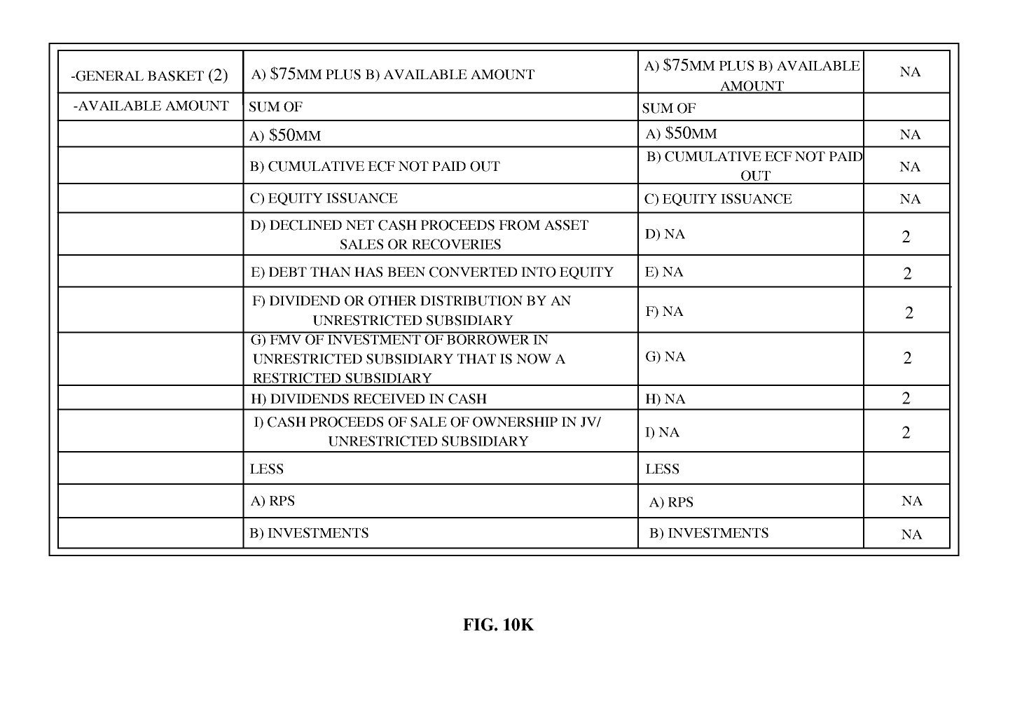

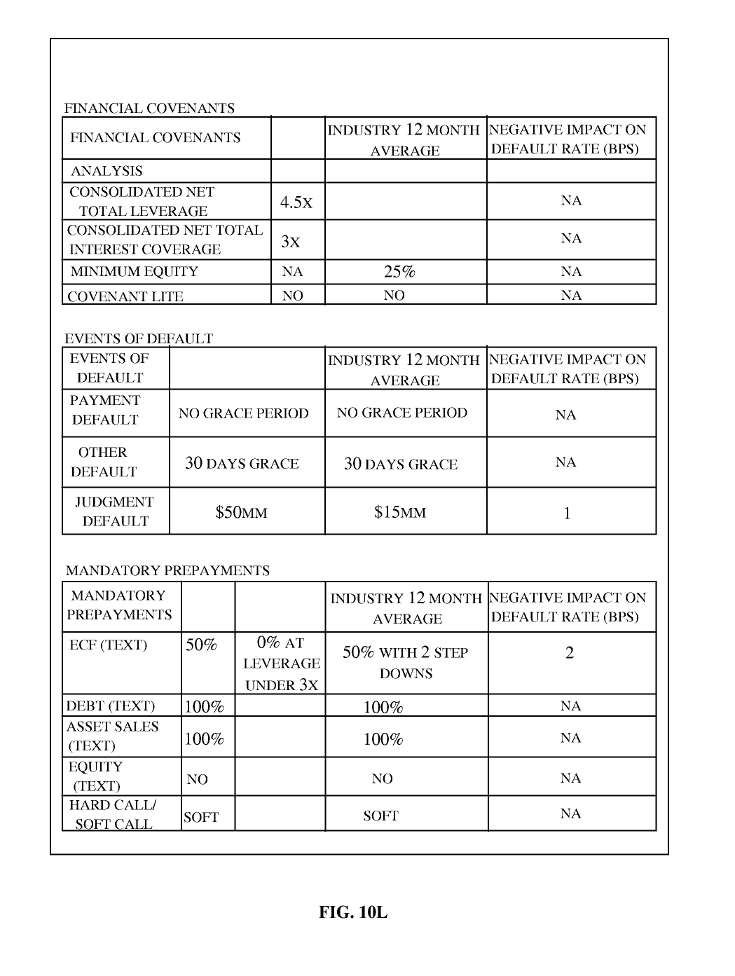

FIGS. 10A-10L exemplarily illustrate screenshots of a company-credit agreement (CA) interface provided on the GUI 204a of the information analysis platform 204 exemplarily illustrated in FIGS. 2-3 and FIG. 5. The company-CA interface provides detailed structural information about negative covenants, pricing, liens, financial analysis, acquisitions, definitions, mandatory prepayments, events of default, etc. The company-CA interface provides limited sharing links for both public investors and lawyers as exemplarily illustrated in FIG. 10A. When a user, for example, a lawyer clicks on the limited sharing link, the information analysis platform 204 displays a pop up window requesting the user for an electronic mail address for sharing a limited portion of the structural information. The company-CA interface provides pricing information comprising, for example, margin for term loans (TL), margin for revolver loans, etc., as exemplarily illustrated in FIG. 10B. The margin for term loans and revolver loans is, for example, L+275 for 6 months after closing as per amendment number 1, dated September, 2012. Amendment 1 proposed to reduce the pricing rates, for example, from about 375 basis points (bps) to about 350 bps and also amended the call premium that is soft call for early redemption, for example, to about $101.

The information analysis platform 204 generates and displays detailed information for the received syndicated loan transaction elements 401 exemplarily illustrated in FIG. 4, the extracted data items, and the data fields on the GUI 204a, on receiving an input from a user device 306 via the GUI 204a. When a user hovers over the data fields, using a mouse pointer or clicks on a data field, the information analysis platform 204 displays a pop up window showing detailed information or a definition of the term in the data field. For example, when a user clicks on the applicable margin field exemplarily illustrated in FIG. 10C, the information analysis platform 204 displays the following detailed information in a pop up window: ““Applicable Margin” or “Applicable Commitment Fee Rate”: for any day, with respect to (i) the Loans under the Revolving Facility and the Tranche A Term Loan Facility, and the commitment fee payable hereunder, the applicable rate per annum determined pursuant to the Pricing Grid and (ii) the Loans under the Tranche B Term Loan Facility, in the case of the Applicable Margin, 2.50% with respect to Initial Tranche B Term Loans that are ABR Loans and 3.50% with respect to Initial Tranche B Term Loans that are Eurocurrency Loans; provided that from the Closing Date until the six-month anniversary of the Closing Date (a) the Applicable Margin shall be 1.75% with respect to Initial Tranche A Term Loans and Revolving Loans that are ABR Loans and 2.75% with respect to Initial Tranche A Term Loans and Revolving Loans that are Eurocurrency Loans and (b) the Applicable Commitment Fee Rate shall be 0.50%, and, thereafter, the Applicable Margin and Applicable Commitment Fee Rate with respect to Initial Tranche A Term Loans and Revolving Loans shall be determined in accordance with the Pricing Grid and the Applicable Margin with respect to Initial Tranche B Term Loans shall be determined in accordance with clause (ii) and the first proviso of this definition, in each case, based on the most recently delivered financial statements delivered pursuant to Section 6.1.”.

In another example, when a user clicks on the asset sale field exemplarily illustrated in FIG. 10C, the information analysis platform 204 displays the following detailed information in a pop up window: ““Asset Sale”: any Disposition of Property or series of related Dispositions of Property by the Borrower or any of its Restricted Subsidiaries not in the ordinary course of business (a) under Section 7.5(e) or (p) or (b) not otherwise permitted under Section 7.5, in each case, which yields Net Cash Proceeds (valued at the initial principal amount thereof in the case of non-cash proceeds consisting of notes or other debt securities and valued at Fair Market Value in the case of other non-cash proceeds) in excess of $5,000,000.”. In another example, when a user clicks on the change of control field the information analysis platform 204 displays the following detailed information in a pop up window: “8.1 (j) (j) (i) Parent shall cease to own, directly or indirectly, 100% of the Capital Stock of Investor; (ii) Investor shall cease to own, directly or indirectly, 100% of the Capital Stock of the Borrower; or (iii) for any reason whatsoever, (x) a majority of the Board of Directors of Parent shall not be Continuing Directors or (y) any “person” or “group” (within the meaning of Rule 13d-5 of the Securities Exchange Act of 1934 as in effect on the Closing Date, but excluding any employee benefit plan of such person and its subsidiaries, and any person or entity acting in its capacity as trustee, agent or other fiduciary or administrator of such plan, and excluding the Permitted Investors) shall become the “beneficial owner” (within the meaning of Rule 13d-3 and 13d-5 of the Securities Exchange Act of 1934 as in effect on the Closing Date), directly or indirectly, of more than the greater of (x) 35% of the then outstanding voting securities having ordinary voting power of Parent and (y) the percentage of the then outstanding voting securities having ordinary voting power of Parent owned, directly or indirectly, beneficially (within the meaning of Rule 13d-3 and 13d-5 of the Securities Exchange Act of 1934 as in effect on the Closing Date) by the Permitted Investors (it being understood that if any such person or group includes one or more Permitted Investors, the outstanding voting securities having ordinary voting power of Parent directly or indirectly owned by the Permitted Investors that are part of such person or group shall not be treated as being owned by such person or group for purposes of determining whether this clause (y) is triggered) (any of the foregoing, a “Change of Control”).”

In another example, when a user clicks on the consolidated net secured leverage field exemplarily illustrated in FIG. 10C, the information analysis platform 204 displays the following detailed information in a pop up window: ““Consolidated Net Senior Secured Leverage”: at any date, (a) the aggregate principal amount of all senior secured Funded Debt of the Borrower and its Restricted Subsidiaries on such date, minus (b) Unrestricted Cash on such date in an aggregate amount not to exceed $150,000,000, in each case determined on a consolidated basis in accordance with GAAP. “Consolidated Net Senior Secured Leverage Ratio”: as of any date of determination, the ratio of (a) Consolidated Net Senior Secured Leverage on such day to (b) Consolidated EBITDA of the Borrower and its Restricted Subsidiaries for the most recently ended Test Period.”. In another example, when a user clicks on the consolidated leverage ratio field, the information analysis platform 204 displays the following detailed information in a pop up window: ““Consolidated Net Total Leverage”: at any date, (a) the aggregate principal amount of all Funded Debt of the Borrower and its Restricted Subsidiaries on such date, minus (b) Unrestricted Cash on such date in an aggregate amount not to exceed $150,000,000, in each case determined on a consolidated basis in accordance with GAAP. “Consolidated Net Total Leverage Ratio”: as of any date of determination, the ratio of (a) Consolidated Net Total Leverage on such day to (b) Consolidated EBITDA of the Borrower and its Restricted Subsidiaries for the most recently ended Test Period.”

In another example, when a user clicks on the incremental commitment field exemplarily illustrated in FIG. 10D, the information analysis platform 204 displays the following detailed information in a pop up window: ““Maximum Incremental Facilities Amount”: at any date of determination, the sum of (a) $300,000,000 and (b) an additional amount if, after giving pro form a effect to the incurrence of such additional amount (and in the case of any New Revolving Commitments or Revolving Commitment Increase being initially provided on any date of determination, as if loans there under were drawn in full on such date) and after giving effect to any acquisition consummated concurrently therewith and all other appropriate pro form a adjustment events, the Consolidated Net Senior Secured Leverage Ratio is equal to or less than 3.25:1.00 (it being understood that (A) if pro form a effect is given to the entire committed amount of any such amount, such committed amount may thereafter be borrowed and re-borrowed, in 26 whole or in part, from time to time, without further compliance with this clause and (B) for purposes of calculating the Consolidated Net Senior Secured Leverage Ratio only, any such amount incurred shall be treated as if such amount is senior secured Funded Debt, regardless of whether such amount is actually secured).”

In another example, when a user clicks on the consolidated net income field exemplarily illustrated in FIG. 10D, the information analysis platform 204 displays the following detailed information in a pop up window: ““Consolidated Net Income”: of any Person for any period, the consolidated net income (or loss) of such Person and its Restricted Subsidiaries for such period, determined on a consolidated basis in accordance with generally accepted accounting principles (GAAP); provided that in calculating Consolidated Net Income of the Borrower and its consolidated Restricted Subsidiaries for any period, there shall be excluded (a) the income (or loss) of any Person accrued prior to the date it becomes a Restricted Subsidiary or is merged into or consolidated with the Borrower or any of its Subsidiaries, (b) the income (or loss) of any Person (other than a Restricted Subsidiary) in which the Borrower or any of its Restricted Subsidiaries has an ownership interest (including any joint venture), except to the extent that any such income is actually received by the Borrower or such Restricted Subsidiary in the form of dividends or similar distributions (which dividends and distributions shall be included in the calculation of Consolidated Net Income) and (c) any income (loss) for such period attributable to the early extinguishment of Indebtedness or Hedge Agreements. Notwithstanding the foregoing, for purposes of calculating Excess Cash Flow, Consolidated Net Income (x) shall not include: (i) extraordinary gains for such period and (ii) the cumulative effect of a change in accounting principles during such period, and (y) shall be reduced by any fees and expenses incurred during such period, or any amortization thereof for such period, in connection with any acquisition, investment, recapitalization, asset disposition, issuance or repayment of debt, issuance of equity securities, refinancing transaction or amendment or other modification of any debt instrument (in each case, including any such transaction undertaken but not completed) and any charges or non-recurring costs incurred during such period as a result of any such transaction. Unless otherwise qualified, all references to “Consolidated Net Income” in this Agreement shall refer to Consolidated Net Income of the Borrower. There shall be excluded from Consolidated Net Income for any period the purchase accounting effects of adjustments to inventory, Property and equipment, software and other intangible assets and deferred revenue required or permitted by GAAP and related authoritative pronouncements (including the effects of such adjustments pushed down to the Borrower and the Restricted Subsidiaries), as a result of any consummated acquisition whether consummated before or after the Closing Date, or the amortization or write-off of any amounts thereof.”

In another example, when a user clicks on the unrestricted subsidiary field exemplarily illustrated in FIG. 10D, the information analysis platform 204 displays the following detailed information in a pop up window: “Unrestricted Subsidiary”: (i) any Subsidiary of the Borrower designated as such and listed on Schedule 4.14 on the Closing Date and (ii) any Subsidiary of the Borrower that is designated by a resolution of the Board of Directors of the Borrower as an Unrestricted Subsidiary, but only to the extent that, in the case of each of clauses (i) and (ii), such Subsidiary: (a) has no Indebtedness other than Non-Recourse Debt; (b) is not party to any agreement, contract, arrangement or understanding with the Borrower or any Restricted Subsidiary unless (x) the terms of any such agreement, contract, arrangement or understanding are no less favorable to the Borrower or such Restricted Subsidiary than those that might be obtained at the time from Persons who are not Affiliates of the Borrower or (y) the Borrower or any Restricted Subsidiary would be permitted to enter into such agreement, contract, arrangement or understanding with an Unrestricted Subsidiary pursuant to Section 7.9; (c) is a Person with respect to which neither the Borrower nor any of the Restricted Subsidiaries has any direct or indirect obligation (x) to subscribe for additional Capital Stock or warrants, options or other rights to acquire Capital Stock or (y) to maintain or preserve such Person's financial condition or to cause such Person to achieve any specified levels of operating results, unless, in each case, the Borrower or any Restricted Subsidiary would be permitted to incur any such obligation with respect to an Unrestricted Subsidiary pursuant to Section 7.7; and (d) does not guarantee or otherwise provide credit support after the time of such designation for any Indebtedness of the Borrower or any of its Restricted Subsidiaries, in the case of clauses (a), (b) and (c), except to the extent not otherwise prohibited by Section 7; provided that after giving effect to any such designation of a Domestic Subsidiary, the combined Consolidated EBITDA of Domestic Subsidiaries that are Unrestricted Subsidiaries for the most recently ended Test Period for which financial statements have been delivered pursuant to Section 6.1 does not exceed 5% of the Consolidated EBITDA of the Borrower and its Subsidiaries for the most recently ended Test Period for which financial statements have been delivered pursuant to Section 6.1 . . . ”.

In another example, when a user clicks on the consolidated earnings before interest, taxes, depreciation and amortization (EBITDA) field exemplarily illustrated in FIGS. 10E-10F, the information analysis platform 204 displays the following detailed information in a pop up window: ““Consolidated EBITDA”: of any Person for any period, Consolidated Net Income of such Person and its Restricted Subsidiaries for such period plus, without duplication and, if applicable, except with respect to clauses (i) and (j) of this definition, to the extent reflected as a charge in the statement of such Consolidated Net Income (regardless of classification) for such period, the sum of: (a) provisions for taxes based on income (or similar taxes in lieu of income taxes), profits, capital (or equivalents), including federal, foreign, state, local, franchise, excise and similar taxes and foreign withholding taxes of such Person paid or accrued during such period; (b) Consolidated Net Interest Expense and, to the extent not reflected in such Consolidated Net Interest Expense, any net losses on hedging obligations or other derivative instruments entered into for the purpose of hedging interest rate risk, amortization or write-off of debt discount and debt issuance costs and commissions, premiums, discounts and other fees and charges associated with Indebtedness (including commitment, letter of credit and administrative fees and charges with respect to the Facilities); (c) depreciation and amortization expense and impairment charges (including deferred financing fees, capitalized software expenditures, intangibles (including goodwill), organization costs and amortization of unrecognized prior service costs and actuarial gains and losses related to pensions and other post-employment benefits); (d) any extraordinary, unusual or non-recurring expenses or losses (including (x) losses on sales of assets outside of the ordinary course of business and restructuring and integration costs or reserves, including any severance costs, costs associated with office and facility openings, closings and consolidations, relocation costs and other non recurring business optimization expenses, (y) any expenses in connection with the Recapitalization Transactions (as defined in the Existing Credit Agreement) (including expenses in respect of adjustments to the outstanding stock options in connection with the Recapitalization Transactions) and (z) any expenses in connection with the 2012 Transactions (including expenses in respect of adjustments to the outstanding stock options in connection with the 2012 Transactions)); . . . ”

In another example, when a user clicks on the excess cash flow field exemplarily illustrated in FIG. 10G, the information analysis platform 204 displays the following detailed information in a pop up window: “Excess Cash Flow”: for any fiscal year of the Borrower, the difference, if any, of (a) the sum, without duplication, of (i) Consolidated Net Income of the Borrower for such fiscal year, (ii) the amount of all non-cash charges (including depreciation, amortization, deferred tax expense and equity compensation expenses) deducted in arriving at such Consolidated Net Income, (iii) the amount of the decrease, if any, in Consolidated Working Capital for such fiscal year (excluding any decrease in Consolidated Working Capital relating to leasehold improvements for which the Borrower or any of its Subsidiaries is reimbursed in cash or receives a credit) and (iv) the aggregate net amount of non cash loss on the Disposition of Property by the Borrower and its Restricted Subsidiaries during such fiscal year (other than sales of inventory in the ordinary course of business), to the extent deducted in arriving at such Consolidated Net Income; minus (b) the sum, without duplication (including, in the case of clauses (ii) and (viii) below, duplication across periods (provided that all or any portion of the amounts referred to in clauses (ii) and (viii) below with respect to a period may be applied in the determination of Excess Cash Flow for any subsequent period to the extent such amounts did not previously result in a reduction of Excess Cash Flow in any prior period)) . . . ”

In another example, when a user clicks on the permitted refinancing obligations field exemplarily illustrated in FIG. 10G, the information analysis platform 204 displays the following detailed information in a pop up window: ““Permitted Refinancing Obligations”: senior or subordinated Indebtedness (which Indebtedness may be (x) secured by the Collateral on a junior basis, (y) unsecured or (z) in the case of Indebtedness incurred under this Agreement, customary bridge financings or debt securities, secured by the Collateral on a pari passu basis), including customary bridge financings, in each case issued or incurred by the Borrower or a Guarantor to refinance Indebtedness and/or Revolving Commitments incurred under this Agreement and the Loan Documents, including Indebtedness incurred to pay fees, discounts, premiums and expenses in connection therewith; provided that (a) the terms of such Indebtedness, other than a revolving credit facility that does not include scheduled commitment reductions prior to maturity, shall not provide for a maturity date or weighted average life to maturity earlier than the maturity date or shorter than the weighted average life to maturity of the Indebtedness being refinanced, as applicable (other than an earlier maturity date and/or shorter weighted average life to maturity for customary bridge financings, which, subject to customary conditions, would either be automatically converted into or required to be exchanged for permanent financing which does not provide for an earlier maturity date or a shorter weighted average life to maturity than the maturity date or the weighted average life to maturity of the Indebtedness being refinanced, as applicable), except that the Borrower and the Guarantors may incur Indebtedness that matures earlier than the maturity date and has a weighted average life to maturity shorter than that of the Indebtedness being refinanced, as applicable (such Indebtedness, the “Inside Maturity Permitted Refinancing Obligations”) . . . ”.

In another example, when a user clicks on the pricing grid field exemplarily illustrated in FIG. 10H, the information analysis platform 204 displays the following detailed information in a pop up window: ““Pricing Grid”: the table set forth below: Consolidated Net Total Leverage Ratio, Applicable Margin for Initial Tranche A Term Loans that are Eurocurrency Loans, Applicable Margin for Initial Tranche A Term Loans that are ABR Loans, Applicable Margin for Revolving Loans that are Eurocurrency Loans, Applicable Margin for Revolving Loans that are ABR Loans, Applicable CommitmentFee Rate=3.00:1.00; 2.75%, 1.75%, 2.75%, 1.75%, 0.500%, <3.00:1.00 but 2.00 to 1.00; 2.50%, 1.50%, 2.50%, 1.50%, 0.375%, <2.00 to 1.00 but 1.50:1.00, 2.25%, 1.25%, 2.25%, 1.25%, 0.375%, <1.50:1.00, 2.00%, 1.00%, 2.00%, 1.00%, 0.375%, 32”.

In another example, when a user clicks on the amortization schedule field exemplarily illustrated in FIG. 10H, the information analysis platform 204 displays the following detailed information in a pop up window: “2.3 Repayment of Term Loans. (a) The Initial Tranche A Term Loan of each Tranche A Term Lender shall be payable on each date set forth below in an amount set forth opposite such date (expressed as a percentage of the stated principal amount of the Initial Tranche A Term Loans funded on the Closing Date) (which installments shall, to the extent applicable, be reduced as a result of the application of prepayments in accordance with the order of priority set forth in Section 2.18(b), or be increased as a result of any increase in the amount of Initial Tranche A Term Loans pursuant to Supplemental Term Loan Commitments (such increased amortization payments to be calculated in the same manner (and on the same basis) as the schedule set forth below for the Initial Tranche A Term Loans made as of the Closing Date)), with the remaining balance thereof payable on the Tranche A Term Maturity Date. Dec. 31, 2012: 1.25%, Mar. 31, 2013: 1.25% Jun. 30, 2013: 1.25%, Sep. 30, 2013: 1.25%, Dec. 31, 2013: 1.875%, Mar. 31, 2014: 1.875%, Jun. 30, 2014: 1.875%, Sep. 30, 2014: 1.875%, Dec. 31, 2014: 2.5%, Mar. 31, 2015: 2.5%, Jun. 30, 2015: 2.5%, Sep. 30, 2015: 2.5%, Dec. 31, 2015: 3.125%, Mar. 31, 2016: 3.125%, Jun. 30, 2016: 3.125%, Sep. 30, 2016: 3.125%, Dec. 31, 2016: 13%, Mar. 31, 2017: 13%, Jun. 30, 2017: 13%, Sep. 30, 2017: 13%, Dec. 31, 2017: 13%, (b) The Initial Tranche B Term Loan of each Tranche B Term Lender shall be payable in equal consecutive quarterly installments, commencing on Dec. 31, 2012, on the last Business Day of each March, June, September and December following the Closing Date in an amount equal to one quarter of one percent (0.25%) of the stated principal amount of the Initial Tranche B Term Loans funded on the Closing Date (which installments shall, to the extent applicable, be reduced as a result of the application of prepayments in accordance with the order of priority set forth in Section 2.18(b), or be increased as a result of any increase in the amount of Initial Tranche B Term Loans pursuant to Supplemental Term Loan Commitments (such increased amortization payments to be calculated in the same manner (and on the same basis) as the schedule set forth below for the Initial Tranche B Term Loans made as of the Closing Date)), with the remaining balance thereof payable on the Tranche B Term Maturity Date.”

In another example, when a user clicks on the liens field exemplarily illustrated in FIG. 10I, the information analysis platform 204 displays the following detailed information in a pop up window: “7.3 Liens. Create, incur, assume or suffer to exist any Lien upon any of its Property, whether now owned or hereafter acquired, except for: (a) Liens for taxes not yet due or which are being contested in good faith by appropriate proceedings; provided that adequate reserves with respect thereto are maintained on the books of the Borrower or its Restricted Subsidiaries, as the case may be, to the extent required by GAAP; (b) landlords', carriers', warehousemen's, mechanics', material men's, repairmen's or other like Liens arising in the ordinary course of business which are not overdue for a period of more than 60 days or that are being contested in good faith by appropriate proceedings; (c) pledges, deposits or statutory trusts in connection with workers' compensation, unemployment insurance and other social security legislation; (d) deposits and other Liens to secure the performance of bids, government, trade and other similar contracts (other than for borrowed money), leases, subleases, statutory obligations, surety, judgment and appeal bonds, performance bonds and other obligations of a like nature incurred in the ordinary course of business; (e) encumbrances shown as exceptions in the title insurance policies insuring the Mortgages, easements, zoning restrictions, rights-of-way, restrictions and other similar encumbrances incurred in the ordinary course of business that, in the aggregate, do not materially detract from the value of the Property subject thereto or materially interfere with the ordinary conduct of the business of the Borrower or any of its Restricted Subsidiaries; . . . ”.

In another example, when a user clicks on the debt field exemplarily illustrated in FIG. 10I, the information analysis platform 204 displays the following detailed information in a pop up window: “7.2 Indebtedness. Create, issue, incur, assume, or permit to exist any Indebtedness, except: (a) Indebtedness of the Borrower and any Restricted Subsidiary pursuant to any Loan Document or Hedge Agreement or in respect of any Cash Management Obligations; (b) Indebtedness (i) of the Borrower to any of its Restricted Subsidiaries or Investor or of any Subsidiary Guarantor to Investor, the Borrower or any Restricted Subsidiary, provided that any such Indebtedness owing to a Restricted Subsidiary that is not a Subsidiary Guarantor is expressly subordinated in right of payment to the Obligations pursuant to the Guarantee and Collateral Agreement or otherwise and (ii) of any Non-Guarantor Subsidiary to any other Non-Guarantor Subsidiary; (c) Indebtedness (including Capital Lease Obligations) secured by Liens in an aggregate principal amount, when combined with the aggregate principal amount of Indebtedness outstanding under clauses (t) and (u) of this Section 7.2, not to exceed the greater of (i) $75,000,000 and (ii) the amount equal to 17.5% of Consolidated EBITDA, as of the end of the most recently ended Test Period for which financial statements have been delivered pursuant to Section 6.1 at the time of such incurrence, at any one time outstanding; (d) (i) Indebtedness outstanding on the Closing Date and listed on Schedule 7.2(d) and any Permitted Refinancing thereof and (ii) Indebtedness otherwise permitted under Section 7.10; (e) Guarantee Obligations (i) by the Borrower or any of its Restricted Subsidiaries of obligations of the Borrower or any Subsidiary Guarantor not prohibited by this Agreement to be incurred and (ii) by any Non-Guarantor Subsidiary of obligations of any other Non-Guarantor Subsidiary; (f) Indebtedness of the Borrower or any of its Restricted Subsidiaries arising from the honoring by a bank or other financial institution of a check, draft or similar instrument inadvertently drawn by the Borrower or such Restricted Subsidiary in the ordinary course of business against insufficient funds, so long as such Indebtedness is promptly repaid; . . . ”.

In another example, when a user clicks on the restricted payments field exemplarily illustrated in FIG. 10J, the information analysis platform 204 displays the following detailed information in a pop up window: “7.6 Restricted Payments. Declare or pay any dividend on, or make any payment on account of, or set apart assets for a sinking or other analogous fund for, the purchase, redemption, defeasance, retirement or other acquisition of, any Capital Stock of the Borrower or any Subsidiary, whether now or hereafter outstanding, or make any other distribution in respect thereof, either directly or indirectly, whether in cash or Property or in obligations of the Borrower or any Restricted Subsidiary, or enter into any derivatives or other transaction with any financial institution, commodities or stock exchange or clearinghouse (a “Derivatives Counterparty”) obligating the Borrower or any Restricted Subsidiary to make payments to such Derivatives Counterparty as a result of any change in market value of any such Capital Stock (collectively, “Restricted Payments”), except that: (a) (i) any Restricted Subsidiary may make Restricted Payments to the Borrower or any Subsidiary Guarantor and (ii) Non-Guarantor Subsidiaries may make Restricted Payments to other Non-Guarantor Subsidiaries; (b) provided that (i)(x) no Default or Event of Default is continuing or would result therefrom and (y) the Consolidated Net Total Leverage Ratio shall not exceed 3.50 to 1.00 on a pro form a basis as of the end of the most recently ended Test Period for which financial statements have been delivered pursuant to Section 6.1 at the time of such Restricted Payment . . . ”.

In another example, when a user clicks on the acquisitions field exemplarily illustrated in FIG. 10J, the information analysis platform 204 displays the following detailed information in a pop up window: “(f) (i) Permitted Acquisitions to the extent that any Person or Property received in such acquisition becomes a Subsidiary Guarantor or a part of the Borrower or any Subsidiary Guarantor or becomes (whether or not such Person is a wholly owned Subsidiary) a Subsidiary Guarantor in the manner contemplated by Section 6.8(c) and (ii) other Permitted Acquisitions in an aggregate purchase price in the case of this clause (ii) (other than purchase price paid through the issuance of equity by Investor or any Parent Company or with the proceeds thereof, including (A) (x) whether or not any equity is issued, capital contributions (other than relating to Disqualified Capital Stock) and (y) equity issued to the seller) in an aggregate amount not to exceed $300,000,000 plus (B) an amount equal to the Available Amount; provided that immediately after giving effect to any such Permitted Acquisition the Borrower shall be in pro form a compliance with the financial covenants set forth in Section 7.1 as of the end of the most recently ended Test Period for which financial statements have been delivered pursuant to Section 6.1 at the time of such Permitted Acquisition;”.

In another example, when a user clicks on the available amount field exemplarily illustrated in FIG. 10K, the information analysis platform 204 displays the following detailed information in a pop up window: “Available Amount”: as at any date, the sum of, without duplication: (a) $50,000,000; 3 (b) the aggregate cumulative amount, not less than zero, of 100% of Excess Cash Flow minus the Excess Cash Flow Application Amount for each fiscal year beginning with the fiscal year ending Mar. 31, 2014; (c) the Net Cash Proceeds received after the Closing Date and on or prior to such date from any Equity Issuance by, or capital contribution to, the Borrower (which is not Disqualified Capital Stock); (d) the aggregate amount of proceeds received after the Closing Date and on or prior to such date that (i) would have constituted Net Cash Proceeds pursuant to clause (a) of the definition of “Net Cash Proceeds” except for the operation of any of (A) the Dollar threshold set forth in the definition of “Asset Sale” and (B) the Dollar threshold set forth in the definition of “Recovery Event” or (ii) constitutes Declined Proceeds; (e) the aggregate principal amount of any Indebtedness of the Borrower or any Restricted Subsidiary issued after the Closing Date (other than Indebtedness issued to a Restricted Subsidiary), which has been extinguished after being converted into or exchanged for Capital Stock in Investor or any Parent Company; (f) the amount received by the Borrower or any Restricted Subsidiary in cash (and the Fair Market Value of Property other than cash received by the Borrower or any Restricted Subsidiary) after the Closing Date from any dividend or other distribution by an Unrestricted Subsidiary; (g) in the event any Unrestricted Subsidiary has been re-designated as a Restricted Subsidiary or has been merged, consolidated or amalgamated with or into, or transfers or conveys its assets to, or is liquidated into, the Borrower or any Restricted Subsidiary, the Fair Market Value of the Investments of the Borrower or any Restricted Subsidiary in such Unrestricted Subsidiary at the time of such redesignation, combination or transfer (or of the assets transferred or conveyed, as applicable); (h) an amount equal to any returns (including dividends, interest, distributions, returns of principal, profits on sale, repayments, income and similar amounts) actually received in cash, Cash Equivalents and Permitted Liquid Investments by the Borrower or any Restricted Subsidiary in respect of any Investments made pursuant to Section 7.7(f)(ii)(B), Section 7.7(h)(B) or Section 7.7(v)(ii); and (i) the aggregate amount actually received in cash, Cash Equivalents or Permitted Liquid Investments by the Borrower or any Restricted Subsidiary in connection with the sale, transfer or other disposition of its ownership interest in any joint venture that is not a Subsidiary or in any Unrestricted Subsidiary, in each case, to the extent of the Investment in such joint venture or Unrestricted Subsidiary; minus, the sum of: (a) the amount of Restricted Payments made after the Closing Date pursuant to Section 7.6(b)(i); and (b) the amount of any Investments made after the Closing Date pursuant to Section 7.7(f)(ii)(B), Section 7.7(h)(B) or Section 7.7(v)(ii).”. In another example, when a user clicks on the consolidated net total leverage field exemplarily illustrated in FIG. 10L, the information analysis platform 204 displays the following detailed information in a pop up window: 4.5× for 9/30/12 and 12/31/12, 4.25× for 3/31/13, 6/30/13, 9/30/13, and 12/31/13, 4× for 3/31/14, 6/30/14, 9/30/14, 12/31/14, and 3.75× for 3/31/15.

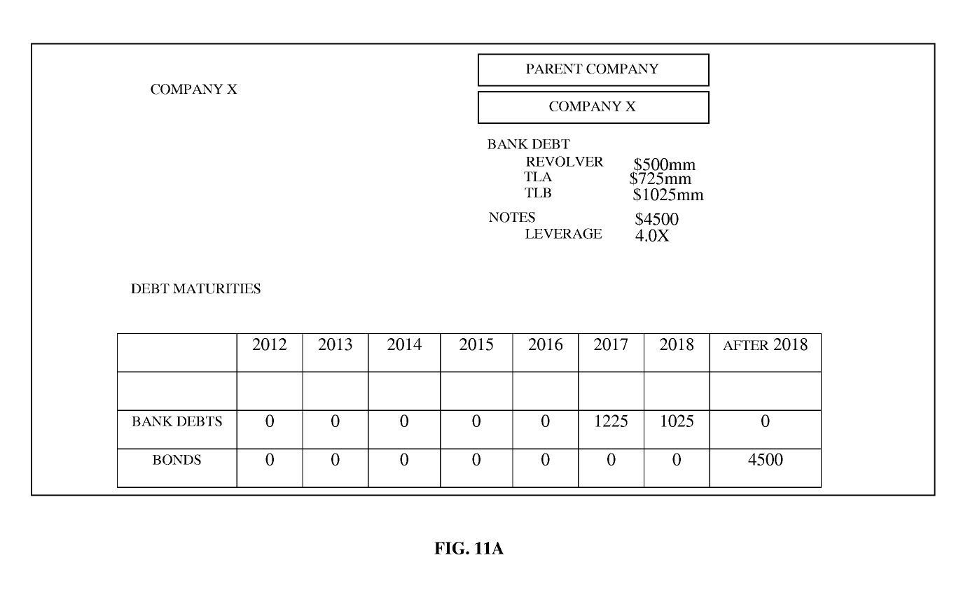

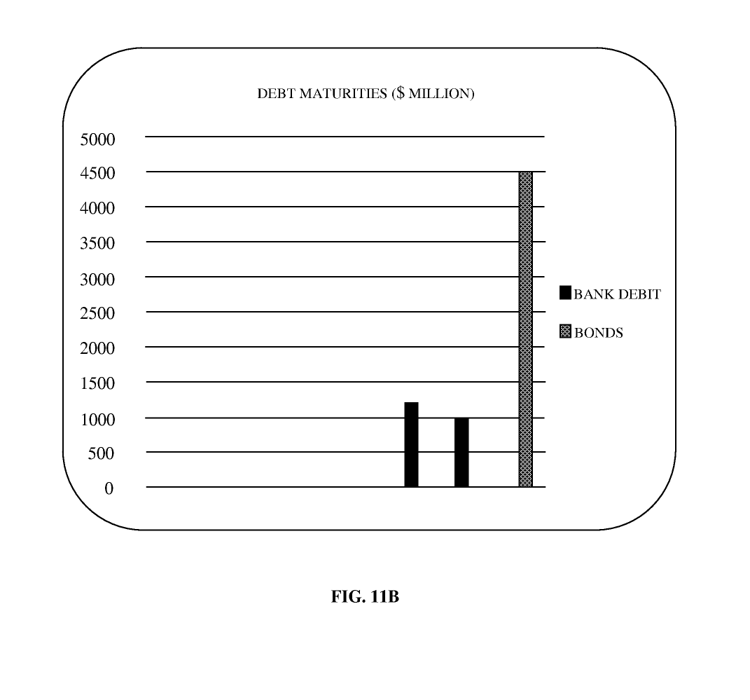

FIGS. 11A-11B exemplarily illustrate screenshots of an organization structure interface provided on the graphical user interface (GUI) 204a of the information analysis platform 204 exemplarily illustrated in FIGS. 2-3 and FIG. 5. The organization structure interface displays comparison charts comprising information about capital structure, debt maturities, etc., generated by the information analysis platform 204, where the comparison charts compare bank debts and bonds as exemplarily illustrated in FIG. 11A. The organization structure interface also provides a graphical representation of debt maturities for the parent company as exemplarily illustrated in FIG. 11B.

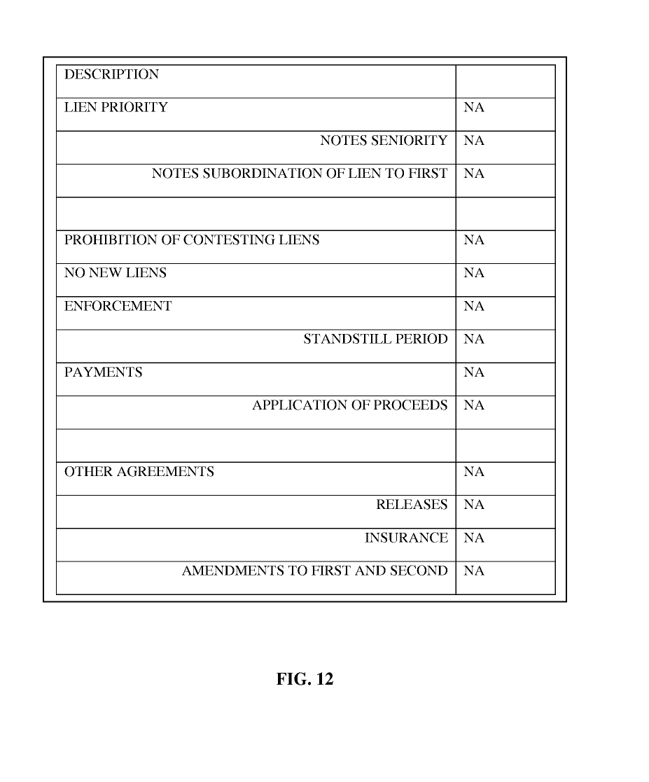

FIG. 12 exemplarily illustrates a screenshot of an intercreditor agreement interface provided on the graphical user interface (GUI) 204a of the information analysis platform 204 exemplarily illustrated in FIGS. 2-3 and FIG. 5. The intercreditor agreement interface comprises information about lien priorities, prohibition of contesting liens, enforcement, payments, other agreements, etc.

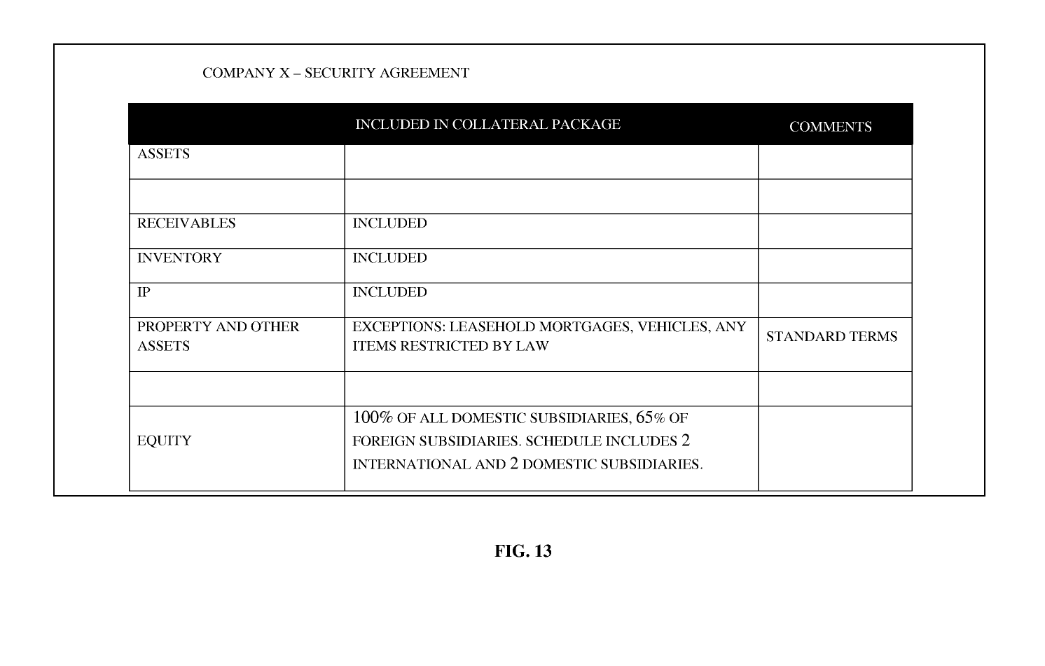

FIG. 13 exemplarily illustrates a screenshot of a security agreement interface provided on the graphical user interface (GUI) 204a of the information analysis platform 204 exemplarily illustrated in FIGS. 2-3 and FIG. 5. The security agreement interface comprises information about security agreements included in a collateral package, for example, assets, receivables, inventory, intellectual property (IP), property and other assets, equity, etc., as exemplarily illustrated in FIG. 13. The exceptions under property and assets comprise leasehold mortgages, vehicles, any item restricted by law, etc. The equity information comprises 100% of all domestic subsidiaries and 65% of foreign subsidiaries.

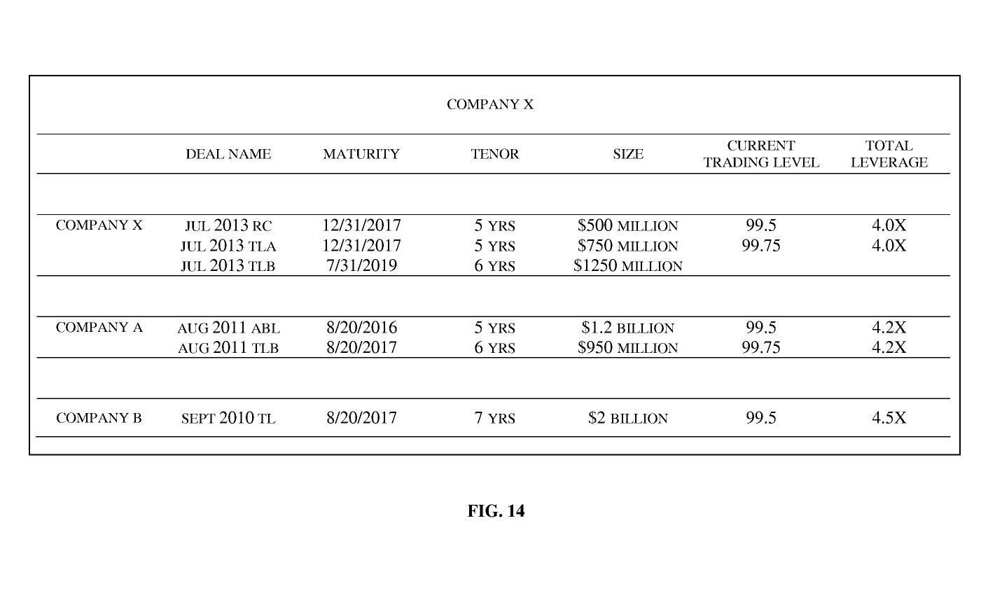

FIG. 14 exemplarily illustrates a screenshot of a competitors interface provided on the graphical user interface (GUI) 204a of the information analysis platform 204 exemplarily illustrated in FIGS. 2-3 and FIG. 5. The competitors interface displays deal information of multiple competitors. The deal information comprises deal name, maturity date, tenor of the loan deal, size of the loan deal, current trading level, total leverage, etc.

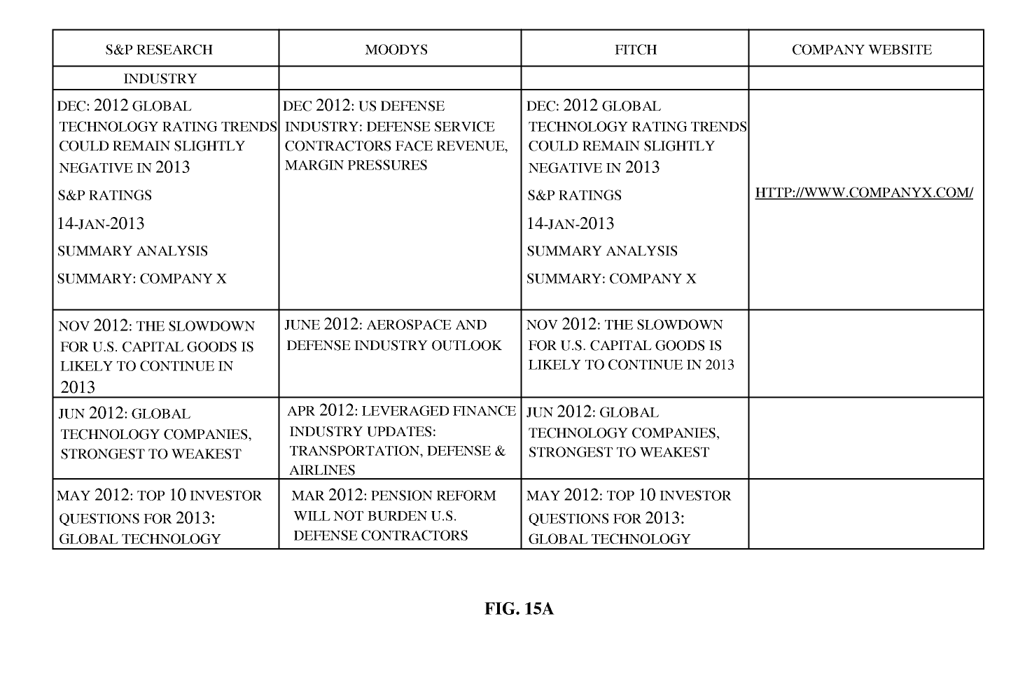

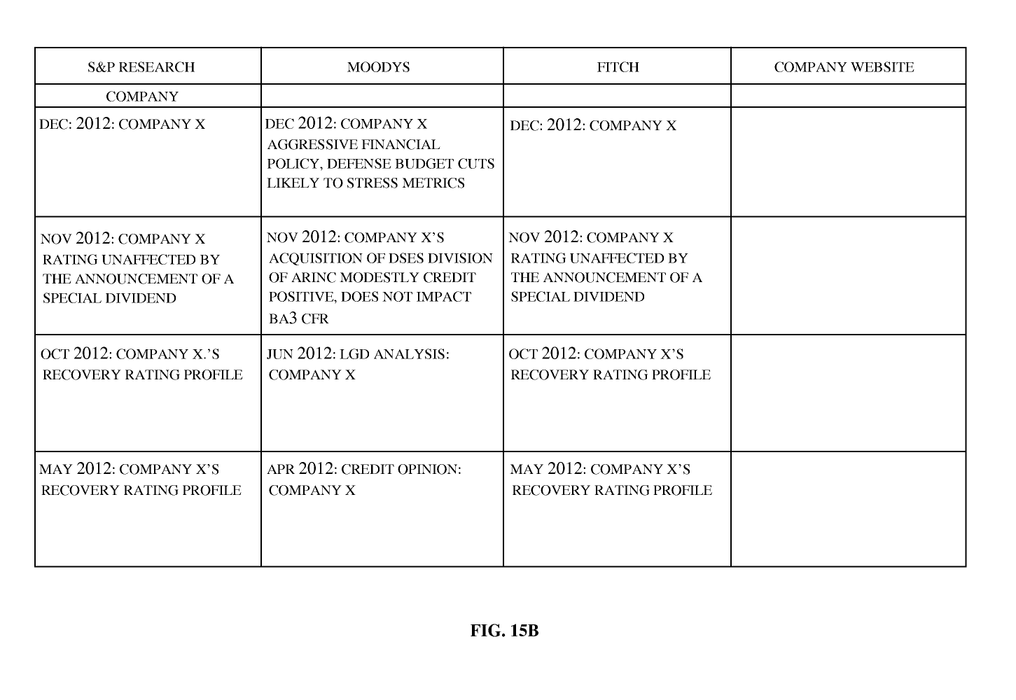

FIGS. 15A-15B exemplarily illustrate screenshots of a research interface provided on the graphical user interface (GUI) 204a of the information analysis platform 204 exemplarily illustrated in FIGS. 2-3 and FIG. 5. The research interface displays, for example, industry research information as exemplarily illustrated in FIG. 15A. The research interface also displays company research information as exemplarily illustrated in FIG. 15B. The research information is a collection of research material from various research firms, for example, S&P Research, Moody's, Fitch Group, etc.

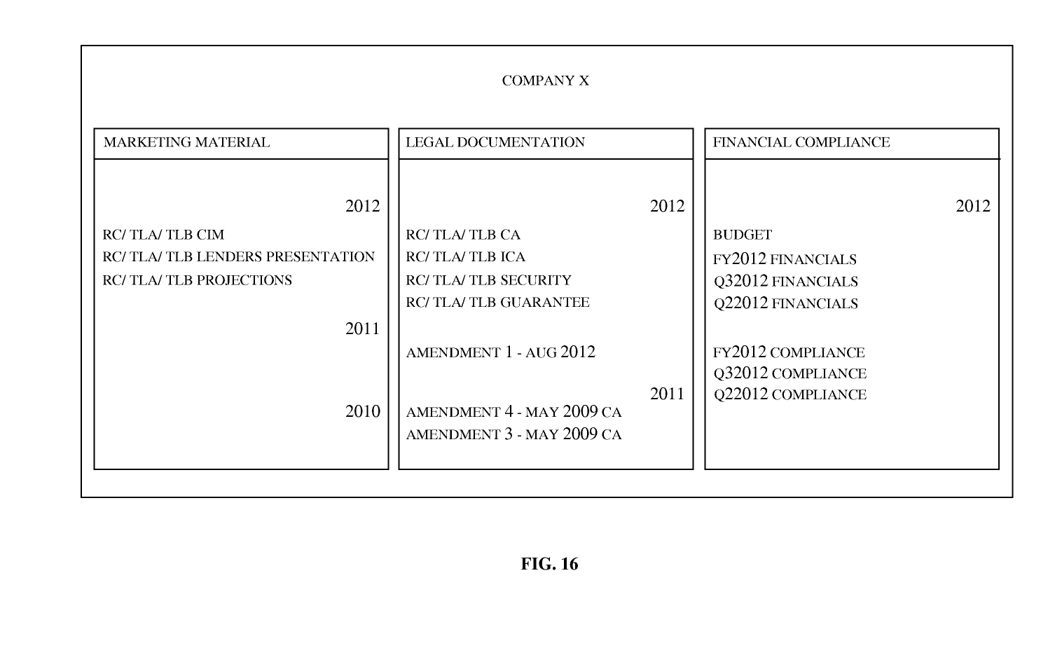

FIG. 16 exemplarily illustrates a screenshot of a documents interface provided on the graphical user interface (GUI) 204a of the information analysis platform 204 exemplarily illustrated in FIGS. 2-3 and FIG. 5. The document interface displays the syndicated loan transaction elements, for example, marketing material, legal documentation, financial compliance information, etc., on the GUI 204a as exemplarily illustrated in FIG. 16.

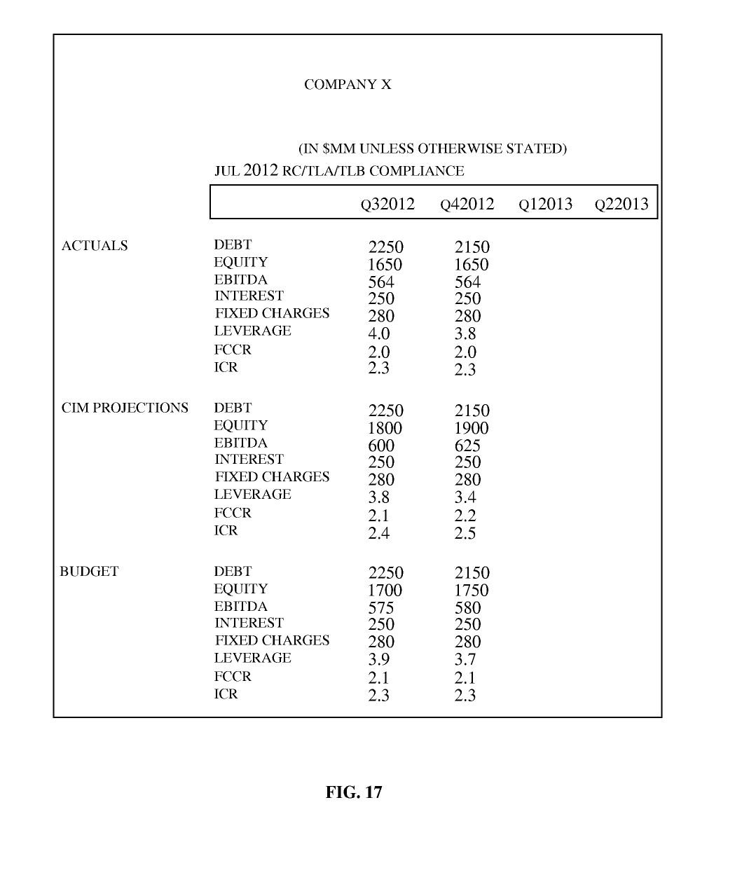

FIG. 17 exemplarily illustrates a screenshot of a compliance interface provided on the graphical user interface (GUI) 204a of the information analysis platform 204 exemplarily illustrated in FIGS. 2-3 and FIG. 5. The compliance interface displays, for example, compliance information for actuals, confidential information memorandum (CIM) projections, budget information, etc. The compliance interface provides compliance information on a quarterly basis for debt, equity, earnings before interest, taxes, depreciation and amortization (EBITDA), interest, fixed charges, leverage, fixed charge coverage ratio (FCCR), income contingent repayment (ICR), etc.

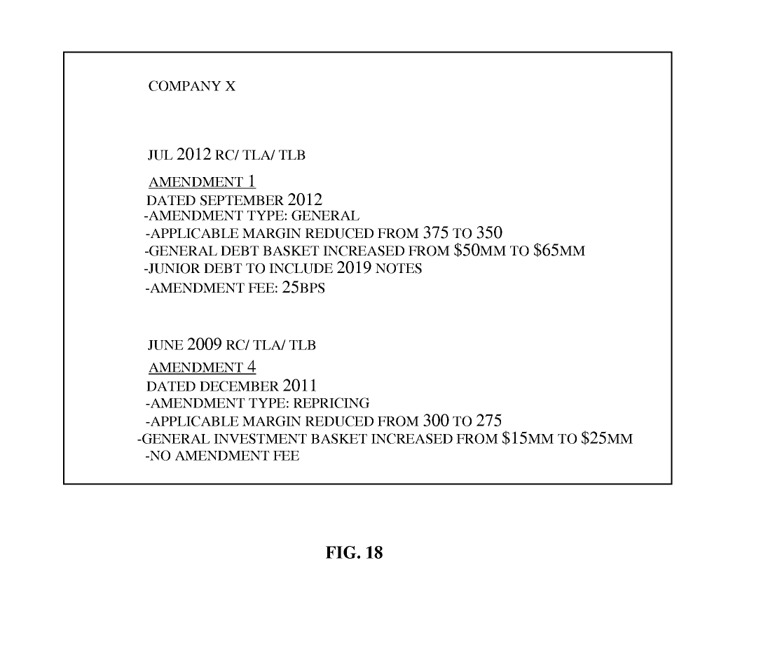

FIG. 18 exemplarily illustrates a screenshot of an amendments interface provided on the graphical user interface (GUI) 204a of the information analysis platform 204 exemplarily illustrated in FIGS. 2-3 and FIG. 5. The amendments interface displays the amendments made, for example, to compliance requirements. FIG. 18 exemplarily illustrates two amendments, for example, amendment 1 and amendment 4, dated September 2012 and December 2011, respectively. Amendment 1 is a general amendment in which the applicable margin is reduced from 375 bps to 350 bps, the general debt basket is increased from $50 mm to $65 mm, and the amendment fee is amended, for example, to about 25 bps. Amendment 4 is an amendment for re-pricing in which the applicable margin is reduced from 300 bps to 275 bps and the general investment basket is increased from $15 mm to $25 mm. As per amendment 4, there is no amendment fee for re-pricing. The information analysis platform 204 records and analyzes each amendment, and overlays each amendment onto an original document to allow a syndicated loan market user to compare the document with the amendment and review changes.

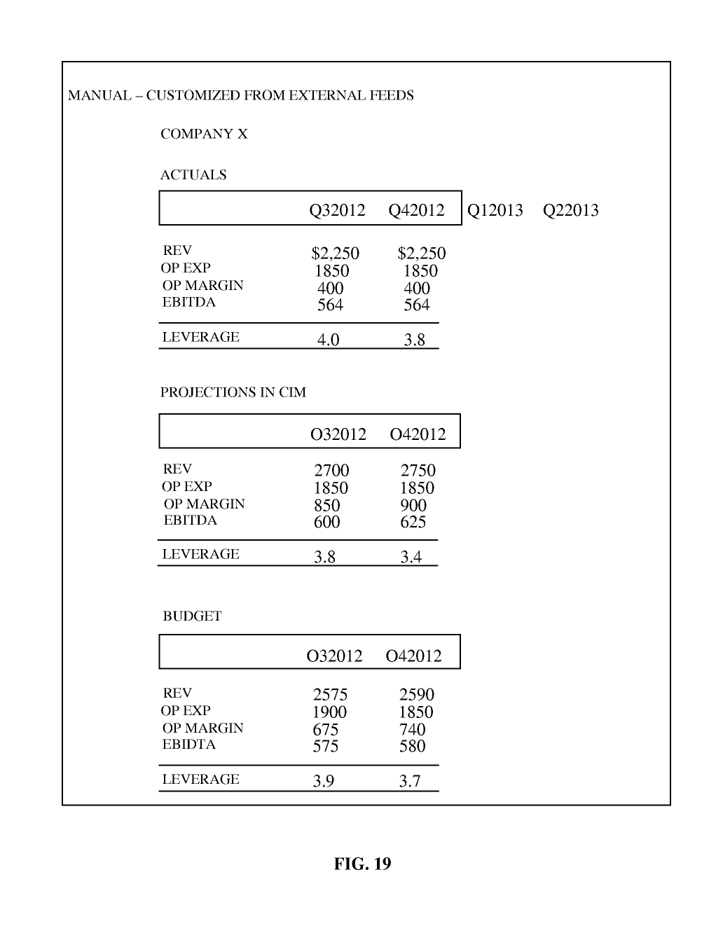

FIG. 19 exemplarily illustrates a screenshot of a comparison interface provided on the GUI 204a of the information analysis platform 204 exemplarily illustrated in FIGS. 2-3 and FIG. 5. The comparison interface displays a comparison of budget versus actuals associated with loan deals. The comparison interface provided by the information analysis platform 204 displays the actuals, projections in the confidential information memorandum (CIM), and budget information on a quarterly basis as exemplarily illustrated in FIG. 19.

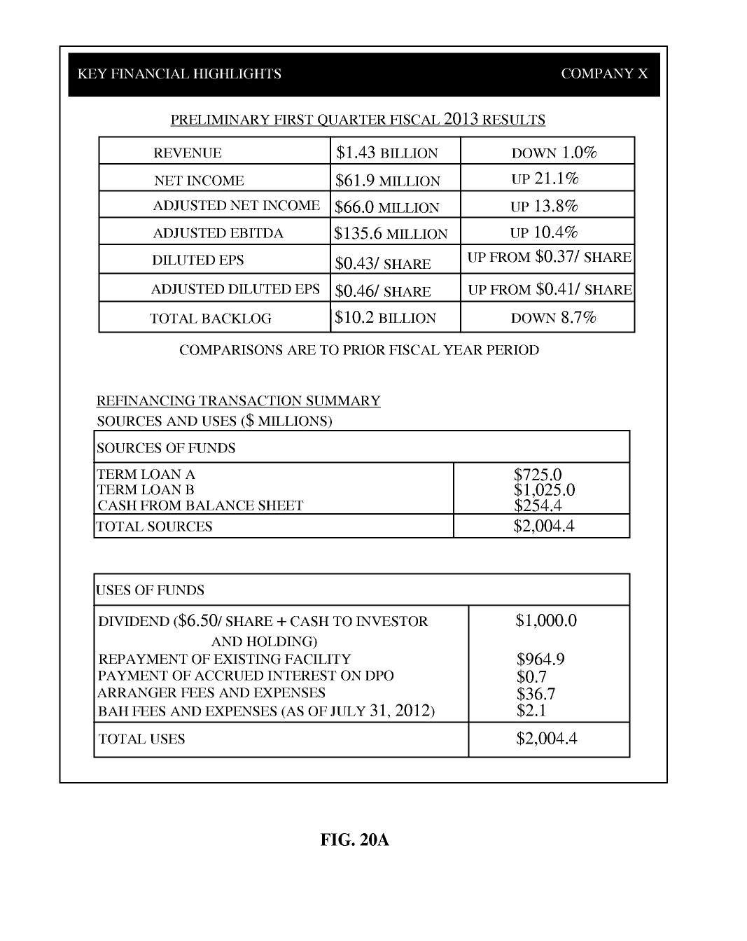

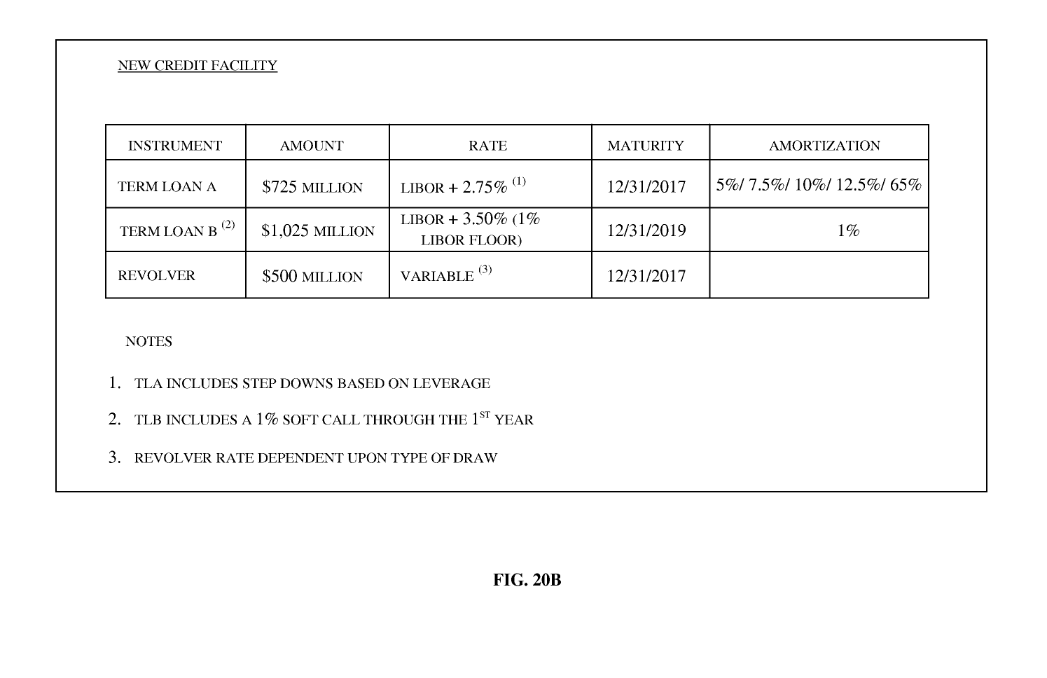

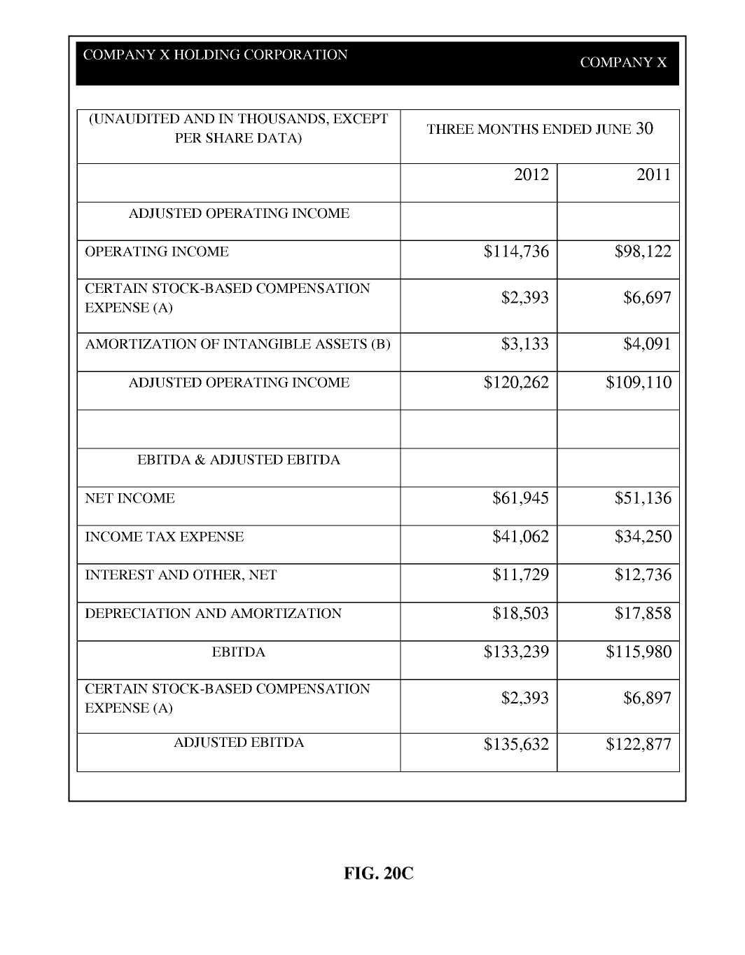

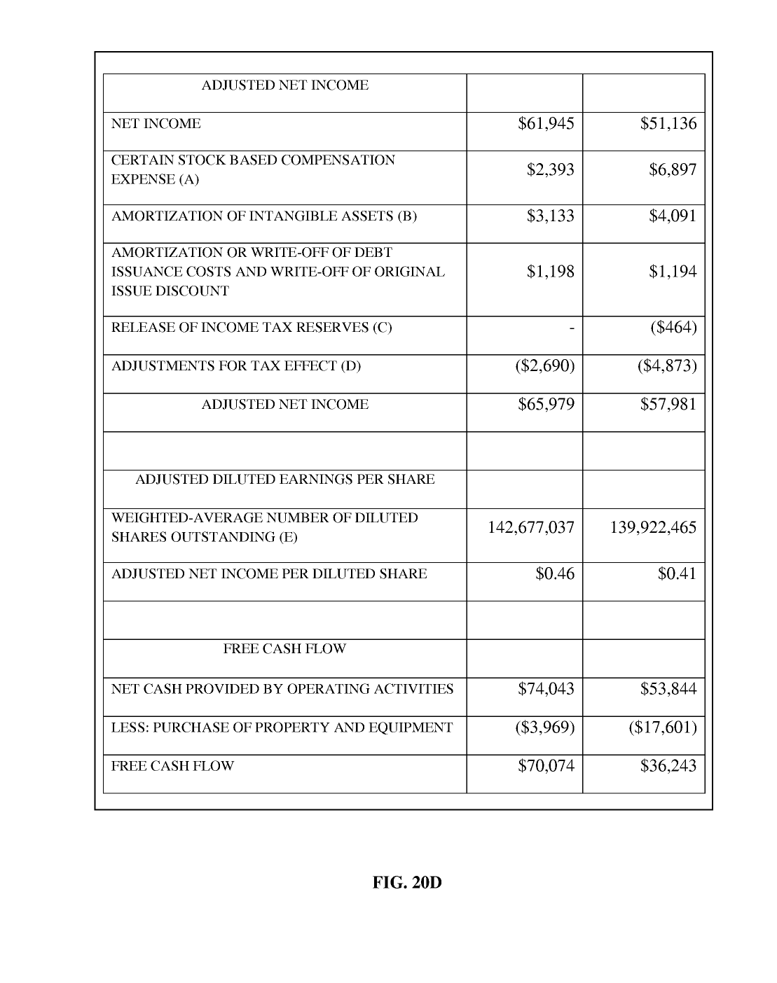

FIGS. 20A-20D exemplarily illustrate screenshots of a confidential information memorandum (CIM)-lenders presentation interface provided on the graphical user interface (GUI) 204a of the information analysis platform 204 exemplarily illustrated in FIGS. 2-3 and FIG. 5. The CIM-lenders presentation interface displays, for example, preliminary first quarter fiscal results for the year 2013. The CIM-lender presentation interface also provides a refinancing transaction summary comprising, for example, sources of funds and uses of funds as exemplarily illustrated in FIG. 20A. The CIM-lenders presentation interface further provides new credit facility information as exemplarily illustrated in FIG. 20B. The CIM-lenders presentation interface further provides non-generally accepted accounting principles (GAAP), financial information comprising, for example, adjusted operating income, earnings before interest, taxes, depreciation and amortization (EBITDA) and adjusted EBITDA, adjusted net income, adjusted diluted earnings per share, and free cash flow, as exemplarily illustrated in FIGS. 20C-20D.

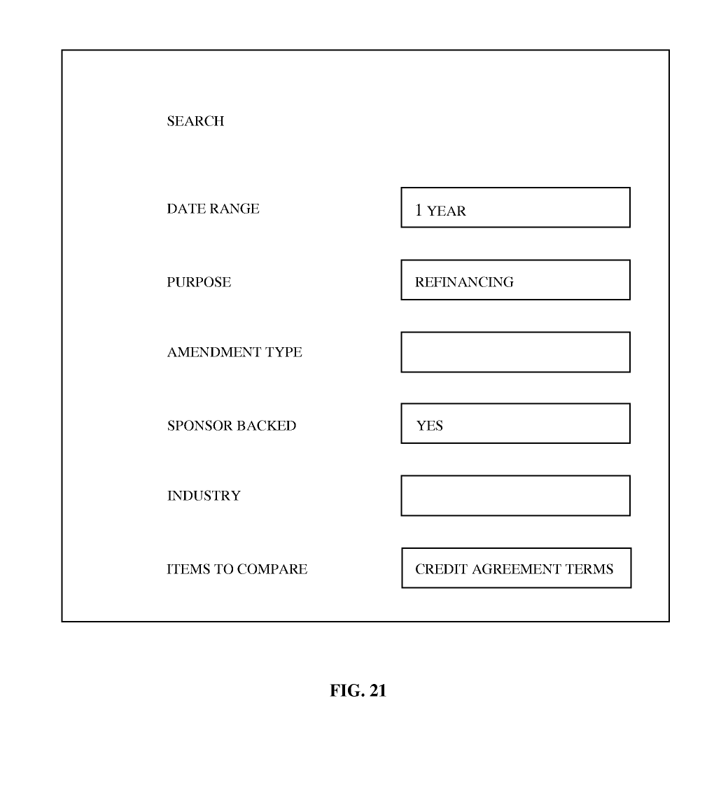

FIG. 21 exemplarily illustrates a screenshot of a search interface provided on the graphical user interface (GUI) 204a of the information analysis platform 204 exemplarily illustrated in FIGS. 2-3 and FIG. 5. The search interface allows users to perform a search by entering search criteria in various fields comprising, for example, a date range, a purpose, an amendment type, sponsor backed, an industry, etc. The search interface also allows users to compare various items or terms related to the syndicated loans.

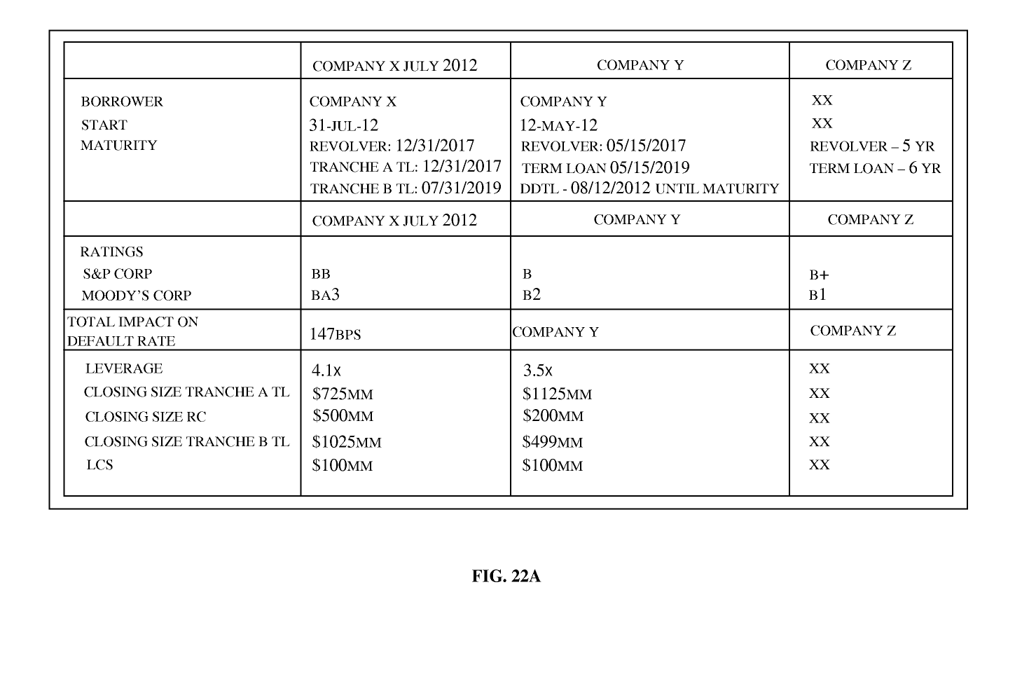

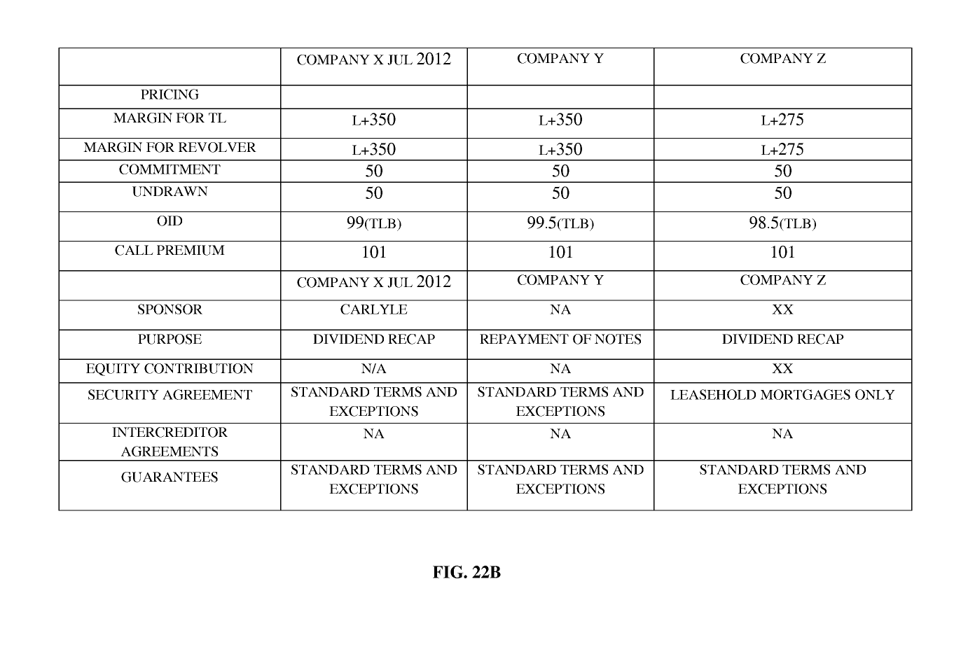

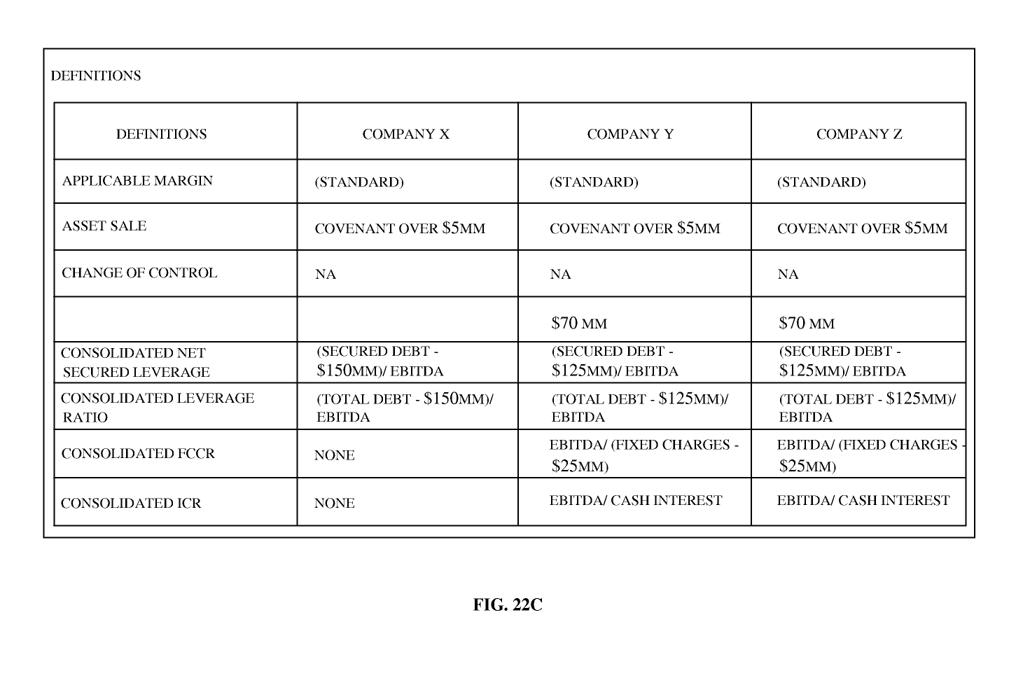

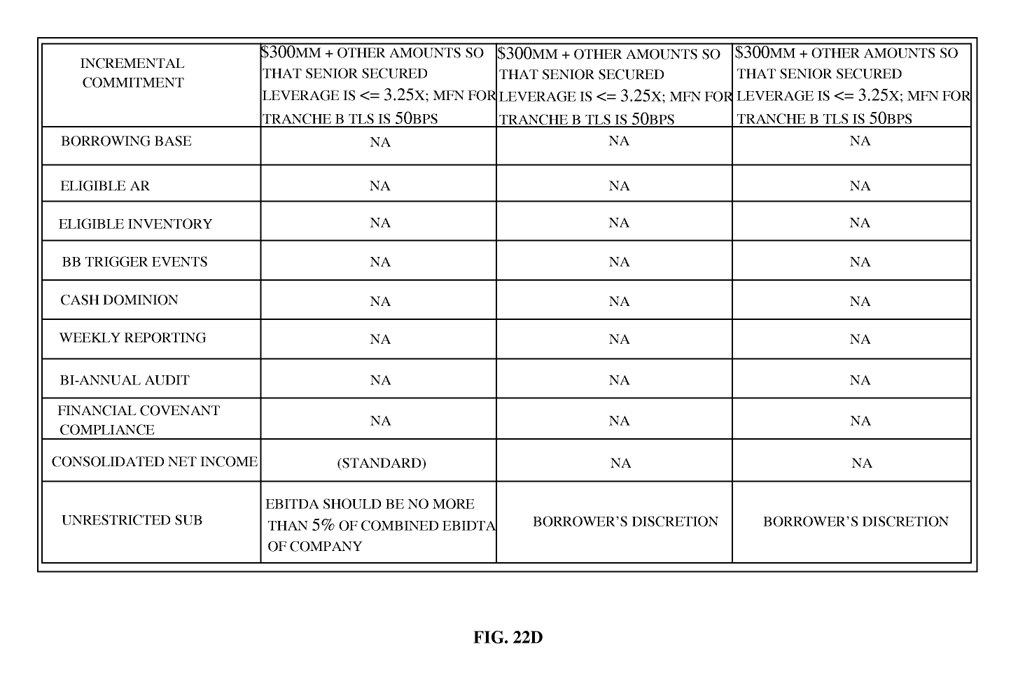

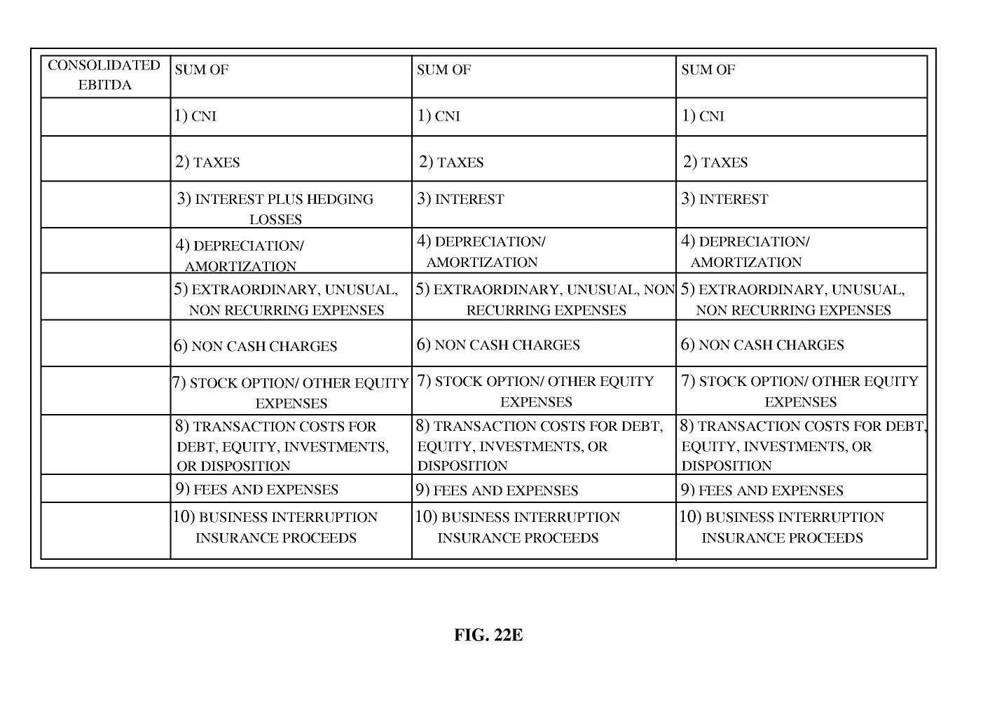

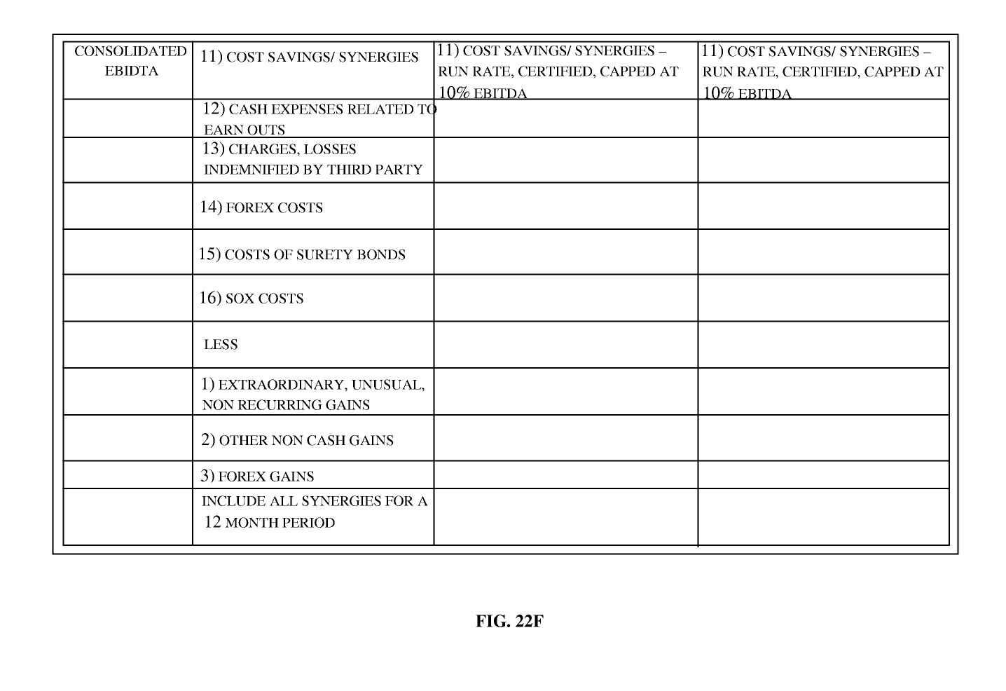

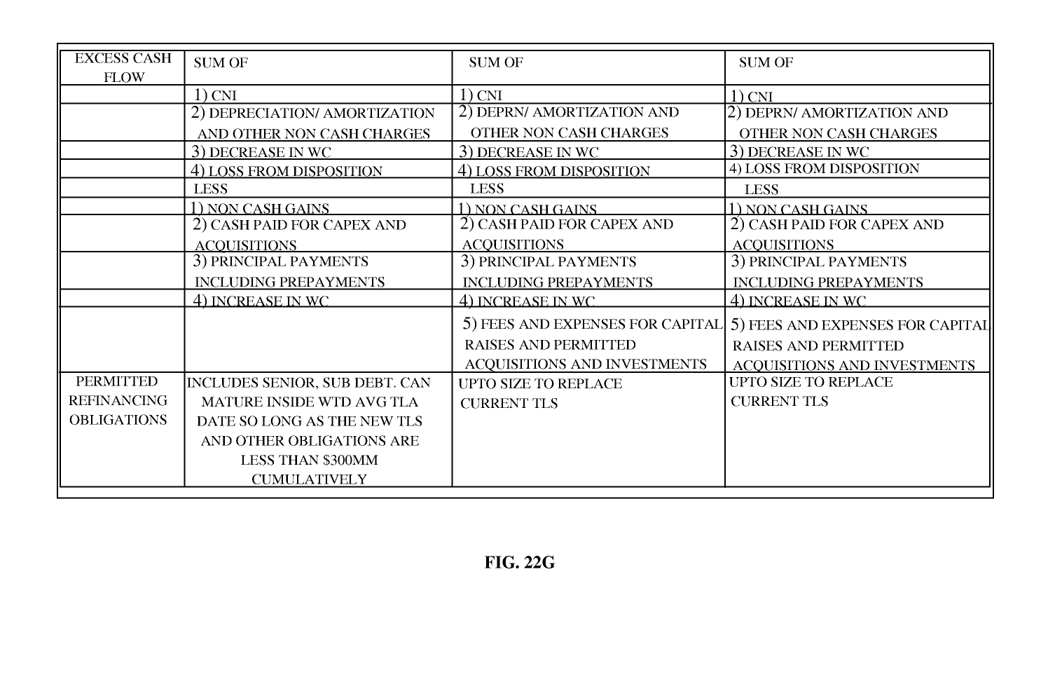

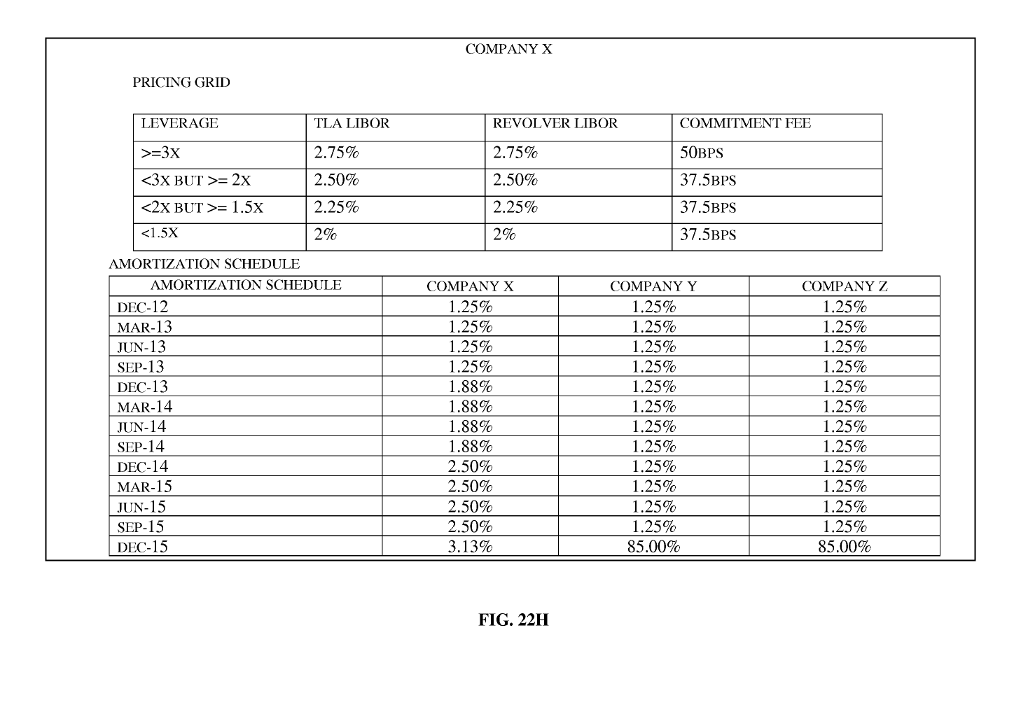

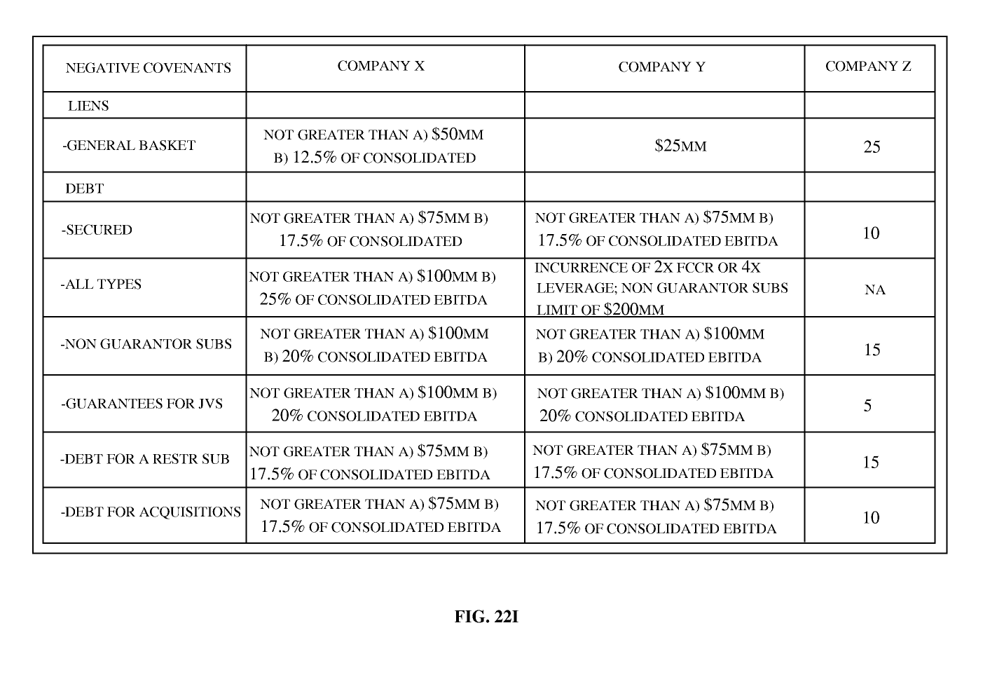

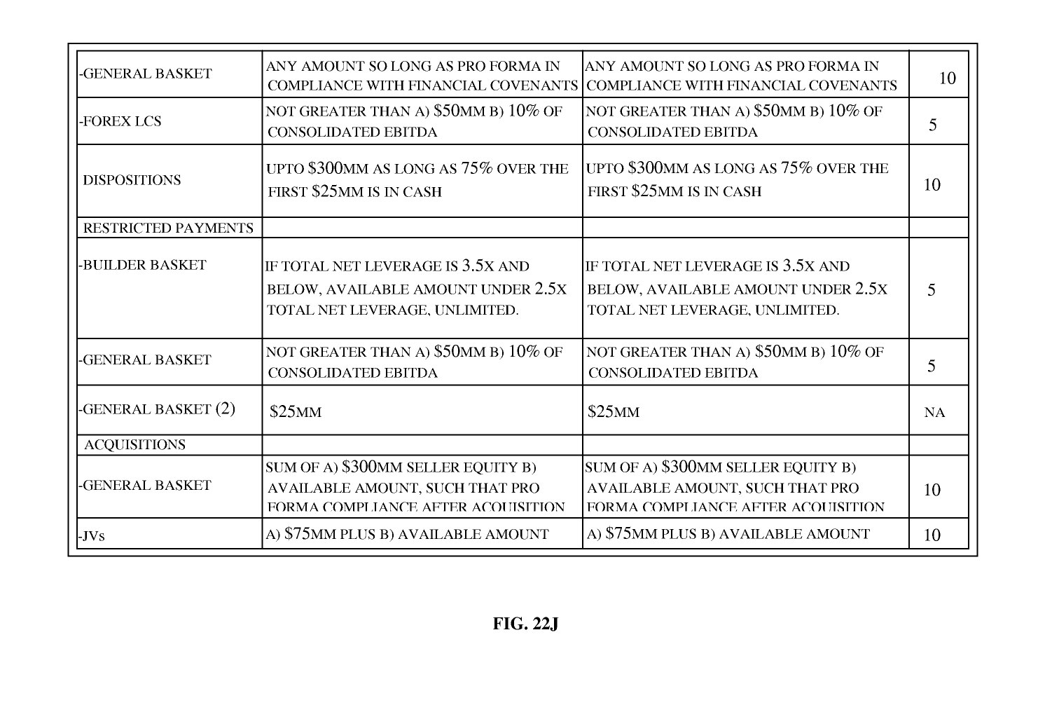

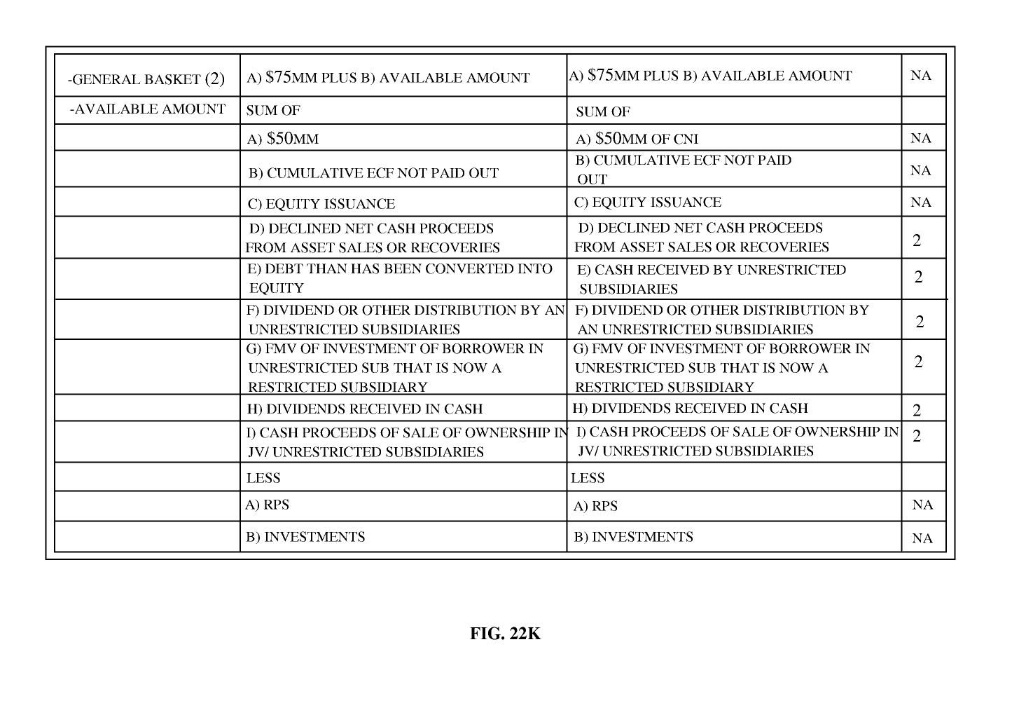

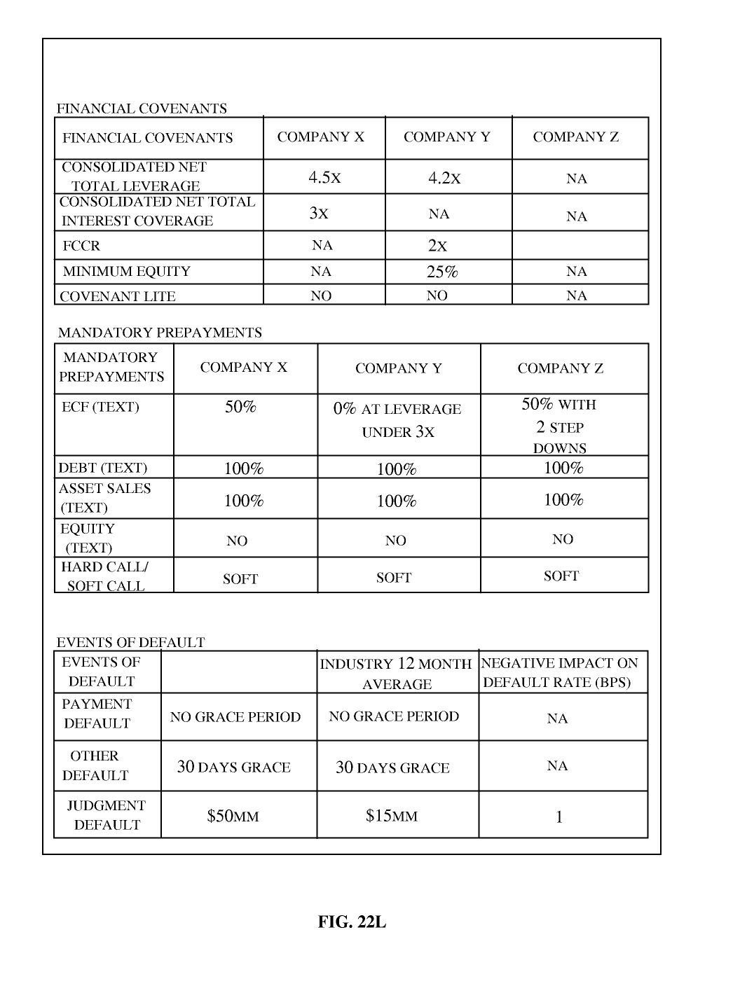

FIGS. 22A-22L exemplarily illustrate screenshots of a search results interface provided on the graphical user interface (GUI) 204a of the information analysis platform 204 exemplarily illustrated in FIGS. 2-3 and FIG. 5. The search results interface displays comparative search results for credit agreement (CA) terms of three companies, for example, company X, company Y, and company Z for an enhanced analysis by a user. The CA terms comprise, for example, ratings, a pricing grid, an amortization schedule, negative covenants, financial covenants, mandatory prepayments, events of default, etc. The original issue discount (OID) under pricing shows an increase in term loan B (TLB) from 99 during primary syndication to 99.5 for the company Y as exemplarily illustrated in FIG. 22B. Furthermore, the search results interface displays amendments, for example, that company X changed pricing from 375 bps to 350 bps and provides links to amendment documents.

The information analysis platform 204 provides detailed descriptions and definitions for each term under each section and subsection to create standardization in the interpretation of all syndicated loan credit agreements as disclosed in the detailed description of FIGS. 10A-10L. For example, if a user clicks on a sub-section next to the available amount field exemplarily illustrated in FIG. 22K, the information analysis platform 204 displays the following detailed information in a pop up window: “Permitted Amount” means (A) 50% of the aggregate amount of the Consolidated Net Income (or, if the Consolidated Net Income is a loss, minus 100% of the amount of the loss) accrued on a cumulative basis during the period, taken as one accounting period, beginning on Apr. 2, 2012 and ending on the last day of the Borrower's most recently completed fiscal quarter for which financial statements have been provided (or if not timely provided, required to be provided) pursuant to this Agreement or the Existing Credit Agreement, plus (B) subject to the final sentence of this definition, the aggregate Net Cash Proceeds received by the Borrower (other than from a Subsidiary) after the Closing Date from (i) the issuance and sale of Qualified Equity Interests, including by way of issuance of Disqualified Equity Interests or Indebtedness to the extent such Disqualified Equity Interest or Indebtedness has been converted into Qualified Equity Interests of the Borrower or any direct or indirect parent of the Borrower (and contributed to the Borrower as a contribution to its common equity) and (ii) other contributions to the common equity capital of the Borrower, other than Excluded Contributions, plus (C) an amount equal to the sum, for all Unrestricted Subsidiaries, of the following: (x) the cash return, and the fair market value of assets or property received, after the Closing Date, on Investments in an Unrestricted Subsidiary as a result of any sale, repayment, redemption, liquidating distribution or other realization (to the extent (i) not included in Consolidated Net Income and (ii) such amount does not cause a corresponding increase to any other basket contained in Section 7.03), plus (y) all distributions or dividends to the Borrower or a Restricted Subsidiary from Unrestricted Subsidiaries (provided that such distributions or dividends shall be excluded in calculating Consolidated Net Income for purposes of clause (A) above), plus (z) the portion (proportionate to the Borrower's equity interest in such Subsidiary) of the fair market value of the assets less liabilities of an Unrestricted Subsidiary at the time such Unrestricted Subsidiary is designated a Restricted Subsidiary, plus (D) without duplication with any amounts covered by clause (C) above, an amount equal to the sum of the following: (x) all distributions or dividends to the Borrower or a Restricted Subsidiary from any Investment, plus (y) the cash return, and the fair market value of property received, after the Closing Date, on any Investment as a result of any sale, repayment, redemption, liquidating distribution or other realization (to the extent in each case (x) and (y), (i) not included in Consolidated Net Income and (ii) such amount does not cause a corresponding increase to any other basket contained in Section 7.03), minus (E) the amount of Investments made pursuant to Section 7.03(q), minus (F) the amount of Restricted Payments made pursuant to Section 7.06(d). The amount expended in any Restricted Payment, if other than in cash, will be deemed to be the fair market value of the relevant non-cash assets or property, as determined in good faith by the Board of Directors, whose determination will be conclusive and evidenced by a resolution of the Board of Directors of the Borrower. Proceeds of the issuance of Equity Interests will be included as part of the “Permitted Amount” only to the extent they are not applied as described in Section 7.06(c) or (j).”

The search results interface also displays events of default as exemplarily illustrated in FIG. 22L, for an industry 12 month period or for the following: last 12 months average across deals, 12 month industry average as % of EBITDA, or 12 month average as % of EBITDA or up to two selected specific transactions. The events of default also comprise negative impact on or impact on loss given default, impact on valuation, or impact on credit value loss.

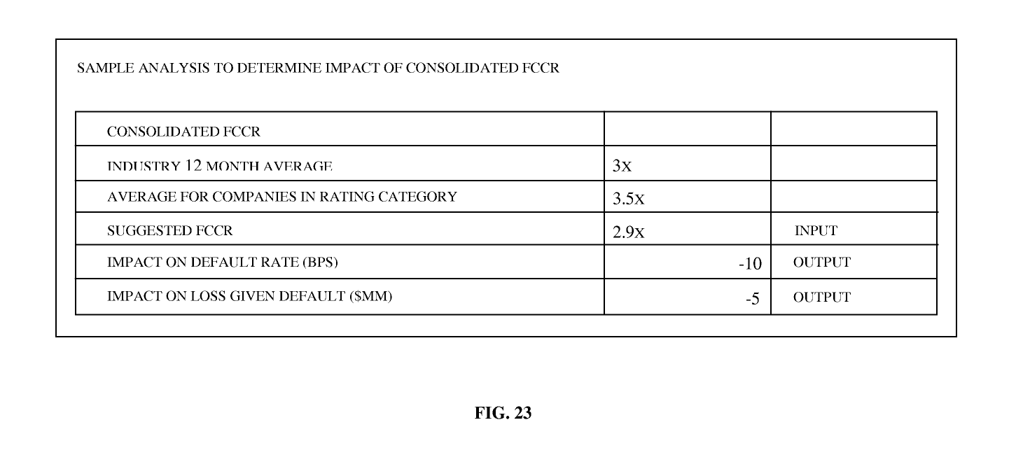

FIG. 23 exemplarily illustrates a screenshot of an analytical interface provided on the graphical user interface (GUI) 204a of the information analysis platform 204 exemplarily illustrated in FIGS. 2-3 and FIG. 5. The analytical interface displays a sample analysis to determine impact of a consolidated fixed charge coverage ratio (FCCR) as exemplarily illustrated in FIG. 23. The sample analysis shows an impact on default rate, for example, of about −10 bps and an impact on loss given default, for example, of about −$5 mm.

Consider an example where a user wishes to supplement his/her credit analysis with an analysis of a structure of a loan being issued by a company, for example, company X. The user subscribes to the information analysis platform 204 exemplarily illustrated in FIGS. 2-3 and FIG. 5, and logs in to the information analysis platform 204 via the graphical user interface (GUI) 204a. The information analysis platform 204 directs the user to the homepage interface as exemplarily illustrated in FIGS. 7A-7E. On the homepage interface, the user searches for financial data associated with the company X via a search link or an advanced search link.

If the user clicks on the search link via the GUI 204a, the information analysis platform 204 displays the search interface as exemplarily illustrated in FIG. 21. The user performs a search via the search interface by selecting an option from a drop down menu provided for each data field as per the user's requirement. For example, the user may select a date range as “1 year”, a purpose as “refinancing”, a sponsor backed as “yes”, an item to compare as “credit agreement terms”, and leaves the remaining data fields comprising an amendment type and an industry blank on the search interface.

If the user clicks on the advanced search link via the GUI 204a, the information analysis platform 204 displays the advanced search interface as exemplarily illustrated in FIG. 8. The user performs an advanced search via the advanced search interface by selecting an option for each of the additional data fields displayed on the advanced search interface. For example, the user selects a company name as “company X”, a type of text string as “dividend recap”, a type of lending as “highly leveraged”, a stage of lending as “primary”, etc. The information analysis platform 204 then displays the search results on the search results interface as exemplarily illustrated in FIGS. 22A-22L. In an embodiment, the information analysis platform 204 displays the company interface of Company X based on the search criteria specified by the user via the GUI 204a as exemplarily illustrated in FIGS. 9A-9B. The company interface of the information analysis platform 204 provides company information of company X comprising, for example, an organization structure, a company profile, research, amendments, compliance information, etc., as exemplarily illustrated in FIG. 9A, and graphical representations of loan pricing for term loan B (TLB) as exemplarily illustrated in FIG. 9B.

Consider another example where a user wishes to determine impact of a consolidated fixed charge coverage ratio (FCCR) on default rate and loss given default for three companies, for example, company X, company Y, and company Z. The feed aggregator 302 of the information analysis platform 204 exemplarily illustrated in FIG. 3, receives credit agreements of the companies from a data source and aggregates the data items from the credit agreements to data fields, as exemplarily illustrated in FIGS. 10A-10L. The information analysis platform 204 extracts and analyzes each data item from the credit agreements and converts the data items into data fields exemplarily illustrated in FIGS. 10A-10L. The extracted data items are, for example, a maturity date for tranche A, tranche B, revolver, etc., a consolidated net total leverage ratio, a consolidated net interest coverage ratio, liens, restricted payments, etc. The data fields are, for example, applicable margin, asset sale, change of control, consolidated FCCR, consolidated earnings before interest, taxes, depreciation and amortization (EBITDA), etc., exemplarily illustrated in FIGS. 10C-10L.

The information analysis platform 204 anticipates sections and subsections under each data field to create standardization in the interpretation of the credit agreements as exemplarily illustrated in FIGS. 10C-10G. The company-credit agreement (CA) interface provided on the GUI 204a of the information analysis platform 204 provides detailed structural information under the sections, for example, definitions, pricing grid, negative covenant, financial covenant, events of default, and mandatory prepayment, as exemplarily illustrated in FIGS. 10C-10G. The information analysis platform 204 categorizes the extracted data items into the data fields via analytical tools 210a exemplarily illustrated in FIG. 4, and/or manual inputs from legal and financial advisers, exemplarily illustrated in FIGS. 22A-22L. For example, the information analysis platform 204 categorizes the data items “revolver: 12/31/2017”, “tranche A term loan: 12/31/2017”, and “tranche B term loan: 07/31/2019” into the “maturity” data field for company X exemplarily illustrated in FIG. 22A.

The user logs in to the information analysis platform 204 via the GUI 204a. When the user clicks on the search link provided on the homepage interface exemplarily illustrated in FIG. 7A, the information analysis platform 204 displays the search interface as exemplarily illustrated in FIG. 21. The information analysis platform 204 allows the user to specify an option from the drop down menu provided for each data field on the search interface, for example, a date range as “1 year”, a purpose as “refinancing”, a sponsor backed as “yes”, and an item to compare as “credit agreement terms”. When the user submits the search criteria, the information analysis platform 204 renders the search results interface on the GUI 204a as exemplarily illustrated in FIGS. 22A-22L. The information analysis platform 204 runs a multivariate regression on a data set comprising financial deals of the companies to determine impact of restricted payment to unrestricted subsidiaries on the default rate and the loss given default, assuming earnings before interest, taxes, depreciation and amortization (EBITDA) of the company contributed towards restricted payments to unrestricted subsidiaries do not exceed 5%. The variables employed to run the multivariate regression on the data set comprise, for example, a restrictive payment basket, a rating of a company such as from 1 to 5, an asset coverage, cash flow, and loss given defaults as exemplarily illustrated in FIGS. 22A-22L.

As exemplarily illustrated in FIG. 23, the analytical interface provided on the GUI 204a of the information analysis platform 204 displays the analysis report obtained by running the multivariate regression based on various factors associated with syndicated loan transactions of the companies included in the data set. The factors associated with the syndicated loans comprise, for example, impact of structural elements on loss given default, probability of default, pricing, etc. Based on the regression results, the information analysis platform 204 shows the risk of default increases by 10 basis points and the loss given default amounts to $5 million for every 5% of earnings before interest, taxes, depreciation and amortization (EBITDA) contributed towards restricted payments to unrestricted subsidiaries.

Consider another example where a user wishes to view earnings information provided to a loan market comprising a financial report of a company, for example, company X. The user signs up and logs in to the information analysis platform 204 via the GUI 204a. The information analysis platform 204 directs the user to the homepage interface exemplarily illustrated in FIGS. 7A-7E. On the homepage interface, the user searches for the company X via an advanced search link by specifying a date range, for example, from May 1, 2012 to current, and a company name, for example, company X. The information analysis platform 204 directs the user to the company interface as exemplarily illustrated in FIGS. 9A-9B. When the user clicks on the confidential information memorandum (CIM)-lenders presentation link provided on the company interface exemplarily illustrated in FIG. 9A, the information analysis platform 204 directs the user to the CIM-lenders presentation interface of the company X exemplarily illustrated in FIGS. 20A-20D.

The CIM-lenders presentation interface provides the earnings information of the company X showing, for example, preliminary first quarter fiscal results for the year 2013. FIG. 20A exemplarily illustrates the preliminary first quarter fiscal results of the company X for the year 2013 in comparison with fiscal results of the company X for the year 2012. As exemplarily illustrated in FIG. 20A, the revenue decreased by 1% to $1.43 billion, the net income increased by 21.1% to $61.9 million, the adjusted net income increased by 13.8% to $66 million, the adjusted EBITDA increased by 10.4% to $135.6 million, the diluted earnings per share (EPS) increased from $0.37 per share to $0.43 per share, the adjusted diluted EPS increased from $0.41 per share to $0.46 per share, and the total backlog decreased by 8.7% to $10.2 billion. The CIM-lenders presentation interface further provides the user with a refinancing transaction summary of company X comprising, for example, sources of funds and uses of funds as of Jul. 31, 2012, as exemplarily illustrated in FIG. 20A, and financial information associated with a new credit facility provided by the company X as exemplarily illustrated in FIG. 20B.

The earnings information of the company X for the year 2013 further comprises non-generally accepted accounting principles (GAAP) financial information comprising, adjusted operating income, EBITDA and adjusted EBITDA, adjusted net income, adjusted diluted earnings per share, and free cash flow, as exemplarily illustrated in FIGS. 20C-20D. Furthermore, the CIM-lenders presentation interface provides a detailed description of each of the data fields used in the non-GAAP financial information as part of the earnings information of the company X for the year 2013. FIGS. 20C-20D also exemplarily illustrate the unaudited non-GAAP financial information in thousands of dollars except the “adjusted diluted earnings per share” data fields for the first quarter of fiscal years 2013 and 2012 provided to the user for comparative analysis of non-GAAP financial status of the company X of two successive fiscal years.

The “certain stock-based compensation expense (a)” data field exemplarily illustrated in FIG. 20C represents a stock-based compensation expense for options for class A common stock and restricted shares issued in connection with an acquisition under the Officer's Rollover Stock Plan established in connection with the acquisition. Furthermore, the “certain stock-based compensation expense (a)” data field represents a stock-based compensation expense for equity incentive plan class A common stock options issued in connection with the acquisition under the equity incentive plan. The “amortization of intangible assets (b)” data field exemplarily illustrated in FIG. 20C reflects amortization of intangible assets resulting from the acquisition. The “release of income tax reserves (c)” data field exemplarily illustrated in FIG. 20D represents release of income tax reserves. The “adjustments for tax effect (d)” data filed exemplarily illustrated in FIG. 20D represents tax effect of adjustments at an assumed marginal tax rate of 40%. The “weighted-average number of diluted shares outstanding (e)” exemplarily illustrated in FIG. 20D excludes an adjustment of approximately $1.3 million of net earnings associated with an application of a two-class method for computing diluted earnings per share.

The information analysis platform 204 allows the user to view the financial information associated with non-GAAP of company X between a period of a first quarter of the fiscal year 2012 to a first quarter of the fiscal year 2013 in which the adjusted operating income increases from $109.11 million to $120.262 million, the EBITDA increases from $115.98 million to $133.239 million, the adjusted EBITDA increases from $122.877 million to $135.632 million, the adjusted net income increases from $57.981 million to $65.979 million, the adjusted net income per diluted share increases from $0.41 to $0.46, and the free cash flow increases from $36.243 million to $70.074 million, as exemplarily illustrated in FIGS. 20C-20D.

It will be readily apparent that the various methods, algorithms, and computer programs disclosed herein may be implemented on computer readable media appropriately programmed for general purpose computers and computing devices. As used herein, the term “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc®, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Some examples of programming languages that can be used comprise C, C++, C#, Java®, Fortran, Ruby, Pascal, Perl®, Python®, Visual Basic®, MATLAB®, etc. Other object-oriented, functional, scripting, and/or logical programming languages may also be used. The computer program codes or software programs may be stored on or in one or more mediums as object code. Various aspects of the method and system disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and system disclosed herein may be implemented as programmed elements, or non-programmed elements, or any suitable combination thereof. The computer program product disclosed herein comprises computer executable instructions embodied in a non-transitory computer readable storage medium, wherein the computer program product comprises one or more computer program codes for implementing the processes of various embodiments.

Where databases are described such as the data management database 209, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the system, the databases may be integrated to communicate with each other for enabling simultaneous updates of data linked across the databases, when there are any updates to the data in one of the databases.

The present invention can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices may comprise processors, for example, the Intel® processors, Advanced Micro Devices (AMD®) processors, UltraSPARC® processors, hp® processors, International Business Machines (IBM®) processors, RISC based computer processors of ARM Holdings, Motorola® processors, etc., that are adapted to communicate with the computers. In an embodiment, each of the computers is equipped with a network communication device, for example, a network interface card, a modem, or other network connection device suitable for connecting to a network. Each of the computers and the devices executes an operating system, for example, the Linux® operating system, the Unix® operating system, any version of the Microsoft® Windows® operating system, the Mac OS of Apple Inc., the IBM® OS/2, the Palm OS®, the Solaris operating system developed by Sun Microsystems, Inc., or any other operating system. Handheld devices execute operating systems, for example, the Android® operating system, the Windows Phone™ operating system of Microsoft Corporation, the BlackBerry® operating system of Research in Motion Limited, the iOS operating system of Apple Inc., the Symbian® operating system of Symbian Foundation Limited, etc. While the operating system may differ depending on the type of computer, the operating system will continue to provide the appropriate communications protocols to establish communication links with the network. Any number and type of machines may be in communication with the computers.

The present invention is not limited to a particular computer system platform, processor, operating system, or network. One or more aspects of the present invention may be distributed among one or more computer systems, for example, servers configured to provide one or more services to one or more client computers, or to perform a complete task in a distributed system. For example, one or more aspects of the present invention may be performed on a client-server system that comprises components distributed among one or more server systems that perform multiple functions according to various embodiments. These components comprise, for example, executable, intermediate, or interpreted code, which communicate over a network using a communication protocol. The present invention is not limited to be executable on any particular system or group of systems, and is not limited to any particular distributed architecture, network, or communication protocol.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials, and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

I claim:

1. A computer implemented method for analyzing and managing a plurality of syndicated loan transaction elements, comprising:
providing an information analysis platform comprising at least one processor configured to analyze and manage said syndicated loan transaction elements;
receiving said syndicated loan transaction elements from a plurality of data sources by said information analysis platform;
extracting data items from said received syndicated loan transaction elements by said information analysis platform;
converting said extracted data items into a plurality of data fields by said information analysis platform, wherein said data fields are configured for enhanced review, interpretation, comparison, and statistical analysis of said received syndicated loan transaction elements;
analyzing said received syndicated loan transaction elements using said data fields by said information analysis platform via analytical tools and expert inputs received via a graphical user interface provided by said information analysis platform; and
estimating one or more of a plurality of factors associated with syndicated loans by said information analysis platform based on said analysis of said received syndicated loan transaction elements.

2. The computer implemented method of claim 1, wherein said syndicated loan transaction elements comprise syndicated loan transaction documents, loan information, legal loan transaction documents, one or more agreements associated with a loan deal, bank books, compliance reports, and any combination thereof.

3. The computer implemented method of claim 1, further comprising storing one or more of said data fields in predefined formats in a data management database by said information analysis platform for enhanced accessibility.

4. The computer implemented method of claim 1, wherein said information analysis platform is configured to convert said extracted data items into said data fields using expert inputs received via said graphical user interface.

5. The computer implemented method of claim 1, further comprising generating one or more reports by said information analysis platform based on said analysis of said received syndicated loan transaction elements.

6. The computer implemented method of claim 1, further comprising categorizing each of said extracted data items into one of said data fields in a data management database by said information analysis platform.

7. The computer implemented method of claim 1, further comprising configuring each of said received syndicated loan transaction elements as a template by said information analysis platform for said extraction of said data items.

8. The computer implemented method of claim 1, further comprising dynamically generating a data management database configured to store said received syndicated loan transaction elements, said extracted data items categorized into said data fields, and information associated with said syndicated loans.

9. The computer implemented method of claim 1, further comprising retrieving and displaying detailed information for each of said received syndicated loan transaction elements, said extracted data items, and said data fields on said graphical user interface by said information analysis platform, on receiving an input from a user device.

10. The computer implemented method of claim 1, further comprising enabling sharing of said estimated one or more of said factors associated with said syndicated loans and one or more reports generated based on said analysis of said received syndicated loan transaction elements between a plurality of user devices via a network by said information analysis platform based on predetermined sharing criteria.

11. The computer implemented method of claim 10, further comprising assigning a user identifier to each of said estimated one or more of said factors and each of said one or more reports generated based on said analysis of said received syndicated loan transaction elements, shared between said user devices by said information analysis platform, for identifying each of said user devices.

12. The computer implemented method of claim 1, further comprising comparing said data fields associated with financial instruments by said information analysis platform for valuing credit of each of said data fields in each of said financial instruments.

13. The computer implemented method of claim 1, wherein said factors associated with said syndicated loans comprise impact of structural elements on loss given default, probability of default and pricing, impact of each of said data fields for short term and long term changes in default and loss given default assumptions, credit impact on each of said extracted data items, impact on valuations of said syndicated loans, and statistical relationships between said data fields in said received syndicated loan transaction elements and metrics that measure overall credit.

14. The computer implemented method of claim 1, further comprising providing a search engine configured to facilitate scanning of said received syndicated loan transaction elements, said extracted data items, and said data fields associated with said syndicated loans.

15. The computer implemented method of claim 1, wherein said data sources comprise one or more business entities that provide one of private filings and public filings associated with a loan transaction, bank databases, public databases, virtual data rooms, and any combination thereof.

16. A computer implemented system for analyzing and managing a plurality of syndicated loan transaction elements, comprising:
an information analysis platform comprising:
at least one processor;
a non-transitory computer readable storage medium communicatively coupled to said at least one processor, said non-transitory computer readable storage medium configured to store modules of said information analysis platform, said at least one processor configured to execute said modules of said information analysis platform;
said modules of said information analysis platform comprising:
a graphical user interface configured to receive expert inputs for converting data items extracted from said syndicated loan transaction elements into data fields and for analyzing said syndicated loan transaction elements using said data fields;
a data reception module configured to receive said syndicated loan transaction elements from a plurality of data sources;
a data extraction module configured to extract said data items from said received syndicated loan transaction elements;
a data conversion module configured to convert said extracted data items into a plurality of said data fields, wherein said data fields are configured for enhanced review, interpretation, comparison, and statistical analysis of said received syndicated loan transaction elements;
an analytics engine configured to analyze said received syndicated loan transaction elements using said data fields via analytical tools and said expert inputs received via said graphical user interface; and
a factor estimation module configured to estimate one or more of a plurality of factors associated with syndicated loans based on said analysis of said received syndicated loan transaction elements.

17. The computer implemented system of claim 16, wherein said syndicated loan transaction elements comprise syndicated loan transaction documents, loan information, legal loan transaction documents, one or more agreements associated with a loan deal, bank books, compliance reports, and any combination thereof.

18. The computer implemented system of claim 16, wherein said modules of said information analysis platform further comprise a data management database configured to store one or more of said data fields in predefined formats for enhanced accessibility, said received syndicated loan transaction elements, said extracted data items categorized into said data fields, and information associated with said syndicated loans.

19. The computer implemented system of claim 16, wherein said data conversion module is further configured to convert said extracted data items into said data fields using said expert inputs received via said graphical user interface.

20. The computer implemented system of claim 16, wherein said modules of said information analysis platform further comprise a reporting engine configured to generate one or more reports based on said analysis of said received syndicated loan transaction elements.

21. The computer implemented system of claim 16, wherein said data conversion module is further configured to categorize each of said extracted data items into one of said data fields in a data management database.

22. The computer implemented system of claim 16, wherein said data extraction module is configured to configure each of said received syndicated loan transaction elements as a template for said extraction of said data items.

23. The computer implemented system of claim 16, wherein said modules of said information analysis platform further comprise a data display module configured to retrieve and display detailed information for each of said received syndicated loan transaction elements, said extracted data items, and said data fields on said graphical user interface, on receiving an input from a user device.

24. The computer implemented system of claim 16, wherein said modules of said information analysis platform further comprise a data management module configured to share said estimated one or more of said factors associated with said syndicated loans and one or more reports generated based on said analysis of said received syndicated loan transaction elements between a plurality of user devices via a network based on predetermined sharing criteria.

25. The computer implemented system of claim 24, wherein said data management module is further configured to assign a user identifier to each of said estimated one or more of said factors and each of said one or more reports generated based on said analysis of said received syndicated loan transaction elements, shared between said user devices, for identifying each of said user devices.

26. The computer implemented system of claim 16, wherein said analytics engine is further configured to compare said data fields associated with financial instruments for valuing credit of each of said data fields in each of said financial instruments.

27. The computer implemented system of claim 16, wherein said factors associated with said syndicated loans comprise impact of structural elements on loss given default, probability of default and pricing, impact of each of said data fields for short term and long term changes in default and loss given default assumptions, credit impact on each of said extracted data items, impact on valuations of said syndicated loans, and statistical relationships between said data fields in said received syndicated loan transaction elements and metrics that measure overall credit.

28. The computer implemented system of claim 16, wherein said modules of said information analysis platform further comprise a search engine configured to facilitate scanning of said received syndicated loan transaction elements, said extracted data items, and said data fields associated with said syndicated loans.

29. The computer implemented system of claim 16, wherein said data sources comprise one or more business entities that provide one of private filings and public filings associated with a loan transaction, bank databases, public databases, virtual data rooms, and any combination thereof.

30. A computer program product comprising a non-transitory computer readable storage medium, said non-transitory computer readable storage medium storing computer program codes that comprise instructions executable by at least one processor, said computer program codes comprising:
a first computer program code for receiving syndicated loan transaction elements from a plurality of data sources;
a second computer program code for extracting data items from said received syndicated loan transaction elements;
a third computer program code for converting said extracted data items into a plurality of data fields, wherein said data fields are configured for enhanced review, interpretation, comparison, and statistical analysis of said received syndicated loan transaction elements;
a fourth computer program code for analyzing said received syndicated loan transaction elements using said data fields and expert inputs received via a graphical user interface; and
a fifth computer program code for estimating one or more of a plurality of factors associated with syndicated loans based on said analysis of said received syndicated loan transaction elements, wherein said factors associated with said syndicated loans comprise impact of structural elements on loss given default, probability of default and pricing, impact of each of said data fields for short term and long term changes in default and loss given default assumptions, credit impact on each of said extracted data items, impact on valuations of said syndicated loans, and statistical relationships between said data fields in said received syndicated loan transaction elements and metrics that measure overall credit.
